(19) United States
(12) Patent Application Publication
(10) Pub. No.: US 2026/0231883 A1
(43) Pub. Date: Aug. 13, 2026

(54) System and Method for Increasing Plant Growth and Yield

(71) Applicant: World Farm, LLC, Milwaukee, WI (US)

(72) Inventors: David A Metzger, Milwaukee, WI (US); Nasim M Balasjin, Milwaukee, WI (US)

(73) Assignee: World Farm, LLC, Milwaukee, WI (US)

(21) Appl. No.: 19/555,862

(22) Filed: Mar. 3, 2026

Related U.S. Application Data
(63) Continuation of application No. PCT/US2026/010078, filed on Jan. 2, 2026.
(63) Continuation-in-part of application No. 19/008,621, filed on Jan. 2, 2025.
(63) Continuation-in-part of application No. PCT/US2024/054477, filed on Nov. 4, 2024.
(60) Provisional application No. 63/547,141, filed on Nov. 2, 2023.
(60) Provisional application No. 63/766,327, filed on Mar. 3, 2025.
(60) Provisional application No. 63/933,357, filed on Dec. 7, 2025.

(51) Int. Cl. A01G 31/02; A01G 7/04; A01G 9/18; A01G 9/26; A01G 31/00

(52) U.S. Cl. CPC A01G 31/024; A01G 7/04; A01G 9/18; A01G 9/26; A01G 31/008; A01G 31/065

(57) ABSTRACT

A plant growing system that includes a hyperbaric growing chamber having a growing atmosphere holding compartment overlying a liquid growing medium holding compartment separated by a gas and liquid impermeable barrier. The growing atmosphere is pressurized to at least 150 kPa and enriched with CO₂ to at least 0.05% by volume. An oxygenation system employing an electrolyzer and nebulizer produces hyperoxygenated hydroponic growing medium containing oxygen nanobubbles maintaining at least 5 mg/L dissolved oxygen. A foliar feeding system discharges nanosized surfactant-enhanced fertilizer droplets into the growing atmosphere for stomatal uptake. An acoustic stimulation system selectively varies sound frequencies emitted by transducers to controllably open and close stomata during feeding cycles. A lighting system collects sunlight via solar collectors, filters UV wavelengths, and delivers filtered light through fiber optic bundles to emitters within the chamber. The chamber is preferably disposed underground to maintain stable growing temperatures without active climate control.

### CROSS-REFERENCE

This application is a continuation-in-part of International Application No. PCT/US2026/010078, filed Jan. 2, 2026, which claims the benefit of and priority to U.S. application Ser. No. 19/008,621, filed Jan. 2, 2025. This application is also a continuation-in-part of U.S. application Ser. No. 19/008,621, filed Jan. 2, 2025, which in turn is a continuation-in-part of International Application No. PCT/US2024/054477, filed Nov. 4, 2024. This application is further a continuation-in-part of International Application No. PCT/US2024/054477, filed Nov. 4, 2024, which claims the benefit of and priority to U.S. Provisional Application No. 63/547,141, filed Nov. 2, 2023. This application further claims the benefit of and priority to U.S. Provisional Application No. 63/766,327, filed Mar. 3, 2025; and U.S. Provisional Application No. 63/933,357, filed Dec. 7, 2025. The entire disclosures of each of the above-referenced applications are hereby expressly incorporated herein by reference.

### FIELD

The present invention relates generally to a system and method for growing plants and more particularly to a system and method of growing plants that produces increased plant growth and yield.

### BACKGROUND

The world's farmers face significant challenges in meeting the needs of a rapidly growing global population, which is expected to reach around 10 billion people by 2050. Food production will need to increase by roughly 70% to meet the anticipated demand, especially given the continued population growth in Asia and sub-Saharan Africa, where food requirements are projected to rise fastest. Yet, the capacity of farmers to feed the world is constrained by numerous factors, including climate change, land and water resource limits, while political and economic barriers continue to mount.

Agricultural productivity has grown considerably in past decades, but in many regions, such as sub-Saharan Africa, yields still fall short of their potential by about 50%. Boosting these yields will require novel technology, infrastructure, and sustainable farming practices, alongside major reductions in food waste, which currently affects nearly one-third of global food production. Climate change presents another complication, with altered weather patterns, rising carbon dioxide, CO₂, levels and extreme events affecting crop viability in vulnerable areas. To adapt, farmers will need access to novel technologies that increase yield while decreasing our carbon footprint.

Even more critically, food distribution inefficiencies and food access disparities are problematic. When, not if, global food supplies rise, issues like urbanization, regional import dependencies, and unequal access to nutritious food can still lead to mass hunger and malnutrition. Novel technologies aimed at improving the shelf life of fruits and vegetables, especially in low-income nations, are essential to prevent food shortages and mass starvation.

We are losing our available farming land. Desert expansion is occurring globally, accelerated by both natural climate patterns and human-induced climate change. For example, the Sahara Desert in Africa has grown by about 10% since 1920, largely driven by changes in rainfall patterns and an intensified warming trend.

Globally, other deserts are also likely to be growing as these processes widen subtropical dry zones, contributing to a broader trend in desertification that affects arable land and could challenge agricultural productivity. In regions like the Sahel, the advancing Sahara is pushing southward, disrupting ecosystems and water sources like Lake Chad, which has drastically shrunk over the last several decades. This expansion represents a significant environmental and socio-economic challenge, especially for communities dependent on stable climates and water resources for agriculture and livelihood in semi-arid regions near deserts. Deserts for the most part are unusable areas of earth devoid of the capability to support meaningful farming. Interestingly, significant groundwater reservoirs, known as aquifers, exist beneath many of the world's major deserts, providing substantial water resources despite these regions' arid conditions. For instance, beneath the Sahara Desert, the Nubian Sandstone Aquifer System spans areas of Egypt, Sudan, Libya, and Chad, holding an estimated 150,000 cubic kilometers of ancient groundwater.

Each year, approximately 14% of global food is lost between harvest and the retail. This significant portion of our food supply is affected by factors like inadequate storage, poor handling during transportation, and lack of refrigeration, particularly impacting perishable items like fruits and vegetables. Losses during transit are especially high in lower-income regions, where infrastructure for cold storage and efficient transport is limited. For example, in regions of Asia, food losses during transport alone can reach as much as 20%.

On a global scale, food loss during transit is a significant contributor to overall food waste, costing billions if not trillions in lost economic value and exacerbating environmental impacts due to the resources required for food production, such as water and energy. Efforts to reduce these losses include improving logistics, packaging solutions, and temperature control technologies to better preserve food quality throughout the supply chain.

Ultimately, while it's possible to feed the growing population, this will require comprehensive changes to food systems, infrastructure, and policies to make food production sustainable and equitable. Failure to address these issues could limit farmers' ability to meet global food demands in the long term. Addressing these needs is seen as a priority by organizations such as the UN and FAO, which emphasize sustainable practices to safeguard future food security.

The extension of the shelf life of fruits and vegetables is a significant concern in the food industry due to their highly perishable nature. There is a need for a plant growing system that not only can reduce food shrinkage (waste) but be able to grow food under the desert surface.

### SUMMARY

The present invention is directed to a growing system and method of growing plants that utilizes a growing chamber configured for growing plants in a hyperbarically pressurized CO₂ enriched growing atmosphere whose roots are substantially completely immersed in a hyperoxygenated, preferably oxygen supersaturated, aqueous hydroponic liquid growing medium for increased plant growth, greater vegetative mass, larger yield, longer plant life and which reduces pre-harvest spoilage. The growing chamber has an enclosure that preferably is gas-tight and liquid-tight, which is formed of at least one sidewall, preferably a top wall, and preferably also a bottom wall, and which includes a liquid growing medium holding compartment underlying a growing atmosphere holding compartment. The chamber preferably has a plurality of spaced apart growing stations spaced which are each can include a plant support rack arrangement configured to structurally support and vertically uprightly orient a plant with its roots submerged in the growing medium and its foliage disposed in the growing atmosphere. Each plant growing station can also include a container configured to hold and desirably orient (a) a propagule in contact with liquid growing medium to facilitate its germination into a seedling, (b) a seedling with its roots immersed in liquid growing medium during growth into a plant and its shoots extending uprightly into the growing atmosphere, and (c) a plant with its roots substantially completely submerged in the growing medium and its stem and shoots uprightly oriented.

The growing system has an oxygenation system configured for hyperoxygenating and maintaining the hyperoxygenation of the growing medium using an atomizer, preferably nebulizer, to atomize, preferably nebulize oxygen from an electrolyzer and a pre-oxygenated liquid growing medium makeup liquid discharged as effluent from the electrolyzer producing hyperoxygenated growing medium containing charged oxygen nanobubbles dissolved therein that stay in solution in the hyperoxygenated growing medium longer and which enable the roots of the plants to remain substantially completely submerged in the hyperoxygenated growing medium increasing the root surface area in contact therewith which advantageously increases oxygen uptake by the plant roots. The growing system preferably also is equipped with a feeding system configured for foliar feeding of plants in the chamber that also employs an atomizer, preferably a nebulizer, to discharge nanosized droplets of nutrient-containing liquid fertilizer into the growing atmosphere which wet the foliage of a plant undergoing a feeding cycle enabling the fertilizer to be readily taken up via stomata of the plant. The growing system can and preferably does further includes a growing atmosphere operating system configured to (a) enrich the growing atmosphere with an increased percentage of CO₂ that is higher than the percentage of CO₂ in the Earth's atmosphere for increased CO₂ uptake by each plant during plant transpiration, (b) pressurize the growing atmosphere to a pressure higher than the Earth's atmospheric pressure which advantageously further helps increase stomatal uptake of CO₂ during transpiration and fertilizer during foliar feeding, and (c) remove excess oxygen from the growing atmosphere. The growing system can and preferably does also have an acoustic plant stimulation system configured to stimulate plants in the chamber for increased growth and yield using sound having certain desired frequencies and sound levels that preferably is configured to acoustically stimulate plant foliage with frequencies that range from a stomata pore opening initiating frequency, which acoustically stimulates stomata guard cells to cause pores of stomata that are closed to begin to open, to a higher stomata pore fully open frequency, which acoustically stimulates the guard cells to substantially completely open the stomata pores to increase stomatal uptake of CO₂ and fertilizer. Finally, the growing system also can and preferably does include a plant lighting system configured to collect sunlight using a solar collector, filter ultraviolet light from the sunlight such as by using a UV light filtering material like a UV light filtering acrylic, and focus the collected UV filtered light onto fiber optic cables which transports the light into the chamber where it is emitted toward foliage of plants in the chamber irradiating the foliage for photosynthesis.

The chamber is used not only to grow plants all the way through harvest, but also germinate propagules, such as a seed, cutting, bulb, rhizome, tuber, corm, runner (stolon), offset, spore or other type of plant propagule, into seedlings which in turn grow in the chamber into plants. The plants are grown in the chamber through all of its stages to maturity and yield where produce in the form of edible product grown by each one of the plants are harvested. When grown from a propagule, the propagule can be placed in a plant growing container of a plant growing station inside the chamber where an open bottom of the container is disposed in liquid growing medium so part of but not the entirety of the propagule is in contact with the growing medium. While an oxygen rich hyperbarically pressurized growing atmosphere is used during germination and sprouting of the propagule, the growing atmosphere operating control system transitions into a CO₂ enhanced hyperbarically pressurized growing atmosphere after sprouting, during growth as a seedling, during all stages of plant growth, and up until the produce of each plant in the chamber is ready to be harvested when ozone is introduced into the hyperbarically pressurized growing atmosphere for a period of time before the ozone is replaced with an even greater percentage of CO₂ in the hyperbarically pressurized growing atmosphere than used during prior plant growth stages to prevent produce spoilage and extend produce shelf life.

During plant growing system and growing chamber operation, liquid growing medium in the chamber is an oxygenated, preferably hyperoxygenated and/or oxygen supersaturated, hydroponic liquid growing medium nutrient containing solution made using an oxygenation system that maintains a level of oxygen in the growing medium of at least 2 milligrams of oxygen per liter of growing medium, preferably at least 3 mg/L, more preferably at least 5 mg/L, and even more preferably at least about 6.5 mg/L and which is preferably no greater than about 8 mg/L and which produces charged nanosized oxygen bubbles which remain in the growing medium for a longer period of time, all of which advantageously enable the roots of the plants to be substantially completely submerged therein. Maintaining such an increased level of oxygen advantageously results in increased oxygen uptake by the roots of the plants in the chamber and enables the roots to remain substantially completely immersed in the hyperoxygenated growing medium. Such increased oxygen uptake by the roots of each plant in the chamber advantageously speeds up germination and sprouting, increases vegetative growth, decreases the time to budding, flowering and fruiting/seed formation of each plant in the chamber and preferably also advantageously increases plant yield, plant life, and/or the number of harvests from each plant from a single harvest for each plant to at least a plurality of harvests, preferably at least a plurality of pairs of harvests, before plant senescence or death. The use of nanosized oxygen bubble to hyperoxygenate the growing medium preferably supersaturates the growing medium with oxygen and advantageously causes oxygen to remain oxygenated in the growing medium, such as by being dissolved or remaining in solution therein, for a longer period of time for at least a plurality of weeks, preferably at least one month, and more preferably at least six weeks before requiring replenishment by the oxygenation system.

The growing atmosphere within the chamber is oxygen regulated, CO₂ enriched, and maintained at a pressure greater than the Earth's atmospheric pressure by a growing atmosphere operating system such that the chamber preferably is a hyperbaric plant growing chamber having a percentage of CO₂ greater than the Earth's atmosphere and which can and preferably does regulate the percentage of oxygen in the growing atmosphere to maintain it at or below a predetermined desired maximum percentage of oxygen that can be less than the percentage of oxygen in the Earth's atmosphere. The growing atmosphere operating system maintains (a) the pressure of the growing atmosphere at a pressure of at least 150 kPa or 21 psi, preferably at least 200 kPa or 29 psi, and more preferably at least about 300 kPa or at least about 43 psi, and which can be and preferably is no greater than 1200 kPa or 175 psi, more preferably no greater than 1000 kPa or 145 psi, even more preferably no greater than 800 kPa or about 115 psi, yet even more preferably no greater than about 600 kPa or about 87 psi, and still even more preferably no greater than about 500 kPa or about 72 psi, (b) at least 0.05%, preferably at least 0.06%, more preferably 0.08%, and even more preferably at least 0.10% CO₂ by volume in the growing atmosphere, and (c) no greater than 25%, preferably no greater than about 21%, more preferably no greater than about 18%, and even more preferably no greater than about 15% oxygen by volume in the growing atmosphere. The amount of oxygen in the growing atmosphere is regulated to remove oxygen produced during respiration of the plants in the chamber to keep the percentage of oxygen in the growing atmosphere no greater than 21%, preferably no greater than 18%, and more preferably no greater than about 15% by volume while supplying CO₂ as needed from a CO₂ gas supply system and/or CO₂ gas generation system, such as preferably provided by a CO₂ capturing system, to maintain the amount of CO₂ in the growing atmosphere to be between 0.05% and 0.40%, preferably between 0.08% and 0.20%, by volume, while maintaining the pressure of the growing atmosphere at between 200 kPa or 29 psi and 1000 kPa or 145 psi during at least the seed stage, germination stage, seedling stage, vegetative growth stage, budding stage and flowering stage of growth of the plants in the chamber. Maintaining such a carbon enriched growing atmosphere at such an increased hyperbaric growing atmosphere pressure while regulating and removing excess oxygen from the growing atmosphere also advantageously speeds up germination, increases vegetative growth, decreases the time to budding, flowering and fruiting/seed formation of each one of the plants in the chamber while preferably also advantageously increasing plant yield, plant life and the number of harvests of each one of the plants to at least a plurality of harvests, preferably at least a plurality of pairs of harvests, before plant senescence or death.

The plant feeding system utilizes the fertilizer delivery and dispensing system that delivers liquid fertilizer using an atomizer, preferably a nebulizer, to discharge the fertilizer in a mist, preferably an aerosol, composed of plant nutrient-containing droplets into the growing atmosphere for foliar feeding, preferably stomatal feeding of a plant being grown in the chamber during a plant feeding cycle for the plant. The droplets in the mist or aerosol are nanosized or included nanosized droplets to facilitate foliar feeding, preferably stomatal feeding, by being more readily taken up by stomata of the foliage of the plant being fertilized during the feeding cycle. The relatively small size of the fertilizer droplets, particularly those that are nanosized, not only facilitate more rapid travel through the growing atmosphere in the chamber to reach and wet the foliage of the plant being fertilized during the plant's feeding cycle, but the relatively small size of the droplets, especially those that are nanosized, are advantageously more easily taken up by stomata of the leaves of the foliage of the plant being fertilized. To facilitate foliar feeding, preferably stomatal feeding, of a plant during its feeding cycle, (a) the fertilizer droplets can be electrically charged, e.g. electrostatically charged, (b) at least part of the plant, such as preferably its foliage, can be electrically charged, e.g. electrostatically charged, or (c) both the droplets and at least part of the plant, such as preferably its foliage, can be respectively electrically charged, e.g., electrostatically charged, with charges of opposite polarity all of which cause the droplets to be electrostatically attracted to the foliage of the plant being fed. This advantageously speeds up feeding by causing the attracted droplets to more quickly reach and wet the foliage of the plant undergoing a feeding cycle as well as to be more quickly taken up by and into pores of the stomata of the plant being fertilized which advantageously provides more efficient feeding of the plant for a given weight or volume of liquid fertilizer discharged by the atomizer or nebulizer of the feeding system. At least one surfactant can be added to the liquid fertilizer to produce a surfactant-enhanced fertilizer discharged in the form of droplets, including nanosized droplets, from the atomizer or nebulizer, the surfactant-containing fertilizer droplets not only more rapidly and uniformly wet and spread out over the outer surfaces of the leaves of the foliage of the plant undergoing a feeding cycle, but are also more quickly and more readily taken up by and into the pores of the stomata of the foliage, including through wicking or capillary action, advantageously increasing the rate of feeding of the plant undergoing the plant feeding cycle.

In preparation for and preferably prior to beginning a feeding cycle for a plant in the chamber, acoustical stimulation of the plant can be and preferably is performed to open or begin opening pores of stomata of the foliage of the plant to facilitate their uptake of liquid fertilizer from the droplets in the mist discharged from atomizer or aerosol discharged from nebulizer which travel through the growing atmosphere and contact and wet the foliage of the plant. In a preferred embodiment of the acoustical stimulation system and method of acoustically stimulating a plant, sonic stomatal pore widening is performed on a plant in the chamber undergoing a feeding cycle by acoustically stimulating its foliage with a pore opening initiating frequency at a desired predetermined sound pressure level and for a sufficient amount of time to cause the pores of the stomata of the foliage of the plant undergoing the feeding cycle to begin to open and which is controllably increased to a stomata pore fully open frequency at a desired predetermined sound pressure level and for a sufficient amount of time to cause the pores of the stomata of the foliage of the plant undergoing the feeding cycle to become and remain fully open until the feeding cycle is completed. Doing so advantageously maximizes foliar feeding by optimizing uptake of the fertilizer from droplets wetting the foliage by the fully open stomata during application of the fertilizer onto the foliage during the feeding cycle until the feeding cycle is completed.

In a preferred embodiment of the acoustical stimulation system and method of acoustically stimulating a plant in preparation for and/or which is undergoing feeding during a feeding cycle, the acoustical stimulation system has a controller configured in software and/or firmware and/or via user input to control operation of a tone or sound generator that cause acoustical transducers in sound emitting communication with the chamber to emit and acoustically stimulate the foliage of the plant in the chamber that is about to undergo or is undergoing a feeding cycle with sound at an initial frequency that is a stomata pore-opening initiating frequency of preferably about 500 Hz at a desired predetermined sound pressure level. The desired predetermined sound pressure level of the stomata pore-opening initiating frequency that reaches the foliage of the plant is at least 50 dB and no greater than 110 dB and preferably is between about 70 dB and about 90 dB. The sound at this desired predetermined sound pressure level is emitted at the stomata pore-opening initiating frequency for a long enough period of time to cause the pores of the stomata of the foliage of the plant being fertilized to begin to open. The frequency of the sound outputted by the transducers is then increased, such as in steps, generally linearly, generally logarithmically or even generally exponentially, while the aforementioned desired sound pressure level is maintained, until a final frequency is reached that is a stomata pore fully open frequency of preferably about 6000 Hz that results in the pores of the stomata of the foliage of the plant undergoing the feeding cycle substantially completely opening. The sound from the transducers preferably is emitted at the stomata pore fully open frequency at the aforementioned desired sound pressure level until the feeding cycle of the plant is finished to keep the stomata open for fertilizer uptake until the feeding cycle is finished.

Where the chamber contains multiple plants, the sound from the transducers preferably is emitted at the stomata pore fully open frequency at the aforementioned desired sound pressure level until the feeding cycles of each one of the plants in the chamber are finished. In one preferred embodiment and stomata pore opening acoustical plant stimulation method of the present invention, the frequency of the sound from the transducers is increased in predetermined frequency steps, such as preferably equal steps, from the stomata pore-opening initiating frequency of about 500 Hz to an intermediate stomata pore opening frequency of about 3000 Hz where the pores of the stomata are between 40% open and 60% open, and from the intermediate stomata pore opening frequency of about 3000 Hz to the stomata pore fully open frequency of about 6000 Hz where the pores of the stomata are substantially completely open by each being at least 90% open and which preferably are each about 100% open.

Where it is desired to acoustically stimulate the pores of the stomata of the foliage 46 of a plant in the chamber to close upon or after completion of its feeding cycle, acoustical stimulation system controller and/or user controls operation of the tone or sound generator to cause the acoustical transducers to emit and acoustically stimulate the foliage of the plant with sound having an initial stomata pore closing frequency that preferably is a pore closing initiating frequency of about 6000 Hz at the desired predetermined sound pressure level of at least 50 dB and no greater than 110 dB which preferably is between about 70 dB and about 90 dB and which decreases in frequency at a rate which causes the substantially completely open pores of the stomata of the foliage of plant to begin closing preferably causing the size of the pores of the stomata of the plant to reduce to a size of no greater than 85% of their fully open pore size. The frequency of the sound emitted from the transducers during pore closing is reduced, such as in steps, generally linearly, generally logarithmically, or generally exponentially, from the pore closing initiating frequency of about 6000 Hz to a final pore fully closed frequency of about 500 Hz while the sound pressure level of the emitted sound is maintained at an aforementioned desired predetermined sound pressure level until substantially all of the pores of the stomata of the foliage of the plant is substantially completely closed by being less than 10% open and preferably less than about 5% open. In one preferred embodiment and stomata pore closing acoustical plant stimulation method of the present invention, the frequency of the sound from the transducers is decreased in predetermined frequency steps, such as preferably in equal steps, from the stomata closing initiating frequency of about 6000 Hz to an intermediate stomata pore closing frequency of about 3000 Hz where substantially all of the pores of the stomata are between 40% open and 60% open, and from the intermediate stomata pore closing frequency of about 3000 Hz to the stomata pore fully closed frequency of about 500 Hz where the pores of the stomata are substantially completely closed by each being no more than 10% open and which preferably are each no more than about 5% open.

In one preferred embodiment and method, such a method of stomata pore closing acoustical plant stimulation is initiated when the feeding cycle of the plant is substantially completed by being at least 90% completed, and preferably by being at least about 95% completed, and preferably is performed until all of the pores of all of the stomata of the plant whose feeding cycle was completed are substantially completely closed. In another such preferred embodiment and method, such a method of stomata pore closing acoustical plant stimulation is initiated when the feeding cycle of the last one of the plants in the chamber is completed or substantially completed, such as by being at least 90% completed, and preferably by being at least about 95% completed, and preferably is performed until substantially all of the pores of all of the stomata of all of the plants in the chamber are substantially completely closed.

The growing system also employs a plant lighting system that utilizes sunlight as a source of plant photosynthesis light that is gathered by a solar collector disposed above ground exteriorly of the growing chamber and which delivers it through fiber optic cables of a fiber optic cable bundle that is separated into a plurality of fiber optic cable bundles which deliver light in the chamber which irradiates the foliage of each plant in the chamber enabling plant photosynthesis to occur. Sunlight is filtered at least to substantially eliminate UV light wavelengths from the light irradiating the plants and can also be filtered to substantially eliminate far infrared light wavelengths from the light irradiating the plants in the chamber. In a preferred embodiment, acrylic, which preferably is a UV light filtering acrylic, is used to filter the UV light from the sunlight to produce plant-irradiating light that is substantially lacking in UV wavelengths. In such a preferred embodiment, the acrylic, preferably UV filtering acrylic, also filters out far IR wavelengths from the sunlight producing a plant-irradiating light having wavelengths in the visible light spectrum as well as in the near IR spectrum.

A preferred growing system can have a plurality of pairs of, i.e., at least three, chambers and each chamber can be disposed sufficiently far enough underground under the surface of the ground to ensure the plants and growing atmosphere in the chamber are maintained without heating or cooling at a substantially constant plant growth optimizing temperature of between 10 degrees Celsius and 35 degrees Celsius, preferably between 20 degrees Celsius and 32 degrees Celsius, and more preferably between about 21 degrees Celsius and 29 degrees Celsius that also helps ensure optimal growth of the plants. In a preferred plant growing system and growing method, the chamber preferably is disposed underground under the surface of the ground at least 10 meters, preferably at least 15 meters, and more preferably at least about 20 meters to ensure that the plants and growing atmosphere are maintained at a substantially constant optimal growing temperature falling within one of the aforementioned temperature ranges.

In one preferred growing system, growing environment, and growing method, the chambers are disposed underground in a desert, such as the Sahara, Arabian or Sonoran desert, at least about 12 meters, preferably at least 15 meters, and more preferably at least 20 meters under the surface of the desert which advantageously maintains the temperature of the growing atmosphere and plants within each chamber at a substantially constant temperature of between 20 degrees Celsius and 32 degrees Celsius and preferably between about 24 degrees Celsius and about 29 degrees Celsius. These temperatures are advantageously maintained without the use of any active climate control, such as in the form of cooling towers, air conditioners, heat pumps, or other refrigeration equipment. The underground chambers preferably are disposed above an underground aquifer which provides water for the (a) liquid growing medium, (b) electrolyzer of the oxygenation system, and (c) the plant feeding system including for use in making up the liquid fertilizer, surfactant and/or mixing them together in preparation for application on foliage of the plants in each chamber during foliar feeding of the plants in each chamber.

These and other objects, features and advantages of this invention will become apparent from the following detailed description of the invention and accompanying drawings.

### DESCRIPTION OF THE DRAWINGS

One or more preferred exemplary embodiments of the invention are illustrated in the accompanying drawings in which like reference numerals represent like parts throughout and in which:

FIG. 1 is a diagram depicting a plant growing system of the present invention illustrating a growing chamber in which one or more plants are grown and which has a gaseous growing atmosphere and a liquid growing medium, a growing medium oxygenation system, a growing atmosphere operating system, a fertilizer delivery system, a plant lighting system, and an acoustical plant stimulation system;

FIG. 2 is an enlarged fragmentary view of a plurality of spaced apart growing stations disposed in the plant growing chamber depicting various stages of growth of plants grown in the chamber;

FIG. 3 is an enlarged portion of the diagram of FIG. 1 that more clearly depicts the growing medium oxygenation system;

FIG. 4 is another enlarged portion of the diagram of FIG. 1 that more clearly depicts the growing chamber and plants being grown therein, the growing atmosphere operating system, the fertilizer delivery system, and components of the acoustical stimulation system;

FIG. 5 is a diagram of the growing atmosphere operating system;

FIG. 6 is a diagram of the fertilizer delivery system that supplies fertilizer in liquid form to an applicator that can be either an atomizer or a nebulizer from which droplets of fertilizer used to feed plants in the chamber are discharged include nanosized droplets;

FIG. 7 illustrates a preferred but exemplary of a fertilizer applicator of the fertilizer delivery system used to deliver fertilizer containing one or more nutrients in the growing chamber to plants in the growing chamber;

FIG. 8 is an enlarged side elevation view of the growing chamber with parts removed for clarity and which depicts a plant feeding station of the fertilizer delivery system that has a movable and rotatable gantry inside the chamber equipped with a plurality of spaced apart downwardly hanging arms that each carry a plurality of spaced apart applicator nozzles for spraying fertilizer onto foliage of a plant during a plant feeding cycle;

FIG. 9 is a top plan view of the plant growing chamber of FIGS. 1 and 3 illustrating a track system carrying the gantry of the feeding station and which is configured to enable movement of the gantry within the chamber, including rotation of the gantry relative to a plant being fertilized as well as displacement of the gantry relative along a plurality of axes;

FIG. 10 is a side elevation view of the gantry, nozzles and nozzle carrying arms;

FIG. 11 is a top view of the gantry, nozzles, and nozzle carrying arms;

FIG. 12 is a side elevation view of the growing chamber depicted in FIG. 1 depicting a preferred but exemplary arrangement of acoustical transducers of the acoustical stimulation system that are carried by walls of the chamber and which are configured to acoustically stimulate foliage and roots of plants in the chamber;

FIG. 13 is a top view of the growing chamber and arrangement of acoustical transducers used to stimulate the foliage of the plants in the chamber;

FIGS. 14-16 depict acoustical stimulation of foliage of plants in the chamber using acoustical transducers configured acoustically increase in size and preferably substantially completely open pores of stomata of the foliage of the plants in the chamber during performing of a stomata opening acoustical stimulation cycle;

FIGS. 17-19 depict acoustical stimulation of foliage of plants in the chamber using acoustical transducers configured acoustically decrease in size and preferably substantially completely close pores of stomata of the foliage of the plants in the chamber during performing of a stomata closing acoustical stimulation cycle;

FIG. 20 is a diagram illustrating the growing chamber and the lighting system used to provide light to plants in the growing chamber that utilizes a light engine with a solar light collection and delivery system configured to transport light therefrom to a light distribution system in the growing chamber that irradiates plants growing in the chamber;

FIG. 21 is an enlarged fragmentary perspective view of a light-emitting portion of the light distribution system disposed inside the chamber from which light is emitted; and

FIG. 22 is a diagram of a preferred but exemplary embodiment of a light engine.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

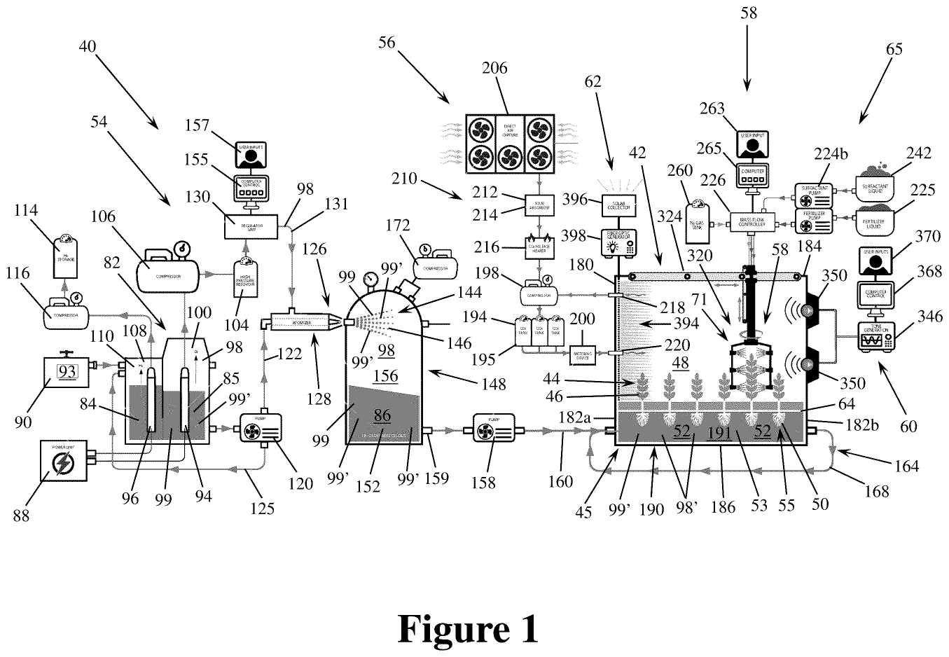

FIG. 1 illustrates a plant growing system 40 of the present invention that includes a plant growing chamber 42 in which one or more plants 44 being grown are grown with the foliage 46 of each plant disposed in a growing atmosphere 48 in the chamber 42 and the roots 50 of each plant 44 being disposed in a growing medium 52 in chamber 42. The growing medium 52 preferably is a liquid growing medium, more preferably an aqueous liquid growing medium, which can be composed substantially of water and preferably contains one or more plant-affecting constituents, such as preferably one or more nutrients, configured for uptake by roots 50 of plants 44 growing in chamber 42. As disclosed in more detail hereinbelow, the liquid growing medium 52 is oxygenated, preferably hyperoxygenated and which can be oxygen supersaturated containing oxygen nanobubbles and which is configured to retain a greater percentage of oxygen in the growing medium 52 for a longer period of time facilitating root uptake of oxygen for an extended period of time and enabling roots 50 of the plants 44 to be substantially completely submerged in the growing medium 52. The plant growing system 40 of the present invention preferably includes one or more of a liquid growing medium oxygenation system 54, a growing atmosphere operating system 56, a plant feeding system 58, an acoustical plant stimulation system 60, and a plant lighting system 62. At least one preferred embodiment of growing system 40 includes a growing medium oxygenation system 54, a growing atmosphere operating system 56, a plant feeding system 58, an acoustical plant stimulation system 60, and a plant lighting system 62.

As discussed in more detail below, growing medium oxygenation system 54 is configured for oxygenating, preferably hyperoxygenating, an aqueous liquid growing medium 52, including by supersaturating the growing medium 52 with oxygen, including nanosized bubbles of oxygen, diffused and/or dissolved in the medium 52 which remain in solution in the medium 52 for a longer time and enable roots 50 of each plant 44 in the chamber 42 to be substantially completely immersed in the medium 52. Plant feeding system 58 is configured for foliar, preferably stomatal, feeding, of each plant 44 in the chamber 42 with a liquid fertilizer containing one or more nutrients and preferably also a surfactant applied using an applicator 245 like an atomizer 246 that preferably is a nebulizer 248 that delivers the fertilizer in the form of droplets which can be nanosized and charged for more efficient uptake by stomata 374 of the foliage 46 of a plant 44 in the chamber 42 being fertilized during a plant feeding cycle in the manner discussed in more detail below. Growing atmosphere operating system 56 is configured to maintain a CO₂ enhanced growing atmosphere 48 within chamber 42 having an increased percentage of CO₂ significantly higher than the Earth's atmosphere for increasing plant growth and yield, regulate the percentage of one or more other gases in the growing atmosphere 48, such as preferably oxygen, and also help maintain the pressure of the growing atmosphere 48 at a hyperbaric pressure significantly higher than Earth's atmospheric pressure also helping to increase growth and yield while also facilitating foliar, preferably stomatal, feeding of the plants 44 in the chamber 42. Acoustical stimulation system 60 is configured for directing acoustic energy onto the foliage 46 of the plants 44, such as in the form of sound, for not only stimulating their growth and increasing yield, but preferably also to facilitate opening of the stomata 374 of the foliage 46 of a plant 44 undergoing a feeding cycle for facilitating stomatal feeding and/or to facilitate closing of the stomata 374 after feeding is finished. Plant lighting system 62 is configured for collecting sunlight 426, selectively filtering wavelengths, such as preferably UV and/or IR wavelengths therefrom, and delivering it to the plants 44 in the chamber 42 in the form of filtered light 394 that irradiates the foliage 46 of each plant 44 with a luminous intensity sufficient for plant photosynthesis.

Growing chamber 42 preferably is a hyperbaric growing chamber 45 of substantially gas tight and liquid tight construction and which contains a CO₂ enriched growing atmosphere 48 composed of at least CO₂, oxygen and nitrogen and can include other gases present in the Earth's atmosphere with the pressure of the atmosphere 48 in chamber 42 controlled to maintain it above atmospheric pressure and the percentage of CO₂ present in the growing atmosphere 48 regulated to maintain it above, preferably significantly above, the percentage of CO₂ in the Earth's atmosphere. As previously noted, chamber 42 also contains a growing medium 52 that preferably contains water which more preferably is a hydroponic liquid growing medium 53, which preferably is substantially completely composed of water, and which preferably is in the form of an aqueous hydroponic liquid growing medium nutrient solution that contains one or more plant nutrients dissolved and/or in suspension therein for uptake by the roots 50 of each plants 44 being grown in chamber 42.

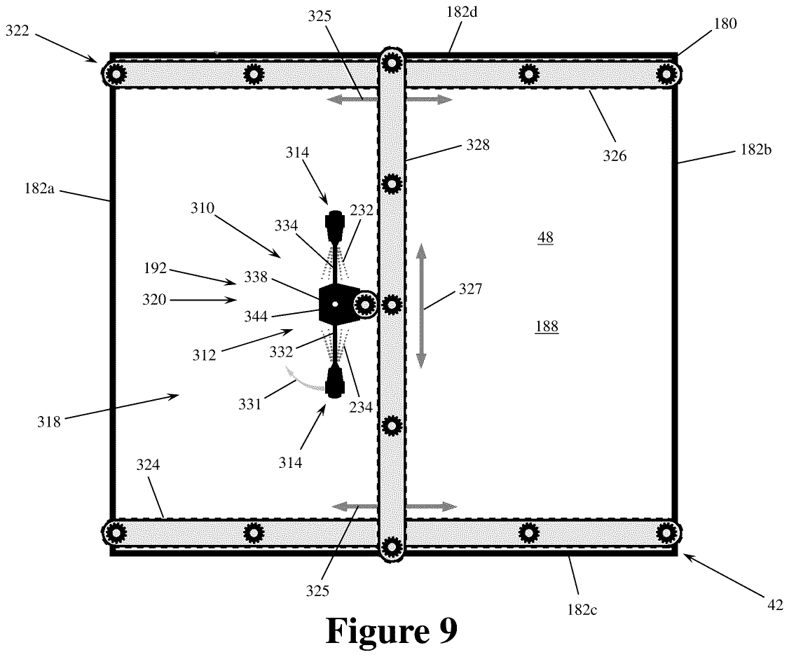

The chamber 42 depicted in the drawing figures is defined by an enclosure 180 composed of a plurality of generally square, e.g., rectangular, sidewalls 182a, 182b, 182c, 182d, 184 and 186 arranged in a box shape which has a generally rectangular cross-section, which can be a generally square cross-section, and which can be in the form of a cube. With additional reference to FIG. 9, the walls of the enclosure 180 are preferably arranged such that walls 184 and 186 respectively are top and bottom walls 184, 186 of the enclosure 180, walls 182a, 182b, 182c and 182d are walls 182a, 182b, 182c, 182d of the enclosure 180, walls 182a, 182b, 182c, 182d are disposed between the top and bottom walls 184, 186, and one pair of the walls 182c and 182d respectively are front and rear walls 182c, 182d of the enclosure 180 disposed between the other pair of walls 182a, 182b. Enclosure 180 is gas-tight and has a growing atmosphere holding compartment 188 formed or otherwise disposed in the top or upper portion of the enclosure 180. Compartment 188 is configured to hold the growing atmosphere 48, disposing it above the liquid growing medium 52. Enclosure 180 also is liquid-tight and has a growing medium liquid holding compartment 190, such as in the form of a tank 191 formed or otherwise disposed in the bottom of the enclosure 180 configured to hold the liquid growing medium 52, disposing it underneath the growing atmosphere 48.

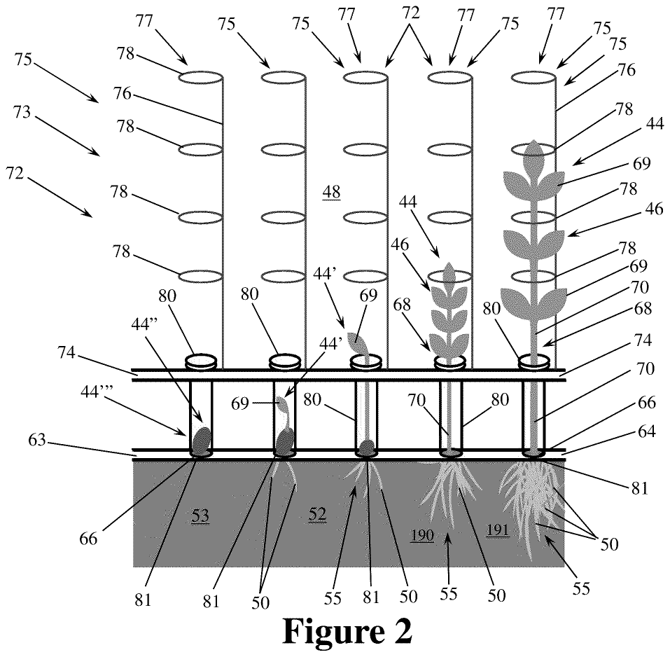

With additional reference to FIG. 2, chamber 42 can be equipped with a gas or liquid barrier 64 disposed between the growing atmosphere 48 and the growing medium 52. Barrier 64 preferably defines a demarcation line between growing atmosphere holding compartment 188 and growing medium liquid holding compartment 190. Barrier 64 preferably has an upper surface in contact with the growing atmosphere 48 and a lower oppositely facing surface in contact with the growing medium 52. Barrier 64 has a plurality of spaced openings 66 formed therein that each extend completely through barrier 64, each opening 66 configured for allowing part of a corresponding one of the plants 44, such as its roots 50 to extend downwardly therethrough into growing medium 52, and/or part of its shoot system 68, e.g. its stem 70, to extend upwardly therethrough into the atmosphere 48. For example, in the barrier 64 illustrated in FIG. 2, there is a separate through-opening 66 in the barrier 64 for each propagule 44″, seedling 44′ and/or plant 44 being grown in the chamber 42 to at least allow roots 50 of each to pass through and be at least partially immersed and preferably be substantially completely submerged in liquid medium 52 directly underneath and in contact with barrier 64.

With the exception of through-openings 66, barrier 64 preferably is of substantially gas-tight construction configuring barrier 64 to help prevent gases in the growing atmosphere 48, especially when pressurized to a pressure greater than the Earth's atmosphere, from diffusing into and/or dissolving in growing medium 52. Such a gas tight construction of barrier 64 can and preferably also does help configure it to help prevent oxygen and oxygen bubbles in oxygenated liquid growing medium 52 from outgassing from the medium 52. With the exception of through-openings 66, barrier 64 is also of substantially watertight construction configuring barrier 64 to help prevent liquid fertilizer 225, 225′ or 225″ introduced into growing atmosphere 48 and/or onto plants 44 during feeding of the plants 44 from flowing into or leaching into the medium 52. Barrier 64 extends between chamber walls 182a, 182b, 182c, 182d, is configured to form a watertight seal therewith that preferably also is gas-tight and can be attached to each one of the walls 182a, 182b, 182c, 182d in a manner that preferably also maintains the watertight and gas-tight seal therebetween. Fertilizer when referred to herein by part number 225 is simply a fertilizer containing a plurality of plant nutrients in accordance with fertilizer 225 disclosed in more detail below, while fertilizer referred to herein by part number 225′ is an enhanced fertilizer containing at least a plurality of plant nutrients along with at least one fertilizer enhancer like beneficial microbes to aid nutrient absorption, humic and/or fumic acids, biostimulants like kelp or seaweed extracts, chelating agents that bind with nutrients to keep them soluble, and adjuvants and/or surfactants. Finally, fertilizer when referred to by part number 225″ herein is an enhanced fertilizer containing one or more surfactants as disclosed in more detail below.

One preferred embodiment of barrier 64 is a gas and liquid impermeable barrier 63 disposed between the growing atmosphere 48 and the liquid growing medium 52 and is configured to (a) prevent gases in the growing atmosphere 48, especially when pressurized to a pressure greater than the Earth's atmosphere, from diffusing into and/or dissolving in the growing medium 52, and (b) prevent excess liquid fertilizer 225, 225′ or 225″ introduced into the growing atmosphere 48 and/or onto plants 44 during foliar feeding of the plants 44 not actually taken up by the plants 44 from flowing or otherwise leaching into the liquid growing medium 52. Such a barrier 64 can be additionally or instead further configured to collect excess fertilizer 225, 225′, 225″ not taken up by the foliage 46 of each plant 44 during foliar feeding of the plant 44 in a manner that enables the unused excess fertilizer 225, 225′, 225″ to be recycled and subsequently reused to fertilize the plants 44. For example, barrier 64 can be further configured so the excess fertilizer 225, 225′, 225″ is collected and recycled by reusing it to foliar feed at least one of the plants 44 in a subsequent feeding cycle. In another preferred embodiment and method, the barrier 64 can instead or also be configured to collect the excess fertilizer 225, 225′, 225″ and controllably deliver or release it via gravity into the liquid growing medium 52 below the barrier 64 for uptake of one or more of the nutrients in the fertilizer 225, 225′, 225″ by roots 50 of the seedlings 44′ and/or plants 44 immersed in growing medium 52.

Barrier 64 can be and preferably also is of light filtering or light blocking construction, such as by being light filtering or even being light impermeable, for limiting and preferably blocking light 394 used to irradiate the plants 44 in the chamber 42 from reaching the roots 50 and growing medium 52 underneath the barrier 64. Barrier 64 can be flexible and/or configured to float on the surface of the growing medium 52 in contact therewith, such as by being composed of a flexible light filtering or light blocking gas and liquid impermeable material, such as preferably in the form of a gas and liquid impermeable membrane 63 that is of flexible light filtering or light blocking construction, and which preferably is buoyant or light enough to float on the surface of liquid growing medium 52.

In one embodiment, barrier 64 is one of a floating polyethylene membrane, a silicone-coated fabric, and a multi-layer film comprising EVOH or PVDC as a gas barrier layer, has a thickness of at least 0.1 mm and no greater than 3 mm, and completely covers the liquid growing medium surface except at locations where plants 44 extend therethrough. Where plants 44 extend therethrough, barrier 64 has slits or perforations formed therein at plant stem locations that are each preferably sealed with flexible gaskets. Barrier 64 is constructed and arranged and configured to preferably prevent ≥99% of bulk gas transfer from the growing atmosphere into the liquid growing medium at a 400 kPa pressure differential therebetween. If desired, barrier 64 can be coated with an anti-algal compound, can be transparent or translucent to allow visual monitoring of the growing medium and/or roots of plants 44, and preferably is removable for cleaning including for cleaning of chamber 42. Barrier 64 can include one or more buoyancy elements to maintain it at the surface of the liquid growing medium and can be configured with root-guiding channels which can extend downwardly from the surface of the liquid growing medium into the liquid growing medium. Barrier 64 prevents CO₂ dissolution sufficient to prevent lowering of the pH of the liquid growing medium to below 5.5 and/or by 10% from the pH of the growing medium at the start of growing of plants 44 in the chamber 42. Barrier 64 preferably also substantially completely prevents oxygen loss from the liquid growing medium into the growing atmosphere.

With continued reference to FIG. 2, a plant support system 72 that is or includes a plant supporting rack 73 disposed in chamber 42 that has a plurality of horizontally spaced apart plant growing stations 75 each configured to support and guide plant growth from a propagule 44″, as a seedling 44′, and as a plant 44 throughout all stages of growth. Each station 75 can and preferably does include a tubular seedling container 80 carried by rack 73 which has an opening 81 at its bottom configured not only to expose a propagule 44″, such as a seed 44″′, disposed in the container 80 to liquid growing medium 52 in a manner which at least partially immerses the propagule 44″ in the medium 52 to facilitate germination and sprouting. Opening 81 also permits passage of roots 50 therethrough into growing medium 52 once the propagule 44″ germinates into a seedling 44′ and thereafter grows into a plant 44. Such a propagule 44″ can be in the form of a seed, cutting, bulb, rhizome, tuber, corm, runner (stolon), offset, spore or other type of plant propagule from which plant 44 can be grown.

The backbone of rack 73 is an elongate generally horizontally extending support beam 74 from which a horizontally spaced apart vertical plant support post 76 of each growing station 75 upwardly extends and which positions each one of the seedling containers 80 alongside a corresponding one of the support posts 76. Although not shown in FIG. 2, the support beam 74 can and preferably is anchored to part of the chamber 42, such as by being fixed to a wall or another part of the chamber 42. The support post 76 of each growing station 75 preferably also has a plant foliage supporting and plant growth directing cage 77 that includes at least a plurality of vertically spaced apart generally horizontally extending foliage support rings 78 that each extend outwardly from post 76. Together, the support post 76 and cage 77, preferably rings 78, of each station 75 are configured to support the foliage 46 of a single plant 44 grown in the station 75 in a manner that helps guide upward growth of the stem 70 of the plant 44 while structurally supporting and guiding growth of the foliage 46 of the plant 44.

Where chamber 42 utilizes such a barrier 64 between growing atmosphere 48 and growing medium 52, the bottom of each seedling container 80 preferably is seated in a corresponding one of the spaced apart through-openings 66 in the barrier 64. The through-opening 66 and barrier 64 are spaced apart and configured to not only help position the seedling container 80 relative to a corresponding support post and cage of its plant station, but to also help uprightly orient seedling container 80 in a manner that helps position and orient (a) a seedling 44′ growing in container 80, or (b) the stem 70 of a plant 44 supported and guided by the container 80. Where seedling containers 80 are not used, each one of through-openings 66 in barrier 64 can be further configured to help uprightly support a corresponding seedling 44′ or plant 44, such as by barrier 64 providing support to the part of stem 70 and/or roots 50 of seedling 44′ or plant 44 that extends through corresponding opening 66 in barrier 64 so the foliage 46 of seedling 44′ or plant 44 is disposed in growing atmosphere 48 on one side of the barrier 64 and its roots 50 are immersed in growing medium 52 on the other side of barrier 64.

As is discussed in more detail below, oxygenation system 54 is configured to oxygenate liquid growing medium 52 with enough oxygen to supersaturate and/or hyperoxygenate medium 52 with oxygen, including in the form of nanosized oxygen bubbles diffused and/or dissolved therein. The nanosized oxygen bubbles advantageously remain in growing medium 52 for an extended period of time of at least two weeks, more preferably at least three weeks, and even more preferably at least one month, and enabling roots 50 of a root system 55 of plants 44 in chamber 42 to be substantially completely immersed in liquid medium 52 during one or more and preferably all plant growth stages. To keep the oxygen 98′, including nanosized oxygen bubbles 99′, in the aqueous liquid medium 52 by preventing it from escaping therefrom, medium 52 preferably is kept at a temperature of between about 18° C. and about 24° C. as the solubility of oxygen 98′ in aqueous medium 52 is optimized between these temperatures.

Growing atmosphere operating system 56 is configured to pressurize and maintain the pressure of growing atmosphere 48 in chamber 42 at a pressure that is greater than the Earth's atmosphere, which preferably is at least 300 kPa. Atmosphere operating system 56 also is configured to control or otherwise regulate the percentage of at least CO₂ in growing atmosphere 48 to maintain it above the percentage of CO₂ present in the Earth's atmosphere and which preferably maintains atmosphere 48 at a percentage of at least 0.06% CO₂ by volume. Keeping growing atmosphere 48 pressurized also helps prevent the oxygen in growing medium 52 from escaping from the medium 52 thereby advantageously helping to maintain a higher level of oxygen in medium 52 for a substantially longer period of time.

Plant feeding system 58 preferably is or includes a foliar feeding system 65 that is configured to deliver liquid fertilizer containing one or more plant nutrients to foliage 46 of plants 44 in chamber for foliar uptake by the plants 44 including preferably through stomata of the plants 44. In a preferred embodiment, feeding system 58 is or includes a stomatal feeding system 71 configured to deliver liquid fertilizer in a manner which is conducive to uptake by stomata of foliage 46 of plants 44 in chamber 42 and which uses an enhanced fertilizer specially formulated with a surfactant which increases the efficiency of stomatal feeding as the surfactant decreases the surface tension of the fertilizer enabling it to be more readily drawn into and/or wick into pores of the stomata thereby more readily taking up more of the fertilizer more rapidly into plants 44.

Plant lighting system 62 is configured to collect and transport sunlight to chamber 42 for irradiating the foliage 46 of plants 44 disposed in growing atmosphere 48 of chamber 42 with light having wavelength(s) and luminous intensity sufficient for plant photosynthesis. Plant lighting system 62 can be and preferably is configured to selectively filter out UV and/or IR light from the light delivered to plants 44 in chamber 42 to prevent UV and/or IR light from reaching foliage 46 of the plants 44.

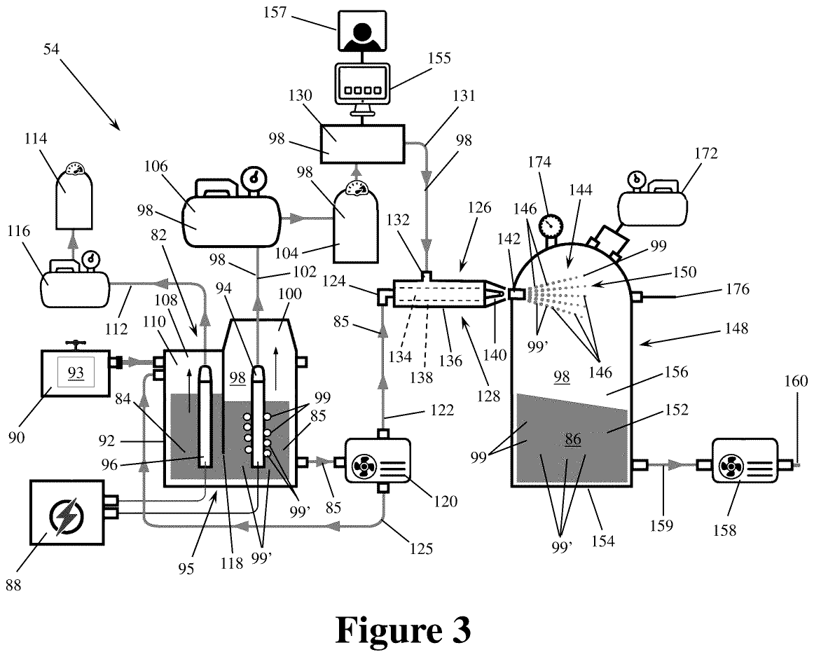

FIG. 3 is a diagram of growing medium oxygenation system 54 of growing system 40 that is configured to oxygenate aqueous growing medium 52 with oxygen for uptake by roots 50 of plants 44 in chamber 42. Oxygenation system 54 is configured to supply enough oxygenated aqueous liquid, such as preferably oxygenated water, so that growing medium 52 in chamber 42 contains at least 2 mg of oxygen per liter (mg/L) of growing medium 52, preferably at least 3 mg/L of oxygen, more preferably at least 5 mg/L of oxygen, and even more preferably between about 6.5 mg/L and about 8 mg/L of oxygen, preferably in the form of or including oxygen bubbles 99 which are nanosized oxygen bubbles 99′ diffused and/or dissolved in growing medium 52 having bubble sizes, namely bubble diameters, ranging between 1 nanometer (nm) and 200 nm, preferably less than 150 nm, and more preferably less than about 100 nm. Oxygenating, preferably supersaturating and/or hyperoxygenating, medium 52 so it has at least 2 mg of oxygen per liter (mg/L) of the growing medium, preferably at least 3 mg/L of oxygen, more preferably at least 5 mg/L of oxygen, and even more preferably between about 6.5 mg/L and about 8 mg/L of oxygen, where at least 50%, preferably at least 65%, and more preferably at least 85% of oxygen in the medium 52 is in the form of nanosized oxygen bubbles advantageously enables immersion of at least 50%, preferably at least 75%, more preferably at least 85%, and even more preferably at least about 95% of the plant's roots 50 in growing medium 52. This advantageously enables more efficient and greater oxygen uptake by plants 44 being grown in chamber 42 thereby advantageously increasing plant metabolism, root growth, root mass, vegetative growth, yield, and/or decreasing yield time, while preferably also beneficially extending plant life and the number of harvests of each plant 44 before plant senescence, dormancy and/or death.

An oxygenation system 54 of the present invention is configured to supply oxygenated aqueous growing medium makeup liquid 86 to chamber 42 during growing system operation that is a hyperoxygenated growing medium makeup liquid 86 supersaturated with oxygen which has a desirably high dissolved oxygen level of at least 2 mg/L, preferably at least 3 mg/L, more preferably at least 5 mg/L, preferably between 5 and 8 mg/L, and even more preferably between about 6.5 mg/L and about 8 mg/L of oxygen per liter of makeup liquid 86 to achieve and maintain a desirably high oxygen level in the growing medium 52 in chamber 42 of at least 2 mg/L, preferably at least 3 mg/L, more preferably at least 5 mg/L, preferably between 5 and 8 mg/L, and even more preferably between about 6.5 mg/L and about 8 mg/L of oxygen per liter of growing medium 52. In one preferred embodiment and method implementation, oxygenation system 54 supplies makeup liquid 86 having a desirably high oxygen level of at least 2 mg/L, preferably at least 3 mg/L, more preferably at least 5 mg/L, preferably between 5 and 8 mg/L, and even more preferably between about 6.5 mg/L and about 8 mg/L of oxygen per liter of makeup liquid 86 to maintain a corresponding desirably high oxygen level in the growing medium 52 in chamber 42 of at least 1 mg/L, preferably at least 2 mg/L, more preferably at least 3 mg/L, and even more preferably between about 5 mg/L and about 6.5 mg/L of oxygen per liter of growing medium 52 during plant growing system operation. The oxygen level of the growing medium 52 is sensed and monitored during growing system operation and the oxygenation system 54 is configured to controllably supply makeup liquid 86 to chamber 42 when the growing medium oxygen level drops below a corresponding one of the aforementioned predetermined desired oxygen levels until the oxygen level of the growing medium 52 reaches or exceeds the predetermined desired oxygen level. The growing medium oxygen level preferably is constantly monitored during growing system operation with the oxygenation system 54 supplying makeup liquid 86 as needed to maintain the predetermined desired oxygen level of the growing medium 52 in chamber 42.

Oxygenation system 54 utilizes an electrolyzer 82 containing an aqueous electrolyte 84 from which oxygen gas 98 is generated and used in the production of oxygenated growing medium makeup liquid 86 controllably discharged from the oxygenation system 54 to growing chamber 42. The oxygenated makeup liquid 86 is used as the oxygenated aqueous growing medium 52 in chamber 42 and is periodically supplied to chamber 42 to replenish growing medium 52 lost to evaporation and transpiration (evapotranspiration), as well as when needed to increase the oxygen level of growing medium 52 in chamber 42 when it is sensed to have dropped below a desired predetermined oxygen level.

While electrolyte 84 preferably is composed substantially completely of water, electrolyte 84 can include one or more additives, such as to improve conductivity by providing charge carriers (ions), facilitate ion transport, and/or maintain stable pH during electrolysis. For example, electrolyte 84 can contain one or more of potassium hydroxide (KOH), sodium hydroxide (NaOH), sulfuric acid (H₂SO₄), sodium chloride (NaCl), and/or baking soda (sodium bicarbonate) to improve conductivity by providing charge carriers (ions), facilitate ion transport, and/or maintain stable pH.

To advantageously more efficiently and more quickly oxygenate growing medium makeup liquid 86, electrolyzer 82 is configured to oxygenate some of the aqueous electrolyte 84 during electrolysis producing an electrolyzer pre-oxygenated aqueous oxygenation system makeup liquid 85. Oxygenation system makeup liquid 85 is discharged from electrolyzer 82 and subsequently further oxygenated with gaseous oxygen 98 generated by electrolyzer 82 during operation of oxygenation system 54 to produce oxygenated makeup liquid 86 as described in more detail below.

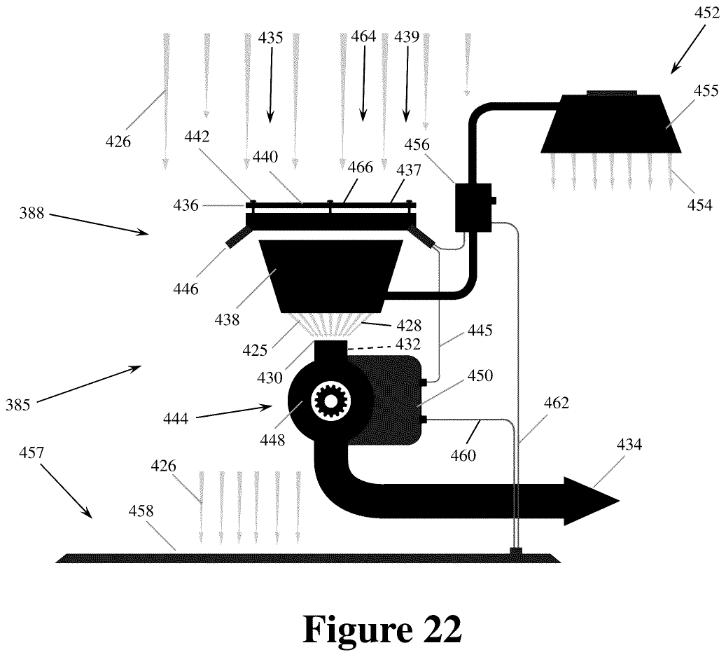

Electrolyzer 82 can be and preferably is electrically powered by a power unit 88 that is, obtains, generates or is otherwise provided with electricity from a source of renewable energy (not shown), such as solar energy, wind-generated electrical power, geothermal energy, hydroelectric power, or another form of renewable energy. In one preferred embodiment, electrolyzer 82 and all the other components of oxygenation system 54 preferably are electrically powered by a power unit 88 which receives electricity generated by an array 457 of solar panels 458, such as depicted in FIG. 22, which are disposed above ground exteriorly of chamber 42. Power unit 88 can also include a battery bank which stores electricity from solar panel array 457 of to provide electricity to oxygenation system 54 when there is no sunlight or inadequate sunlight.

In a preferred oxygenation system embodiment and method of the present invention, a source 90 of water for electrolyte 84, such as a water well or preferably an underground aquifer 93, is delivered to an electrolyte tank 92 inside a housing 95 of electrolyzer 82, in which is immersed an anode 94 and a cathode 96. Anode 94 and cathode 96 are spaced apart from each other and electrically charged during electrolysis using power from power unit 88 to electrolyze the water 84. In a preferred embodiment, particularly where chamber 42 is disposed underground at a desired minimum depth below the surface of the earth which maintains chamber 42 at a desired substantially constant temperature and/or within a desired temperature range, water source 90 can be an underground aquifer that is disposed at a depth beneath the surface of the earth deeper than chamber 42, which can be disposed directly underneath chamber 42, and which provides water not only for the electrolyte of electrolyzer 82 but also for use in growing medium 52, preferably aqueous liquid hydroponic growing medium 53, liquid growing medium oxygenation system 54, and plant feeding system 58.

During electrolysis, anode 94 generates oxygen gas 98 that rises from electrolyte 84 and is collected in an oxygen gas collection chamber 100 inside electrolyzer 82 disposed above anode 94. Oxygen gas 98 in chamber 100 is transported via a conduit 102 to an oxygen gas storage reservoir 104, e.g., pressurized tank or pressure vessel, preferably using a compressor 106 disposed upstream of reservoir 104, which compresses and pressurizes oxygen gas 98 delivered to reservoir 104 to a pressure of at least 1200 kPa (at least about 175 psi), preferably at least about 1380 kPa (at least about 200 psi), and more preferably at least about 1725 kPa (at least about 250 psi). Hydrogen gas 108 generated by cathode 96 is collected in a hydrogen collection chamber 110 above cathode 96 and delivered by a conduit 112 to a hydrogen storage reservoir 114, e.g. pressurized tank or pressure vessel, with the collected hydrogen 108 preferably also pressurized, such as by using a compressor 116 disposed upstream of the reservoir 114. Oxygen chamber 100 is separated from hydrogen chamber 110 by a baffle 118 in electrolyzer 82 that extends downwardly therebetween with oxygen chamber 100 preferably having a greater volume than hydrogen chamber 110. Baffle 118 preferably also extends upwardly to a height higher than hydrogen chamber 110. Each one of gas storage reservoirs 104, 114 preferably is a pressurized gas storage reservoir that can be in the form of a tank, e.g., high pressure gas storage tank or pressurized tank, or a vessel, e.g. pressure vessel, which respectively stores pressurized gas therein.

At least some of oxygen 98 that forms on anode 94 of electrolyzer 82 during electrolysis of electrolyte 84 is in the form of oxygen bubbles 99 (exaggerated for clarity in FIG. 3), at least some of which are oxygen bubbles 99 which rise up out of electrolyte 84 and are collected in the oxygen collection chamber 100 above anode 94. This provides the oxygen 98 used in an atomized, preferably nebulized, liquid growing medium oxygenation process disclosed below to oxygenate liquid growing medium 52. Some of these oxygen bubbles 99′ which migrate out of electrolyte 84 can be formed of oxygen bubbles 99 which coalesce after formation on anode 94 into larger oxygen bubbles 99′ which then migrate out of electrolyte 84 into the collection chamber 100. While outgassing of bubbles 99′ can occur, the bubbles 99′ typically rise, such as through buoyancy, to the surface of electrolyte 84 until they are released into collection chamber 100, preferably forming an atmosphere of substantially pure oxygen gas 98 in chamber 100.

In a preferred embodiment and growing medium oxygenation method of the present invention, at least some of the anode-generated bubbles 99 can be and preferably are nanosized bubbles 99′ which become charged, preferably electrostatically charged, and more preferably charged via electrophoresis, i.e. electrophoretically charged, with a charge that preferably is a negative charge. At least some of the nanosized bubbles 99′ and preferably substantially all the nanosized bubbles 99′ are charged by an electric field, such as an electric field which can emanate from anode 94 or from another electric field generator disposed adjacent anode 94, charging the surface of bubbles 99′ with the desired negative charge. The negative charge carried by each one of nanosized bubbles 99′ stabilizes the nanosized bubbles 99′ in a manner that repels them from each other preventing them from (a) coalescing into larger non-nanosized oxygen bubbles 99, and/or (b) migrating out of electrolyte 84 into collection chamber 100. The negative charge carried by nanosized bubbles 99′ also stabilizes the bubbles 99′ in a manner that not only causes them to be repelled from each other, but which also repels them (a) from other larger non-nanosized bubbles 99 already present in the electrolyte 84 as well as (b) from other particles in the electrolyte 84. Doing so advantageously facilitates the charged nanosized bubbles 99′ going into solution in electrolyte 84. These charged nanosized bubbles 99′ which go into solution in electrolyte 84 oxygenate the electrolyte 84 producing an intermediately oxygenated aqueous makeup liquid 85 that is subsequently further oxygenated to increase its oxygen level to subsequently help produce oxygenated makeup liquid 86 used as oxygenated liquid growing medium 52 in growing chamber 42.

In such a preferred embodiment and growing medium oxygenation method of the invention, the oxygenated electrolyte 84 is a source of pre-oxygenated makeup water 85 drawn from electrolyzer 82 and subsequently further oxygenated as discussed elsewhere herein to produce oxygenated liquid growing medium 52. This can be used as the oxygenated liquid growing medium 52 in growing chamber 42 at startup and/or to replenish liquid growing medium 52 in chamber 42, such as to maintain the level of oxygen in the growing medium 52 in chamber 42 so it contains at least 2 mg/L, preferably at least 3 mg/L and more preferably at least 5 mg/L of oxygen per liter of growing medium 52.

During use and operation of oxygenation system 54, the pre-oxygenated makeup water 85 is combined with oxygen 98 from electrolysis using an atomized, preferably nebulized, liquid growing medium oxygenation process of the present invention described in more detail below. This is used to produce an oxygenated liquid growing medium 52 containing oxygen bubbles 99 that preferably include nanosized oxygen bubbles 99′. The oxygen bubbles 99 and especially the nanosized bubbles 99′ are uniformly dispersed within the growing medium 52, preferably by going into solution or being dissolved therein. The bubbles 99 and especially the nanosized bubbles 99′ are negatively charged. By being negatively charged, the nanosized oxygen bubbles 99′ advantageously remain in solution in the oxygenated liquid growing medium 52 for a longer period of time such that the growing medium 52 maintains a dissolved oxygen level in milligrams of oxygen per liter of growing medium 52 of at least 2 mg/L, preferably at least 3 mg/L, more preferably at least 5 mg/L, and even more preferably between 5 and 8 mg/L, in the growing medium 52 in chamber 42 for at least a plurality of weeks, preferably for at least three weeks, more preferably for at least one month, even more preferably at least six weeks, and yet even more preferably at least a plurality of months, i.e., at least two months. In a preferred embodiment and method, the oxygenated growing medium 52 is produced by supplying it with oxygenated makeup water from oxygenation system 54 having a dissolved oxygen level high enough for the growing medium 52 to maintain an oxygen level of at least 2 mg/L, preferably at least 3 mg/L, more preferably at least 5 mg/L, even more preferably at least 6.5 mg/L, yet even more preferably between 6.5 and 8 mg/L in the growing medium 52 in chamber 42 for at least a plurality of weeks, preferably for at least three weeks, more preferably for at least one month, even more preferably at least six weeks, yet even more preferably at least a plurality of months, i.e., at least two months, before requiring replenishment with additional oxygenated makeup water 86 supplied by the oxygenation system 54.

In a preferred embodiment and growing medium oxygenation method of the invention, each of the bubbles 99′ which are discharged from electrolyte 84 into oxygen collection chamber 100 have a size, preferably diameter, of no greater than 200 nm, preferably no greater than 150 nm, and more preferably no greater than about 100 nm. In one such preferred embodiment and method, at least some of the charged nanosized bubbles 99′ go into solution of the oxygenated aqueous electrolyte liquid growing medium makeup liquid 85. In one such preferred embodiment and method, nanosized bubbles 99′ include some bubbles 99′ having a size of no greater than 200 nm and other bubbles 99′ having a size no greater than 150 nm and the oxygenated liquid growing medium 52 made therewith or therefrom or composed thereof is oxygenated, preferably hyperoxygenated, and/or oxygen supersaturated, with sufficient oxygen in the form of nanosized oxygen bubbles 99′ and oxygen 98′ to retain an oxygen level of at least 2 mg/L, preferably at least 3 mg/L, and more preferably at least 5 mg/L in the growing medium 52 in growing chamber 42 for at least a plurality of weeks, preferably at least three weeks, and more preferably at least one month, and even more preferably at least six weeks before requiring re-oxygenation or replenishment. In another such preferred embodiment and method, the nanosized bubbles 99′ have a size no greater than 150 nm and include some bubbles 99′ having a size of no greater than 100 nm to maintain an oxygen level of at least 3 mg/L and preferably at least 5 mg/L in growing medium 52 in chamber 42 for at least three weeks, preferably at least one month, and more preferably at least six weeks before requiring re-oxygenation or replenishment.

In use and operation of oxygenation system 54 in carrying out a preferred implementation of an atomized, preferably nebulized, oxygenation process of producing oxygenated liquid growing medium 52 in accordance with the invention, pre-oxygenated makeup water 85 is drawn from electrolyzer 82 by a pump 120 that delivers it via a conduit 122 to a liquid intake 124 of an atomizer 126, preferably a nebulizer 128, like that depicted in FIGS. 1 and 3, which can be and preferably is composed of stainless steel. When oxygenated water, preferably oxygenated liquid growing medium 52, is not being generated by oxygenation system 54, the pump 120 is configured, such as with a valve, that redirects flow of electrolyzer oxygenated water 85 via a return conduit 125 back to electrolyzer 82.

While electrolyzer oxygenated water in the form of pre-oxygenated makeup water 85 is being delivered by pump 120 to atomizer 126 and preferably nebulizer 128, pressurized oxygen gas 98 from oxygen reservoir 104 is simultaneously controllably metered using gas flow regulator 130 via conduit 131 to pressurized gas intake 132 of atomizer 126, preferably nebulizer 128. The electrolyzer oxygenated water 85 travels through an elongate center tube 134 within an outer housing 136 of atomizer 126, preferably nebulizer 128, while pressurized oxygen 98 travels through an elongate annular gas transport conduit 138 formed between center tube 134 and outer housing 136. Both are mixed in a mixing chamber 140 further oxygenating the pre-oxygenated water 85 preferably producing a fully oxygenated water discharged out a nozzle 142 of atomizer 126, preferably nebulizer 128, in an atomized mist or cloud 144 of oxygenated droplets 146 into a pressurized oxygenated water collection vessel 148. The oxygenated droplets 146 are discharged into an oxygen-rich atmosphere 156 within vessel 148 and fall downwardly via gravity into a pool 152 of oxygenated water 86 disposed at the bottom of vessel 148. The oxygenated droplets 146 discharged from atomizer 126, preferably nebulizer 128, preferably contain at least 2 milligrams of oxygen per liter of growing medium 52, preferably contain at least 3 mg/L and more preferably contain at least 5 mg/L such that the droplets 146 are hyperoxygenated, preferably oxygen supersaturated.

With continued reference to FIGS. 1 and 3, at least the oxygen 98 can be and preferably is electrically charged, preferably electrostatically charged, with a negative charge, such as using an electric field, prior to and/or during mixing of oxygen 98 with pre-oxygenated water 85 and/or during discharge of the oxygenated mixture from the nozzle 142 forming oxygenated droplets 146 that are hyperoxygenated, preferably oxygen supersaturated with nanosized negatively charged oxygen bubbles dissolved therein. As a result of oxygenated droplets 146 containing negatively charged nanosized oxygen bubbles due to being pre-oxygenated in electrolyzer 82 and being introduced during mixing with oxygen 98 generated by electrolyzer 82 during electrolysis, the nanosized oxygen bubbles 99′ advantageously remain in solution when the droplets 146 reach chamber 42 such that the oxygenated liquid growing medium 52 advantageously retains or maintains an oxygen level of at least 2 mg/L, preferably at least 3 mg/L and more preferably at least 5 mg/L in chamber 42 for at least a plurality of weeks, preferably at least three weeks, more preferably at least one month, and even more preferably at least six weeks before requiring replenishment with more oxygenated liquid growing medium 52 supplied by oxygenation system 54 to chamber 42. In a preferred embodiment and oxygenation method, this also imparts an electrical charge to the discharged droplets 146 which preferably helps them more quickly travel downwardly towards and be assimilated into the oxygenated water pool 152 at the bottom of vessel 148.

In a preferred embodiment and method where a nebulizer 128 is used, the mist or cloud 144 is an aerosol 150 composed of oxygenated droplets 146 at least some of which, preferably at least 50% of the droplets 146, more preferably at least 75% of the droplets 146, even more preferably at least 85% of the droplets 146, and yet even more preferably at least 95% of the droplets 146, are nanosized droplets 146 having a droplet size, e.g., droplet diameter, of no greater than 200 nm, preferably no greater than about 150 nm, and more preferably no greater than about 100 nm, and/or which preferably also contain oxygen molecules dissolved therein as well as oxygen bubbles suspended therein, at least some of which are nanosized oxygen bubbles 99′ having a bubble size, preferably diameter, of no greater than 200 nm, preferably no greater than about 150 nm, and more preferably no greater than about 100 nm. In a preferred embodiment, droplets 146 discharged from nebulizer 128 are hyperoxygenated and/or supersaturated with oxygen with at least some of the discharged droplets 146, such as at least 50%, preferably at least 75%, more preferably at least 85%, and even more preferably at least 95% of droplets 146 containing nanosized oxygen bubbles 99′ dissolved or diffused therein.

More oxygen 98 than needed to oxygenate the pre-oxygenated makeup water 85 is supplied to atomizer 126, preferably nebulizer 128, in order to hyperoxygenate and preferably oxygen supersaturate the discharged droplets 146 not only with oxygen bubbles but also with molecular oxygen that dissolves in the droplets 146. Excess oxygen 98 discharged from atomizer 126, preferably nebulizer 128, not used to oxygenate the droplets 146 goes into the oxygen-rich atmosphere 156 disposed above the oxygenated water pool 152 in vessel 148.

While the atmosphere 156 in vessel 148 can contain some water vapor from the mist or aerosol of droplets 146 discharged from atomizer 126, preferably nebulizer 128, the atmosphere 156 in vessel 148 preferably is oxygen-rich by being substantially completely composed of oxygen gas 98.

When it is desired to oxygenate liquid growing medium 52 in chamber 42, an oxygenated water delivery pump 158 disposed between collection vessel 148 and the chamber 42 supplies oxygenated water 86 from pool 152 in vessel 148 via a conduit 160 to growing medium 52 in chamber 42. With reference once again to FIG. 1, conduit 160 leads to a growing medium intake 162 of chamber 42 that is in liquid flow communication with growing medium 52 in chamber 42 and which can also be indirectly or directly in fluid flow communication with an oxygenated growing medium recirculation loop 164 that recirculates growing medium 52 in chamber 42. As also shown in FIG. 1, recirculation loop 164 extends from an outlet 166 on one side or end of chamber 42 through a recirculation loop conduit 168 to another side or end, e.g., opposite side or end, of chamber 42 during plant growing system operation.

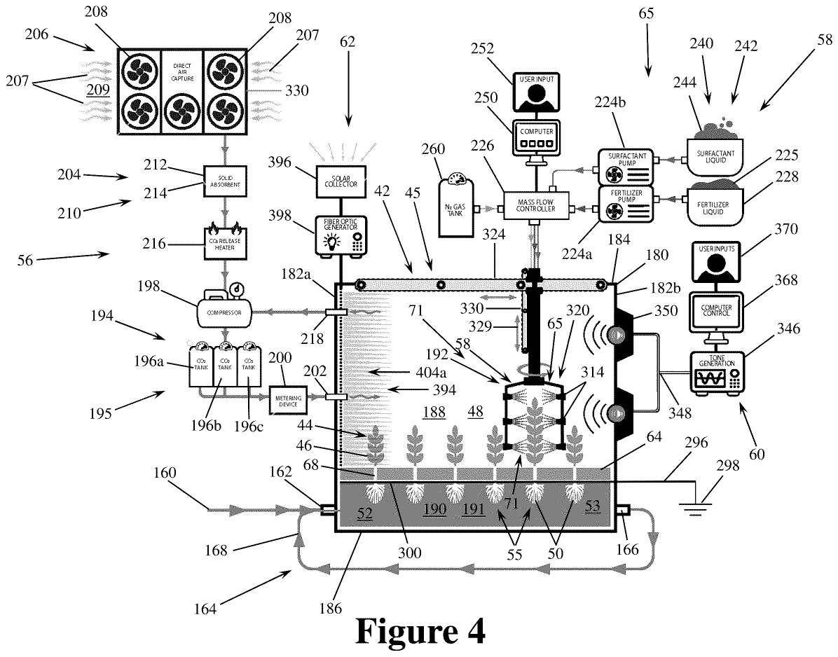

During oxygenation system operation, the flow of pressurized oxygen 98, such as preferably its flow rate or mass flow rate, from pressurized oxygen reservoir 104 to atomizer 126, preferably nebulizer 128, is controlled by oxygen regulator 130, which preferably is an oxygen flow regulator or an oxygen mass flow regulator, substantially simultaneously while the flow rate of the electrolyzer oxygenated water 85 from electrolyzer 82 to atomizer 126, preferably nebulizer 128, is controlled by controlling operation of pump 120. Operation of oxygenation system 54 preferably is controlled with or using a controller 155 that preferably is a processor-equipped device, such as preferably a computer, e.g., personal computer, smartphone, tablet, programmable logic controller, FPGA or another processor-equipped device configured, such as by user input 157, with firmware and/or software to carry out a method of controlling operation of oxygenation system 54 in accordance with a method the present invention where controller 155 is in communication with one or more sensors (not shown), including one or more oxygen sensors (not shown), such as one or more oxygen sensors in communication with oxygenated water 86 in pool 152 inside vessel 148 and/or one or more oxygen sensors in communication with oxygenated growing medium 52 in chamber 42, to control operation of oxygenation system 54, including controlling and/or regulating supply and delivery of electrolyte water 84 delivered from well 90, controlling and/or regulating operation of electrolyzer 82, controlling and/or regulating operation of atomizer 126, preferably nebulizer 128, including by controlling and/or regulating operation of pump 120 and/or oxygen regulator 130, as well as controlling and/or regulating delivery of oxygenated water 86 from vessel 148 to growing medium 52 in chamber 42. As previously noted, oxygenated water delivery conduit 160 can be in liquid flow communication with growing medium recirculation loop 164 that recirculates growing medium 52 within chamber 42 during plant growing system operation, such as by being connected to loop 164, such as in the manner depicted in FIGS. 1 and 4. Although not shown, a pump can be used, such as by being inserted inline in conduit 168 of recirculation loop 164, to recirculate growing medium 52, which can be substantially continuously, e.g. continuously, recirculated during plant growing system operation.

Pool 152 of oxygenated water 86 in vessel 148 preferably is maintained at a temperature of between about 18° C. and about 24° C. to increase the solubility of oxygenated water in pool 152 to enable it to accept more oxygen from the oxygen-rich atmosphere in vessel 148. The temperature of oxygenated water 86 in pool 152 can be maintained within this temperature range using a heater (not shown), such as a sensor or thermostat-controlled heater (not shown) in thermal communication with vessel 148 and/or the oxygenated water 86 in pool 148 in vessel 148, and/or whose heating operation is controlled by user input 157 and/or a controller, e.g., controller 155. Controller, e.g., controller 155, can be a processor equipped device like that discussed elsewhere herein, configured, such as with or in software and/or firmware, to communicate with one or more sensors, preferably temperature sensors, configured to sense the temperature of oxygenated water 86 in pool 152 in vessel 148 to sense the actual temperature of oxygenated water 86 within vessel 148 and control operation of the heater to maintain the oxygenated water temperature within the aforementioned desire temperature range. It is contemplated that such a heater arrangement, the arrangement of one or more temperature sensors, and controller, e.g., controller 155, along with operation of any recirculation loop pump, including pump 158, can be implemented to sense the temperature of growing medium 52 in chamber 42 and controllably heat the growing medium 52 and/or recirculate the medium 52 through recirculation loop 164 in a manner that maintains the temperature of growing medium 52 in chamber 42 at a temperature of between about 18° C. and about 24° C. to maintain supersaturation and/or hyperoxygenation of the growing medium 52 by maintaining a temperature high enough that prevents oxygen from being lost therefrom.

To further increase oxygenation of oxygenated water 86 in pool 152 of vessel 148, the oxygen-rich atmosphere 156 within vessel 148 is pressurized to a desired oxygen solubility-increasing pressure of at least 1200 kPa (at least about 175 psi), preferably at least about 1380 kPa (at least about 200 psi), and more preferably at least about 1725 kPa (at least about 250 psi) in carrying out a preferred method of operating oxygenation system 54. The increased pressure of oxygen-rich atmosphere 156 within vessel 148 increases oxygenation of oxygenated water 86 in pool 152 in vessel 148 by causing at least some oxygen in the collection vessel atmosphere 156 to diffuse or dissolve in oxygenated water 86 of pool 152. In a preferred embodiment and method of maintaining the pressure of growing atmosphere 48 at or above a desired predetermined pressure or within a desired predetermined range in accordance with the present invention, pressurizing oxygen 98 in pressurized reservoir 104 and pressurizing the oxygen-rich atmosphere 156 (preferably composed substantially completely of oxygen 98) within pressurized vessel 148 to a pressure of at least 1200 kPa (at least about 175 psi), preferably at least about 1380 kPa (at least about 200 psi), and more preferably at least about 1725 kPa (at least about 250 psi) helps pressurize the growing atmosphere 48 within chamber 42 to a desired pressure of at least 150 kPa or 21 psi, preferably at least 200 kPa or 29 psi, and more preferably at least about 300 kPa or at least about 43 psi, and which can be and preferably is no greater than 1200 kPa or 175 psi, more preferably no greater than 1000 kPa or 145 psi, even more preferably no greater than 800 kPa or about 115 psi, yet even more preferably no greater than about 600 kPa or about 87 psi, and still even more preferably no greater than about 500 kPa or about 72 psi. Since the oxygen 98 was pressurized at such an aforementioned desired pressure or pressure range when it went into solution during operation of the oxygenation system 54 that produced oxygenated water 86 supplied to growing medium 52 to oxygenate it, when pressurized oxygen 98′ in the growing medium 52 comes out of solution or outgasses into growing atmosphere 48, it helps pressurize the growing atmosphere 48 thereby helping to maintain the pressure of the growing atmosphere 48 at or above an aforementioned desired growing atmosphere pressure or within an aforementioned desired pressure range.

Atmosphere 156 inside vessel 148 is pressurized to such a desired oxygen solubility increasing pressure preferably using a compressor 172, connected like that depicted in FIG. 3, such that the compressor 172 takes in some of the atmosphere 156, pressurizes it or compresses it, and discharges it back into the atmosphere 156 thereby increasing the pressure of the atmosphere 156. In a preferred embodiment and method, there are one or more pressure sensors configured to sense the pressure of the atmosphere 156 and which are in communication with a controller, such as controller 155, which is configured, such as by a user input 157, as well as in software and/or firmware, to operate compressor 172 when the pressure drops below a selected, e.g. user selected, one of the aforementioned oxygen solubility increasing pressures listed above until the pressure of the atmosphere 156 reaches or exceeds the selected aforementioned oxygen solubility increasing pressure. Vessel 148 preferably also is equipped with a pressure relief arrangement 174 that preferably includes a valve, e.g. pressure relief valve, and which can also include a pressure sensor or pressure gauge, and which is configured to relieve pressure when the pressure of atmosphere 156 in vessel 148 becomes greater than a predetermined or user selected pressure. If desired, vessel 148 can have a connection 176, such as to a source of oxygen (not shown in the drawings) to supply oxygen or additional oxygen if needed for the oxygenated water 86 to reach or even exceed one of the aforementioned desired oxygen percentages and/or maintain it within an aforementioned desired oxygen percentage range disclosed above.

During oxygenation system operation, vessel 148 has a discharge 159 in fluid-flow communication with the oxygenated water pool 152 that enables the oxygenated water makeup pump 158 to deliver oxygenated water 86 from the pool 152 through conduit 160 to intake 162 of growing chamber 42 where it is added to and/or mixed with growing medium 52 in the chamber 42 preferably increasing and/or maintaining the dissolved oxygen level of the growing media 52 so it contains at least 2 mg/L, preferably at least 3 mg/L more preferably at least 5 mg/L, preferably between 5 and 8 mg/L, and even more preferably between about 6.5 and about 8 mg/L of oxygen. As previously noted, the temperature of the oxygenated growing medium 52 preferably is kept at a temperature of between about 18° C. and about 24° C. to keep the oxygen in solution in the growing medium 52 and prevent effervescence or outgassing of the oxygen therefrom thereby advantageously maintaining its aforementioned desirably high oxygen level.

During oxygenation system operation, a controller e.g., controller 155, can be configured or further configured, such as via a user input 157 and/or in firmware and/or software, to monitor one or more sensors (not shown), such as preferably one or more oxygen sensors, located and configured to monitor the (a) amount of oxygen in the electrolyzer oxygenated water 85 being delivered to atomizer 126, preferably nebulizer 128, and (b) amount of oxygen in the oxygenated water 86 in vessel 148 and control or regulate oxygen regulator 130 based thereon to adjust the amount, flow or flow rate of oxygen 98 from storage reservoir 104 delivered to atomizer 126, preferably nebulizer 128, when the amount of oxygen in the oxygenated water 86 is less than a predetermined desired minimum dissolved oxygen threshold of at least 2 mg/L, preferably of at least 3 mg/L, more preferably of at least 5 mg/L, and even more preferably of at least about 6.5 mg/L, to discharge oxygenated water droplets 146 from atomizer 126, preferably nebulizer 128 containing a sufficiently high amount of oxygen to increase the level or content of oxygen in the oxygenated water 86 so it reaches and preferably exceeds one of the aforementioned predetermined desired minimum oxygen threshold levels. In a preferred embodiment, the dissolved oxygen content is between 5 and 8 mg/L. To achieve such a desired minimum oxygen content used to monitor the amount or percentage of oxygen in the growing medium 52 in chamber 42 and control operation of atomizer 126, preferably nebulizer 128, by controlling operation of pump 120 and/or the oxygen regulator 130 in this manner, it results in the production of a supply of oxygenated water 86 available as growing medium 52, to make-up growing medium 52, and/or replenish growing medium 52 that maintains such as desired level or amount of oxygenation and/or oxygen in growing medium 52 during growing system operation. When the oxygen level in the growing medium 52 is at or above the desired threshold, amount or percentage, the flow of electrolyzer oxygenated water 85 is returned to electrolyzer 82 using pump 120 via return 125. In one preferred embodiment and method of operating oxygenation system 54, controller, e.g., controller 155, can be configured or even further configured, including via user input 157, as well as in firmware and/or software, to cease delivery of oxygenated water 86 from oxygenation system 54 to growing medium 52 in chamber 42, such as by preferably stopping operation of at least pump 158 delivering oxygenated water 86 from reservoir 148 to chamber 42, when the amount of oxygen in the oxygenated growing medium 52 in chamber 42 exceeds a maximum oxygen threshold of 8.5 mg/L.

FIG. 4 is a portion of the diagram of FIG. 1 depicting certain components of growing chamber 42, growing atmosphere operating system 56, plant feeding system 58, acoustical stimulation system 60 and lighting system 62. Growing chamber 42 is configured to hold at least one plant 44 therein and preferably is configured to hold a plurality, preferably at least a plurality of pairs of, i.e. at least three, plants 44 spaced apart from one another and do so beginning from when each plant 44 was a seed, e.g. seed 44″, and/or germinated therefrom, a cutting or seedling 44′ and/or grown therefrom, a bulb and/or grown therefrom, a tuber and/or grown therefrom, a rhizome and/or grown therefrom, or the like.

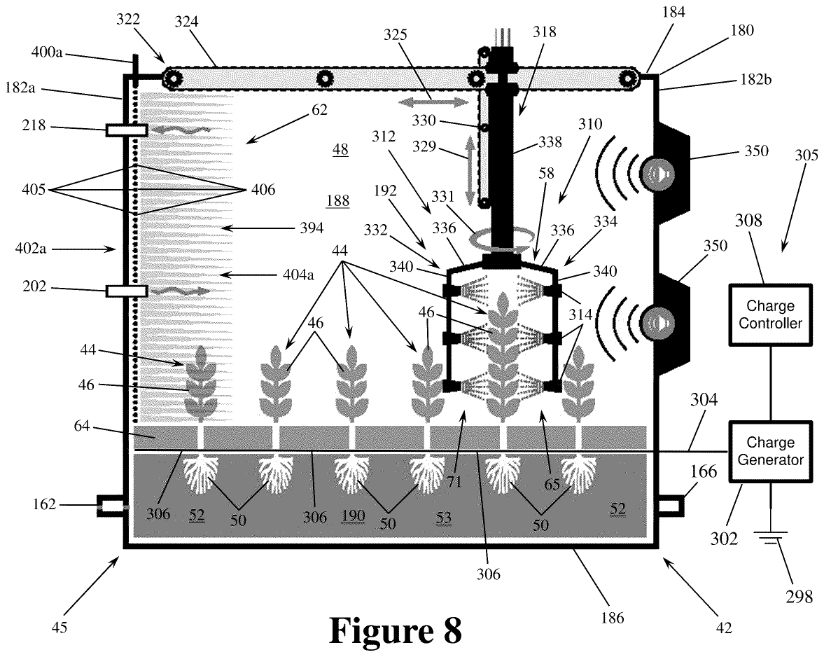

With additional reference to FIGS. 8 and 9, growing chamber 42 has an enclosure 180 that preferably is gas-tight and liquid-tight for enabling chamber 42 to function as and/or be a hyperbaric plant growing chamber 45. In at least one preferred embodiment and method, chamber 42 is a hyperbaric chamber 45 whose growing atmosphere 48 is maintained at a pressure that is greater than atmospheric pressure. The chamber enclosure 180 is formed of at least one wall 182a, 182b, 182c and 182d, can and preferably does have a top wall 184, and can and preferably does have a bottom wall 186. Enclosure 180 can be box shaped by having a generally rectangular cross-section that can be a generally square cross-section. With specific reference to FIG. 9, a preferred enclosure 180 is composed of a plurality of walls 182a, 182b, 182c and 182d disposed between top wall 184 and bottom wall 186 with one pair of walls 182a and 182b being sidewalls 182a, 182b and the other pair of walls 182c and 182d being front and rear walls 182c, 182d.

Chamber 42 has a growing atmosphere holding compartment 188 formed or otherwise disposed in a top or upper portion of enclosure 180 which holds growing atmosphere 48, and a growing medium holding compartment 190 formed or otherwise disposed in enclosure 180 which holds growing medium 52 and which is located below compartment 188. Chamber 42 can include and preferably is equipped with aforementioned barrier 64 with barrier 64 extending from front wall 182c to rear wall 182d and between sidewalls 182a and 182b of enclosure 180. Barrier 64 has outer edges which preferably extend to adjacent and/or abut all the walls 182a, 182b, 182c and 182d of enclosure 180. Where barrier 64 is employed, barrier 64 can be and preferably is sealed along outer edge of the barrier 64 to each corresponding growing chamber enclosure wall 182a, 182b, 182c and 182d with which it abuts or adjoins.

Also disposed within chamber 42 is a plant feeder 192 of plant feeding system 58 of the present invention that is carried by part of enclosure 180, such as preferably top wall 184, and which is movable within chamber 42 relative to chamber 42 and one or more plants 44 in chamber 42 to more efficiently feed one or more of the plants 44 in chamber 42 during foliar feeding, preferably stomatal feeding, of plants 44 during feeding system operation. As is discussed in more detail below, feeder 192 is configured to be movable inside chamber 42 relative to a single one of the plants 44 being fed during a plant feeding cycle by delivering fertilizer containing one or more nutrients to foliage 46 of the plant 44 to foliar feed the plant 44. As is also discussed in more detail below, fertilizer preferably is delivered in the form of droplets 236, preferably nanosized droplets, which are more readily taken up by stomata of foliage 46 of plant 44 during a feeding cycle, which are more readily taken up by stomata of plant 44 due to being subjected to growing atmosphere 48 pressurized to greater than atmospheric pressure, preferably to a pressure of at least 150 kPa or 21 psi, more preferably to a pressure of at least 300 kPa or 43 psi, which fertilizer droplets 236 can also contain a surfactant to further facilitate stomatal uptake by plant 44, and which stomatal uptake can be even further facilitated by acoustical stimulation from acoustical stimulation system 60 opening stomata of plant 44 during a feeding cycle.

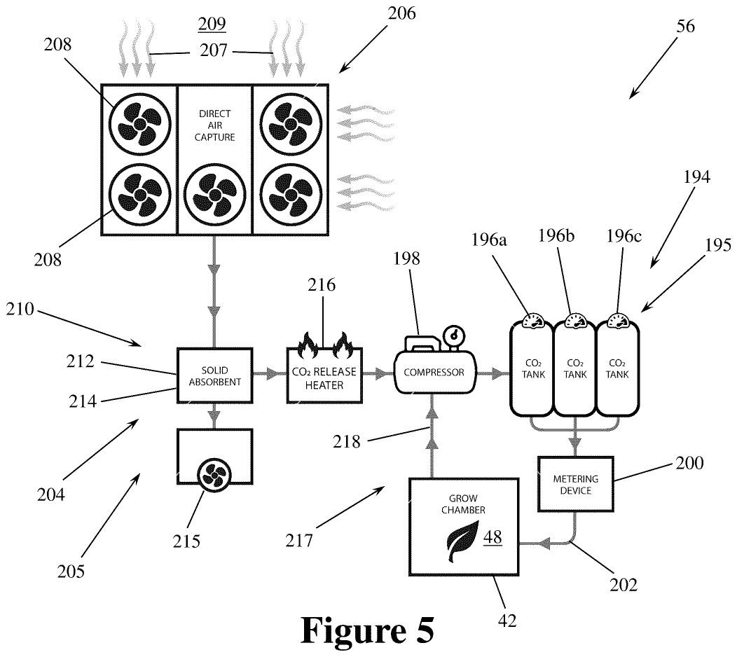

With additional reference to FIG. 5, growing atmosphere operating system 56 is configured to control and/or regulate one or more aspects of growing atmosphere 48 within the growing atmosphere holding compartment 188 of chamber 42 during germination and/or growth of plants 44 throughout the various stages of plant growth during plant growing system operation. In a preferred embodiment and method, growing atmosphere operating system 56 includes a gas supply system 194 configured to supply at least one gas to growing atmosphere 48 and which can be and preferably also is configured to pressurize the atmosphere 48, including by supplying pressurized gas to the atmosphere 48 and/or pressurizing the atmosphere 48, and/or maintain a pressure of the atmosphere 48, including by supplying pressurized gas to the atmosphere 48 and/or pressurizing the atmosphere 48, so the atmosphere 48 has a pressure that is greater than atmospheric pressure and which preferably is between a minimum pressure of at least 150 kPa or 21 psi, preferably at least 200 kPa or 29 psi, and more preferably at least about 300 kPa or at least about 43 psi, and a maximum of no greater than 1200 kPa or 175 psi, preferably no greater than 1000 kPa or 145 psi, more preferably no greater than 800 kPa or about 115 psi, even more preferably no greater than about 600 kPa or about 87 psi, and yet even more preferably no greater than about 500 kPa or about 72 psi. Such a pressure is maintained within chamber 42 during one or more, preferably during at least a plurality of, more preferably during at least a plurality of pairs of, and even more preferably during each one of the germination, seedling, vegetative growth, flowering or budding, pollination and/or fertilization, fruiting/seed formation, ripening and/or maturation, and/or senescence, dormancy and/or death stages of plant growth of plants 44 grown in chamber 42 thereby advantageously increasing a rate of foliar feeding by increasing a rate of fertilizer uptake through stomata of plant 44, increasing one or more of the growth rate of plant 44, increasing the vegetation growth rate of plant 44, increasing the amount, such as the mass, of vegetative growth of plant 44, causing plant 44 to reach the flowering or budding stage more quickly, causing plant 44 to produce edible produce more quickly and in greater amounts, i.e., producing larger yields and/or a greater mass of produce per plant, while keeping edible produce from plant 44 fresher longer, and/or delaying senescence of plant 44 which can advantageously enable plant 44 to grow edible produce longer, have a plurality, and preferably at least a plurality of pairs, i.e. at least three, of edible produce harvests, and/or contribute to plant 44 producing greater yields of edible produce for an extended period of time compared to the same type or strain of plant conventionally grown hydroponically or conventionally grown outdoors in soil in the Earth's atmosphere at Earth's ambient pressure of about 1 atmosphere, about 101.3 kPa, or about 14.7 psi.

In a preferred growing atmosphere operating system embodiment and method of operation, growing atmosphere operating system 56 is configured not only to pressurize growing atmosphere 48 and/or maintain the pressure of growing atmosphere 48 at or above a selected one of the minimum pressures listed above and preferably at or below a selected one of the maximum pressures listed above, but also is configured to regulate at least one gas, such as CO₂ and/or oxygen, in growing atmosphere 48 and which can be configured to (a) supply the at least one gas to growing atmosphere 48 where the percentage of the at least one gas in the growing atmosphere 48 falls below a predetermined minimum percentage, and/or (b) remove the at least one gas from growing atmosphere 48 where the percentage of the at least one gas in growing atmosphere 48 exceeds a predetermined percentage. Such a preferred growing atmosphere operating system and method can be and preferably also is configured to regulate and maintain the relative humidity of growing atmosphere 48 to be at least about 80% and preferably is maintained at a relative humidity of about 85%±2% for advantageously optimizing plant photosynthesis and facilitating opening of stomata 374 of foliage 46 of plants 44 in chamber 42 which therefore increases and preferably optimizes CO₂ uptake through these stomata 374.

In one preferred growing atmosphere operating system embodiment and method where system 56 is configured to regulate the percentage of oxygen in growing atmosphere 48, system 56 can be and preferably is configured to remove oxygen in atmosphere 48 produced by plants 44 growing in chamber 42 during respiration by plants 44 and/or from oxygen outgassing from liquid growing medium 52 when the amount of oxygen in the growing atmosphere 48 exceeds a predetermined maximum percentage preferably of no greater than about 15% by volume, preferably no greater than about 18% and more preferably no greater than the percentage of oxygen in the Earth's atmosphere (about 21% by volume). In another preferred embodiment and method, growing atmosphere operating system 56 is configured to maintain a percentage of oxygen in the growing atmosphere 48 to no more than 25%, preferably no more than about 21%, and more preferably no more than about 18%. Although not shown, an oxygen scrubber, a membrane oxygen separator, and/or a pressure swing adsorption system can be used to remove oxygen from growing atmosphere 48 where it exceeds a predetermined maximum percentage, such as a user or controller selected one of the predetermined maximum oxygen percentages listed hereinabove.

Where a growing atmosphere operating system 56 of the present invention is configured or further configured to regulate the percentage of CO₂ in growing atmosphere 48, system 56 can be and preferably is configured to regulate the percentage of CO₂ such as preferably by providing a gas supply system 194 that is a CO₂ gas supply system configured to supply CO₂ to growing atmosphere 48 in chamber 42 to maintain the percentage of CO₂ in atmosphere 48 at least above the percentage of CO₂ in the Earth's atmosphere (about 0.043% by volume). In a preferred embodiment and method, growing atmosphere operating system 56 is configured to regulate CO₂ in growing atmosphere 48 to maintain the percentage of CO₂ in the atmosphere 48 at or above a minimum percentage of at least 0.05% by volume, preferably at least 0.06%, more preferably at least 0.08%, and even more preferably at least 0.10% advantageously resulting in one or more of the following occurring: opening and/or increasing the size of pores of stomata of foliage of plant 44 increasing uptake of CO₂ into plant 44 and uptake of fertilizer during feeding of plant 44, increasing one or more of the growth rate of plant 44 and/or the vegetation growth rate of plant, increasing the amount, e.g., mass, of vegetation of plant 44, causing plant to reach the flowering or budding stage more quickly, causing plant 44 to produce edible produce more quickly and in a greater amount, i.e., produce larger yields or greater mass of edible produce per plant 44, and/or maintaining the freshness of edible produce harvested from plant 44 for a longer period of time after harvest, and/or delaying senescence of plant 44 which can advantageously enable the plant 44 to grow edible produce longer, have a plurality, and preferably a plurality of pairs of, i.e. at least three, edible produce harvests, and/or contribute to plant 44 producing greater yields or a greater mass of edible produce for an extended period of time compared to the same type or strain of the plant conventionally grown hydroponically or outdoors in soil in the Earth's atmosphere containing no more than about 0.043% CO₂ gas. In at least one such embodiment and method, system 56 is further configured to regulate the percentage of CO₂ in growing atmosphere 48, so it does not exceed a maximum percentage of 0.20% by volume, preferably does not exceed 0.30%, and more preferably does not exceed 0.40%. At substantially the same time, this carbon-rich or carbon-gas enhanced growing atmosphere 48 in chamber 42 also is pressurized to a minimum pressure of at least 150 kPa or 21 psi, preferably at least 200 kPa or 29 psi, and more preferably at least about 300 kPa or at least about 43 psi, and within a maximum of no greater than 1200 kPa or 175 psi, preferably no greater than 1000 kPa or 145 psi, more preferably no greater than 800 kPa or about 115 psi, even more preferably no greater than about 600 kPa or about 87 psi, and yet even more preferably no greater than about 500 kPa or about 72 psi advantageously increasing uptake of CO₂ through foliage 46 of plants 44 in chamber 42 and uptake of fertilizer, including through stomata of plants 44 during foliar feeding of each plant 44, increasing one or more of the growth rate of plants 44 and/or the vegetation growth rate of plants 44, increasing the amount or mass of vegetation of plants 44, causing plants 44 to reach the flowering or budding stage more quickly, causing plants 44 to produce edible produce more quickly and in greater amounts, i.e., produce larger yields, and/or maintaining the freshness of edible produce harvested from plants 44 for a longer period of time after harvest, and/or delaying senescence of plants 44 which can advantageously enable plants 44 to grow edible produce longer, have a plurality, and preferably a plurality of pairs of, i.e. at least three, edible produce harvests, and/or contribute to plants 44 producing greater yields of edible produce for an extended period of time compared to the same type or strain of plants 44 conventionally grown hydroponically or grown outdoors in soil in the Earth's atmosphere having a pressure of no more than about 1 atmosphere, about 101.3 kPa, or about 14.7 psi and which contains no more than about 0.043% CO₂ gas. The relative humidity of such a carbon-enriched highly pressurized growing atmosphere 48 preferably is maintained at about 85%±2% for opening and/or maintaining opening of stomata 374 of plant's foliage 46 disposed in atmosphere 48 for optimizing CO₂ uptake through the stomata 374. Maintaining humidity at about 85%±2% also advantageously optimizes plant photosynthesis when light 394 is irradiating foliage 46 of the plants 44 in the chamber 42.

In one embodiment and method, system 56, including CO₂ gas supply system 194, is configured to selectively vary the percentage of CO₂ in growing atmosphere 48 to be within a range of between 0.05% and 0.40% in a manner that controllably stimulates guard cells of stomata of foliage of the plants 44 to open pores of stomata of plants 44 and/or open more the pores of stomata of plants 44 such as preferably when it is desired to increase uptake of CO₂ into each one of plants 44 and/or when it is desired for plant(s) 44 undergoing a feeding cycle to uptake through its stomata fertilizer delivered by feeder 192 of feeding system 58. In at least one embodiment, system 56, including CO₂ gas supply system 194, can also be configured to selectively vary the percentage of CO₂ in growing atmosphere 48 in a manner that opens less and/or preferably closes pores of stomata of plants 44, such as when it is no longer desired for uptake of CO₂ to take place, and/or such as when the feeding cycles for all the plants 44 in chamber 42 are finished.

In at least one such embodiment and method, system 56, including CO₂ gas supply system 194, is configured to selectively increase the percentage of CO₂ in growing atmosphere 48 within one of a predetermined selected range of between 0.05% and 0.40%, 0.06% and 0.3%, 0.08% and 0.2%, and 0.1% and 0.2% to stimulates guard cells of stomata of foliage of plants 44 to increasingly open pores of stomata of foliage 46 of plants 44 in chamber 42 as the percentage of CO₂ in growing atmosphere 48 is controllably increased, such as from or from adjacent one of the aforementioned minimum percentages of a selected one of the aforementioned ranges toward, to adjacent, or to the corresponding one of the aforementioned maximum percentages of the selected one of the aforementioned ranges. In such an embodiment and method, system 56, including CO₂ gas supply system 194, can also be and preferably also is configured to selectively decrease the percentage of CO₂ in growing atmosphere 48 within one of the aforementioned predetermined selected ranges of between 0.05% and 0.40%, 0.06% and 0.3%, 0.08% and 0.2%, and 0.1% and 0.2% to cause guard cells of the stomata of foliage 46 of plants 44 in chamber 42 to increasingly close the pores of stomata of the plants 44 as the percentage of CO₂ in the growing atmosphere 48 is controllably decreased, such as from or from adjacent one of the aforementioned maximum percentages of a selected one of the aforementioned ranges toward, to adjacent, or to a corresponding one of the aforementioned minimum percentages of the selected one of the aforementioned ranges. At substantially the same time, growing atmosphere 48 in chamber 42 also maintained at (a) a minimum pressure of at least 150 kPa or 21 psi, preferably at least 200 kPa or 29 psi, and more preferably at least about 300 kPa or at least about 43 psi, and (b) at a maximum pressure of no greater than 1200 kPa or 175 psi, preferably no greater than 1000 kPa or 145 psi, more preferably no greater than 800 kPa or about 115 psi, even more preferably no greater than about 600 kPa or about 87 psi, and yet even more preferably no greater than about 500 kPa or about 72 psi advantageously increasing uptake of CO₂ by plants 44 and increasing stomatal uptake of fertilizer by plants 44 during foliar feeding of plants 44, increasing one or more of the growth rate of plants 44 and/or the vegetation growth rate of plants 44, increasing the amount of vegetation on or of plants 44, causing plants 44 to reach the flowering or budding stage more quickly, causing plant 44 to produce edible produce more quickly and in a greater amount, i.e., produce larger yields, and/or maintaining the freshness of produce harvested from plants 44 for a longer period of time after harvest, and/or delaying senescence of plants 44 which can advantageously enable plants 44 to grow edible produce longer, have a plurality, and preferably a plurality of pairs of, i.e. at least three, edible produce harvests, and/or contribute to plants 44 producing greater yields of edible produce for an extended period of time compared to the same type or strain of the plant conventionally grown hydroponically or outdoors in soil in the Earth's atmosphere having a pressure of no more than about 1 atmosphere, about 101.3 kPa, or about 14.7 psi and which contains no more than about 0.043% CO₂ gas.

With continued reference to FIG. 5, a preferred embodiment of growing atmosphere operating system 56 includes a gas supply system 194 configured to supply CO₂ to growing atmosphere 48 to maintain the percentage of CO₂ in growing atmosphere 48 during growing system operation above the percentage in the Earth's atmosphere, preferably at least 0.05% and no greater than 0.4% CO₂, more preferably at least 0.06% and no greater than 0.3% CO₂, and even more preferably at least 0.08% and no greater than 0.2% CO₂ during at least one or more of the seedling stage, vegetative growth stage, and flowing or budding stage of growth of plants 44 in chamber 42. However, during germination and/or sprouting of propagules 44″, growing atmosphere operating system 56 is operated to limit the percent of CO₂ in growing atmosphere 48 to be no greater than the percentage of CO₂ in the Earth's atmosphere, i.e., no greater than 0.4% CO₂, and the percentage of oxygen in growing atmosphere 48 is increased to be at least the same as or greater than the percentage of oxygen in the Earth's atmosphere, i.e., at least 20.95% oxygen, to facilitate germination and sprouting. After germination after the propagule 44″ develops shoots and matures into a seedling 44′, growing atmosphere operating system 56 is operated to increase the percent of CO₂ in the growing atmosphere 48 to be between 0.05% and 0.4% CO₂, preferably to be between 0.06% and 0.3% CO₂, and more preferably to be between 0.08% and 0.2% CO₂.

CO₂ gas supply system 194 of growing atmosphere operating system 56 includes a pressurized CO₂ gas storage reservoir 195 in the form of one or more pressure vessels, e.g., pressurized gas storage tanks 196a, 196b, 196c, which each hold pressurized or liquified CO₂ that preferably has been pressurized using a compressor 198 or liquified using compressor 198 and a cooling system (not shown) configured for cooling the pressurized CO₂ down to its saturation point. Gas supply system 194 preferably has a CO₂ gas metering device 200, e.g., a gas regulator, such as a gas flow regulator or gas mass flow regulator, which delivers CO₂ gas to chamber 42 via a CO₂ gas discharge duct 202. CO₂ gas metering device 200 preferably is configured, such as in software and/or firmware and/or via user input, to regulate the amount and/or flow of CO₂ from reservoir 195 discharged through duct 202 into chamber 42 during growing of plants 44 to control the percentage of CO₂ in growing atmosphere 48 to maintain a percentage of CO₂ in growing atmosphere 48 of at least 0.05% and no greater than 0.4%, more preferably at least 0.06% and no greater than 0.3%, and even more preferably at least 0.08% and no greater than 0.2%. In a preferred embodiment and method of controlling the percentage of CO₂ in growing atmosphere 48, metering device 200 is in communication with a CO₂ gas sensor (not shown) preferably disposed in the growing atmosphere 48 in the chamber 42 and configured, such as in software and/or firmware and/or via user input, to controllably meter CO₂ from pressurized reservoir 195 into the growing atmosphere 48 through discharge duct 202 as needed based upon the percentage of CO₂ gas in the growing atmosphere 48 to maintain a percentage of CO₂ in the growing atmosphere 48 of at least 0.05% and no greater than 0.4%, more preferably at least 0.06% and no greater than 0.3%, and even more preferably at least 0.08% and no greater than 0.2%.

In another preferred embodiment and method of controlling the percentage of CO₂ in the growing atmosphere 48, a controller (not shown) is disposed in communication with a CO₂ sensor, such as by being electrically connected thereto, and the metering device 200, such as by also being electrically connected thereto, with the CO₂ sensor disposed in communication with the growing atmosphere 48, such as by being disposed in the atmosphere 48 and inside the chamber 42 and configured to sense the percentage of CO₂ in the growing atmosphere 48. The controller is configured in software and/or firmware and/or via user input to monitor the percentage of CO₂ in the growing atmosphere 48 sensed by the sensor and controllably operate the metering device 200 to discharge CO₂ gas from reservoir 195 through duct 202 into atmosphere 48 based upon the percentage of sensed CO₂ gas in the growing atmosphere 48 to maintain a percentage of CO₂ in the growing atmosphere 48 of at least 0.05% and no greater than 0.4%, more preferably at least 0.06% and no greater than 0.3%, and even more preferably at least 0.08% and no greater than 0.2%.

The gas supply system 194 preferably also includes a CO₂ gas generation system 204 that employs a CO₂ capturing system 205 that preferably is a direct air CO₂ capturing system. The direct air CO₂ capturing system 205 has an intake plenum and air handling unit 206 in communication with an atmosphere, such as an ambient atmosphere, disposed exteriorly of the growing chamber 42 that can be and preferably is in communication with the Earth's atmosphere for drawing the ambient atmosphere into it so CO₂ can be separated and captured therefrom. The air handling unit 206 has a plurality of air movers, each of which is a fan or blower 208, which draws a stream of fresh air 207 from the Earth's atmosphere 209, e.g., ambient atmosphere, and delivers it to a carbon or CO₂ capturing unit 210 that has a sorbent 212, preferably an adsorbent 214, which sorbs carbon and/or CO₂ in the air stream that passes therethrough before the remainder of the air stream that preferably is substantially free of CO₂ is thereafter returned to the ambient atmosphere using an exhaust air handling unit 215. Heat is then applied to sorbent 212, preferably by using a CO₂ release heater 216, to release the captured CO₂ gas from the sorbent 212. The released CO₂ gas is then pressurized, such as using compressor 198 (or liquified), before being stored the CO₂ storage reservoir 195.

CO₂ gas supply system 194 preferably includes a recirculation loop 217 that includes compressor 198, pressurized storage reservoir 195, gas metering device 200, discharge duct 202 in gas flow communication with growing atmosphere 48 of chamber 42 and an intake duct 218 in gas flow communication with atmosphere 48 of chamber 42 configured to remove CO₂ from growing atmosphere 48, compress the removed CO₂, store it in pressurized storage reservoir 195 and controllably meter CO₂ from reservoir 195 with metering device 200 to discharge CO₂ through duct 202 into atmosphere 48 as needed to maintain a percentage of CO₂ in atmosphere 48 of at least 0.05% and no greater than 0.4%, more preferably at least 0.06% and no greater than 0.3%, and even more preferably at least 0.08% and no greater than 0.2%. In a preferred embodiment, intake of compressor 198 can be in communication with a valve arrangement that includes a selectable gas valve configured to compress and pressurize either CO₂ gas from CO₂ release heater 216 or CO₂ enriched gas withdrawn from atmosphere 48 and discharge the compressed CO₂ gas to reservoir 195 for safekeeping until it is needed to supply CO₂ to atmosphere 48.

Metering device 200 and/or a controller preferably configured in software and/or firmware and/or via user input to communicate with a CO₂ sensor that senses the percentage of CO₂ in atmosphere 48, compressor 198, and the aforementioned valve arrangement to intake CO₂ enriched gas from atmosphere 48 through intake duct 218 of recirculation loop 217 and compress and pressurize the CO₂ rich gas for storage in reservoir 195 when the percentage of CO₂ in atmosphere 48 exceeds a predetermined desired maximum percentage of no greater than about 0.2% CO₂, preferably no greater than 0.3% CO₂, or no greater than 0.4% CO₂ to remove excess CO₂ from atmosphere 48. Metering device 200 and/or controller preferably are further configured in software and/or firmware and/or via user input to subsequently controllably meter CO₂ from reservoir 195 through discharge duct 202 into atmosphere 48 based on the sensed percent of CO₂ in atmosphere 48 from the sensor to maintain a percentage of CO₂ in the growing atmosphere 48 of at least 0.05% and no greater than 0.4%, more preferably at least 0.06% and no greater than 0.3%, and even more preferably at least 0.08% and no greater than 0.2%.

In another embodiment and method of reducing the percentage of CO₂ in growing atmosphere 48 below a predetermined desired maximum percentage of no greater than about 0.2% CO₂, preferably no greater than 0.3% CO₂, or no greater than 0.4% CO₂, recirculation loop 217 is modified such that instead of excess CO₂ containing atmosphere 48 being withdrawn from chamber 42 and delivered by intake duct 218 to compressor 198, intake duct 218 is modified or rerouted to deliver CO₂ enriched gas from atmosphere 48 to sorbent 212 of CO₂ capturing unit 210 which extracts CO₂ therefrom in the same manner as discussed above, pressurizes the extracted CO₂ using compressor 198, and stores the compressed CO₂ extracted from atmosphere 48 in reservoir 195. The remaining carbon-depleted gas from the extracted atmosphere 48 can be returned, such as via another duct, to atmosphere 48 in chamber 42, or more preferably is exhausted exteriorly of chamber 42 into the ambient atmosphere, e.g., Earth's atmosphere.

Growing atmosphere operating system 56 can and preferably does also include a growing atmosphere control system (not shown) which has a controller and at least one and preferably a plurality of gas sensors in communication with the growing atmosphere 48 with at least one of the sensors being a CO₂ sensor configured to sense the percentage of CO₂ in the atmosphere 48 in real time during all stages of growth of plants 44 in chamber 42 during growing system operation. Controller can be and preferably is a processor-equipped device, such as a computer, smartphone, tablet or other processor-equipped device configured with firmware and/or software to sense from the CO₂ sensor, the percentage of CO₂ in atmosphere 48 and operate CO₂ gas supply system 194 to supply CO₂ gas to atmosphere 48 sufficient to make up for CO₂ lost during transpiration during growth of plants 44 in chamber 42 to maintain the percentage of CO₂ in the atmosphere 48 above that found in the Earth's atmosphere and preferably so it is at or above a minimum of at least 0.05% CO₂, more preferably at least 0.06% CO₂, even more preferably at least 0.08% CO₂, and yet even more preferably at least 0.10% CO₂. Controller is further configured to continue sensing the percentage of CO₂ in growing atmosphere 48 while CO₂ is being supplied from the CO₂ supply system 194 to atmosphere 48 until the percentage of CO₂ in atmosphere 48 reaches a maximum of 0.4%, preferably 0.3% and more preferably 0.2%, at which point supplying of CO₂ to atmosphere 48 preferably is ceased. In a preferred embodiment and method, at substantially the same time the pressure of growing atmosphere 48 also is maintained at or above the minimum pressure of at least 150 kPa or 21 psi, preferably at least 200 kPa or 29 psi, and more preferably at least about 300 kPa or at least about 43 psi, and at or below the maximum of 1200 kPa or 175 psi, preferably 1000 kPa or 145 psi, more preferably 800 kPa or about 115 psi, even more preferably 600 kPa or about 87 psi, and yet even more preferably 500 kPa or about 72 psi. In such a preferred embodiment and method, the CO₂ gas delivered from supply system 194 is pressurized CO₂ gas delivered at a pressure that is at least the same as the pressure of growing atmosphere 48 and which preferably is delivered at a pressure greater than the pressure of atmosphere 48.

In accordance with another aspect of the invention, controller can be and preferably is configured, such as in software and/or firmware, to regulate the percentage of CO₂ in growing atmosphere 48 to controllably increase the percentage, such as preferably from at or about a selected one of the aforementioned minimum CO₂ percentages of one of the aforementioned predetermined CO₂ ranges toward, about, or to a corresponding selected one of the aforementioned maximum percentages of the one of the aforementioned predetermined CO₂ ranges, in a manner that opens or increases the size of pores of stomata of foliage 46 of plants 44 in chamber 42 during at least one or stages of plant growth during growing system operation. Controller can be and preferably also is even further configured to selectively and controllably perform such a CO₂ controlled growing atmosphere stomata pore opening cycle when it is desired to one of (a) increase uptake of CO₂ into and through pores of stomata of foliage 46 of plants 44 in chamber 42, and/or (b) perform a feeding cycle where fertilizer is applied during foliar feeding, such as preferably stomatal feeding, and is taken up through stomata of foliage 46 of a plant 44 in chamber 42 undergoing a feeding cycle. Controller can be configured, such as by software and/or firmware and also with user input to selectively and/or controllably perform CO₂ controlled growing atmosphere stomata opening cycles during at least one or more of the seedling stage, the vegetative growth stage, and the budding or flowering stage of growth of plants 44 in chamber 42 when it is desired to open the plants' stomata. Controller can be and preferably is yet even further configured to maintain the pressure of growing atmosphere 48 within chamber 42 at or above the minimum pressure of at least 150 kPa or 21 psi, preferably at least 200 kPa or 29 psi, and more preferably at least about 300 kPa or at least about 43 psi, and at or below the maximum pressure of 1200 kPa or 175 psi, preferably 1000 kPa or 145 psi, more preferably 800 kPa or about 115 psi, even more preferably 600 kPa or about 87 psi, and yet even more preferably 500 kPa or about 72 psi during performance of such a CO₂ controlled growing atmosphere stomatal pore opening cycle during growing system operation.

Controller can be and preferably is yet even further configured to regulate the percentage of CO₂ in growing atmosphere 48 to controllably decrease the percentage, such as preferably from at or about a selected one of the aforementioned predetermined maximum CO₂ percentages of one of the aforementioned predetermined CO₂ ranges toward, about, or to one of the aforementioned predetermined minimum percentages of the one of the aforementioned predetermined CO₂ ranges in a manner that closes or decreases the size of the pores of stomata of foliage 46 of plants 44 in chamber 42 during growing system operation during at least one or stages of plant growth during growing system operation when it is desired to close the stomata of the plants 44. Controller can be and preferably also is still even further configured to perform such a stomata pore closing cycle when it is desired to one of (a) decrease uptake of CO₂ through stomata of foliage 46 of plants 44 in chamber 42, and/or (b) cease feeding or stop performing a feeding cycle of a plant 44 that had been undergoing a feeding cycle in chamber 42. Controller can be configured, such as by software and/or firmware and also with user input to selectively and/or controllably perform CO₂ controlled growing atmosphere stomata closing cycles during at least one or more of the seedling stage, the vegetative growth stage, and the budding or flowering stage of growth of plants 44 in chamber 42. Controller can be and preferably is even further configured to maintain the pressure of growing atmosphere 48 within chamber 42 at or above the minimum pressure of at least 150 kPa or 21 psi, preferably at least 200 kPa or 29 psi, and more preferably at least about 300 kPa or at least about 43 psi, and at or below the maximum pressure of no greater than 1200 kPa or 175 psi, preferably no greater than 1000 kPa or 145 psi, more preferably no greater than 800 kPa or about 115 psi, even more preferably no greater than 600 kPa or about 87 psi, and yet even more preferably no greater than 500 kPa or about 72 psi during performance of such a CO₂ controlled growing atmosphere stomatal pore closing cycle during growing system operation.

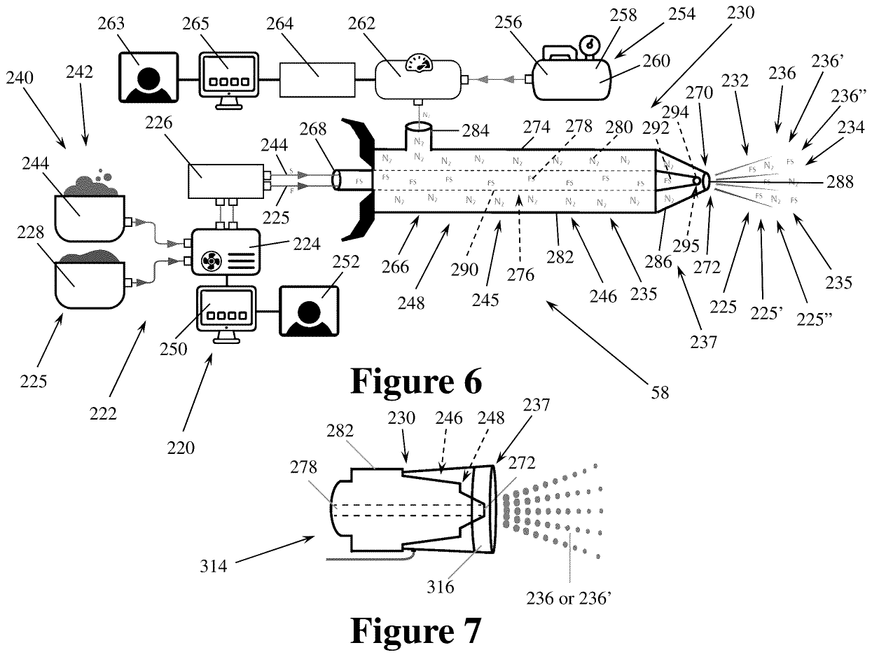

FIG. 6 illustrates in detail a fertilizer delivery and dispensing system 220 of plant feeding system 58 of the present invention that includes a fertilizer delivery system 222 that has a pump 224 that delivers liquid fertilizer 225 containing at least one nutrient from a fertilizer source 228 to a mass flow controller 226 that meters the fertilizer 225 to a fertilizer dispenser 230 of the feeder 192 of a dispensing system 235 disposed in growing chamber 42 that delivers the fertilizer 225 to foliage 46 of at least one plant 44 in chamber 42 during a plant feeding cycle. Dispenser 230 preferably is or includes an applicator nozzle 237 configured to discharge into growing atmosphere 48 droplets 236 containing one or more plant nutrients which are used to feed at least one of the plants 44 whose foliage 46 receives the droplets 236 in carrying out foliar feeding, preferably stomatal feeding, during a feeding cycle for plant 44 in carrying out a preferred plant feeding method of the invention. A preferred dispenser 230 is or includes an atomizer 246 configured to deliver fertilizer 225 in the form of a mist 232 composed of fertilizer droplets 236 discharged into growing atmosphere 48 that travel through atmosphere 48 until becoming deposited on foliage 46 of at least one plant 44 in chamber 42 being fed during a feeding cycle for plant 44. Atomizer 246 is configured such that at least some of the droplets 236 that form the mist 232 are nanosized such that the nanosized droplets 236 have a droplet diameter of between 1 nm and 150 nm, preferably between 1 nm and about 100 nm.

In a particularly preferred embodiment, atomizer 246 preferably is or includes a nebulizer 248 configured to deliver the fertilizer 225 in the form of an aerosol 234 discharged into growing atmosphere 48 composed of fertilizer droplets 236 that become deposited on and wet foliage 46 of at least one plant 44 being grown in chamber 42 for foliar feeding, preferably stomatal feeding, thereof in carrying out a preferred plant feeding method of the invention. As discussed in more detail below, at least some of the droplets 236 in the discharged mist 232, preferably aerosol 234, are nanosized having a diameter of between 1 nm and 150 nm, preferably between 1 nm and about 100 nm. In a preferred nebulizer embodiment and nebulization method, at least 35%, preferably at least 50%, more preferably at least 65% and even more preferably at least 85% of the droplets 236 are nanosized having a droplet diameter of preferably between 1 nm and about 100 nm.

Fertilizer source 228 utilizes a container, such as a tank, vessel, vat, hopper or other type of container, that holds flowable and preferably liquid fertilizer 225 and which is in liquid flow communication with pump 224 that delivers fertilizer 225 from source 228 to mass flow controller 226 downstream of pump 224 and upstream of nebulizer 248. Mass flow controller 226 is used to more precisely meter fertilizer flow to nebulizer 248 to ensure that a relatively precise amount or mass flow rate of fertilizer 225 is discharged from nebulizer 248 onto foliage 46 of plant 44 during a feeding cycle. Fertilizer delivery and dispensing system 220 can and preferably does include a controller 250 configured, such as in software and/or firmware, and/or via user input 252 to control a flow rate, amount and time that fertilizer 225 is delivered by nebulizer 248 to plant 44 during a feeding cycle to ensure plant 44 is foliarly fed, preferably stomatal fed, an amount of fertilizer 225 that is a proper amount based on the type, variety, strain, and growth stage of plant 44. In a preferred embodiment and configuration of system 220 and feeding method, amount of fertilizer 225 dispensed during a feeding cycle is not only based on the type, variety, strain, and growth stage of plant 44 but is also based on the amount, e.g., mass, of vegetation of plant 44.

In a preferred embodiment where dispenser 230 is an atomizer 246 that is a nebulizer 248, atomizer 246, preferably nebulizer 248, can be a gas-assist atomizer, such as preferably a gas-assist nebulizer, which uses a propellant system 254 that employs a gas propellant 258 from a propellant source 256 that is a pressurized gas 260, preferably pressurized nitrogen gas 260, to expel the fertilizer 225 into the growing atmosphere 48 in the form of droplets 236 that collectively form mist 232 or aerosol 234 used to fertilize plant 44 during a feeding cycle thereof. The source 256 preferably is a pressure vessel or tank containing pressurized nitrogen gas 260 that is pressurized to a pressure of at least 1200 kPa (at least about 175 psi), preferably at least about 1380 kPa (at least about 200 psi), and more preferably at least about 1725 kPa (at least about 250 psi) to provide nitrogen gas 260 to the nebulizer 248 at the same pressure during nebulizer operation during a plant feeding cycle. Where the discharged droplets 236 are charged, the nitrogen gas 260 simultaneously discharged with the droplets 236 also becomes ionized as a result.

Discharge of this high pressure nitrogen gas from nebulizer 248 into growing atmosphere 48 helps maintain the pressure of the atmosphere 48 at or above the aforementioned desired minimum pressure of at least 150 kPa or 21 psi, preferably at least 200 kPa or 29 psi, and more preferably at least about 300 kPa or at least about 43 psi, and at or below the aforementioned desired maximum pressure of no greater than 1200 kPa or 175 psi, preferably no greater than 1000 kPa or 145 psi, more preferably no greater than 800 kPa or about 115 psi, even more preferably no greater than 600 kPa or about 87 psi, and yet even more preferably no greater than 500 kPa or about 72 psi during growing of plants 44 in chamber 42. In a preferred embodiment and method, can be and preferably is controllably regulated to maintain or help maintain the pressure of atmosphere 48 at or above the aforementioned desired minimum pressure of at least 150 kPa or 21 psi, preferably at least 200 kPa or 29 psi, and more preferably at least about 300 kPa or at least about 43 psi, and at or below the aforementioned desired maximum pressure of no greater than 1200 kPa or 175 psi, preferably no greater than 1000 kPa or 145 psi, more preferably no greater than 800 kPa or about 115 psi, even more preferably no greater than 600 kPa or about 87 psi, and yet even more preferably no greater than 500 kPa or about 72 psi during growing chamber operation.

Nebulizer propellant source 256, preferably high pressure nitrogen gas 260, can be and preferably is in gas flow communication with a high-pressure storage reservoir 262 and which ultimately communicates pressurized nitrogen gas 260 to a regulator 264, such as a pressure regulator, flow controller, proportional valve or the like, configured to regulate the pressure of nitrogen gas 260 and/or control a rate of flow of nitrogen gas 260 to nebulizer 248 in a manner which can and preferably does help control a rate of application of fertilizer 225 onto foliage 46 of a plant 44 being fed during a feeding cycle. In a preferred embodiment and method, there is a controller 265 in operative cooperation with nebulizer 248, preferably its pressurized gas propellant system 254, and which is configured in software and/or firmware as well as via user input 263 to control the pressure and/or flow rate, e.g., mass flow rate, of pressurized nitrogen gas 260 to nebulizer 248 by controlling operation of regulator 264 and/or nitrogen gas discharge from reservoir 262 in a manner that controls one or more of (a) a rate of fertilizer 225 discharged from nebulizer 248, (b) a rate of fertilizer application into growing atmosphere 48 and/or plant foliage 46, (c) a size of droplets 236 discharged from nebulizer 248, and/or (d) a makeup and/or percentage of droplets 236 that are nanosized discharged from nebulizer 248.

With continued reference to FIG. 6, nebulizer 248 has an outer housing 266, a fertilizer intake 268, such as disposed at one end, which receives the metered liquid fertilizer from mass flow controller 226 and a discharge 270, such as preferably a nozzle 272, such as disposed at an opposite end thereof, configured to discharge atomized liquid fertilizer in the form of a mist 232 or aerosol 234 of fertilizer droplets 236 through an orifice 288 of nozzle 272 into growing atmosphere 48 adjacent foliage 46 of plant 44. Housing 266 can be or include an elongate tubular outer cylinder 274, such as preferably made of stainless steel, which encloses an elongate center tube 276, such as preferably also made of stainless steel, which defines a fertilizer transport conduit 278 through which liquid fertilizer 225 flows during nebulizer operation out a nozzle 272 having a 2 millimeter diameter for producing fertilizer droplets 236 which are preferably nanosized and which preferably also contain negatively charged nanosized oxygen bubbles in solution in each droplet 236.

Center tube 276 is narrower and/or has a smaller diameter than outer cylinder 274 thereby defining an annular pressurized gas transport conduit 280 therebetween through which pressurized nitrogen gas 260 flows during nebulizer operation. Outer cylinder 274 forms an outer wall of the pressurized gas transport conduit 280 and the center tube 276 forms an inner wall of the conduit 280. Outer cylinder 274 has an elongate tubular body 282 with a pressurized gas intake port 284 disposed adjacent one end and has another end that is a discharge end that has a converging section 286 that converges, such as by being conically tapered or diametrically necked down, into a discharge orifice 288 of nebulizer discharge nozzle 272.

Center tube 276 of fertilizer fluid transport conduit 278 has a tubular body 290 with one end that forms or communicates with fertilizer intake 268 and an opposite end that is or includes a converging section 292 that converges, such as by being conically tapered or diametrically necked down, into a discharge orifice 294 of a fertilizer fluid discharging nozzle 295. Converging section 292 preferably tapers or necks down such that the resulting orifice 294 has a diameter smaller than the diameter of tube body 290 and which preferably has an orifice diameter that is less than half the diameter of body 290.

Orifice 294 of fertilizer fluid discharge nozzle 295 can be and preferably is located within gas transport conduit converging section 292 (also known as the nebulizer's discharge nozzle converging section) upstream of and axially spaced from orifice 288 of nebulizer discharge nozzle 272 at the end of converging section 292. In the embodiment depicted in FIG. 6, at least part of fertilizer transport conduit converging section 292 and the entire fertilizer fluid discharge nozzle orifice 294 are disposed in converging section 286 of pressurized gas transport conduit 280 of nebulizer nozzle 272 so that liquid fertilizer 225 is discharged from orifice 294 into part of converging section 286 of nebulizer nozzle 272 upstream of nebulizer discharge orifice 288. Pressurized nitrogen gas 260 flowing through gas transport conduit 280 propels liquid fertilizer 225 discharged from fertilizer discharge nozzle orifice 294 into nebulizer discharge nozzle converging section 286 which undergoes expansion as it exits orifice 288 of nebulizer nozzle 272 thereby aerosolizing the liquid fertilizer 225 discharging an aerosol 234 formed of droplets 236 which preferably are or include droplets 236 which are nanosized.

Converging sections 286, 292, orifices 288, 294, and nozzles 272, 295, of nebulizer 248 can be and preferably are constructed and arranged in accordance with the present invention to configure nebulizer 248 to control formation and/or size of droplets 236 including to produce at least some droplets 236 which are nanosized and create a more finely dispersed aerosol 234 discharged from nozzle 272 into growing atmosphere 48 in growing chamber 42. The presence of such smaller sized droplets 236 in aerosol 234, at least some which are nanosized, advantageously more uniformly wet external surfaces of foliage 46 of plant 44 with liquid fertilizer 225. This can and preferably does lead to more efficient foliar feeding by resulting in more uniform simultaneous fertilizer uptake by stomata of foliage 46 of a plant 44 being fed more quickly feeding plant 44 using less fertilizer than conventional plant feeding systems and methods. In a preferred system, nebulizer 248, foliar feeding system 65, preferably stomatal feeding system 71, and plant feeding method that preferably is a foliar feeding method, more preferably a stomatal feeding method of the present invention, the mist 232, preferably aerosol 234, contains at least 30% droplets 236 which are nanosized, preferably contains at least 50% nanosized droplets 236, more preferably contains at least 75% nanosized droplets, even more preferably contains at least 90% nanosized droplets, and can be composed of droplets 236 substantially all of which, at least 95%, are nanosized.

Fertilizer source 228 preferably holds a liquid fertilizer 225 containing one or more of nitrogen (N), such as a liquid solubilized nitrogen, phosphorus (P), such as a liquid solubilized phosphorous, potassium (K), calcium (Ca), such as a liquid solubilized calcium, magnesium (Mg), such as a liquid solubilized magnesium, and/or sulfur(S), such as a liquid solubilized sulfur, and which can also include one or more micronutrients, such as one or more of manganese (Mn), such as a liquid solubilized manganese, copper (Cu), such as a liquid solubilized copper, zinc (Zn), such as a liquid solubilized zinc, boron (B), such as a liquid solubilized boron, molybdenum (Mo), such as a liquid solubilized molybdenum, and/or chlorine (CI), such as a liquid solubilized chlorine. In a preferred formulation of a fertilizer 225 used as source 228 that is delivered to at least one plant 44 during a feeding cycle, the fertilizer formulation includes one or more of the nutrients of N, P, K, Ca, Mg, and/or S, preferably includes at least a plurality of these nutrients, and can be formulated to include each one of these nutrients in respective varying amounts specifically selected for or based on the type and strain of the plant or plants being grown in the chamber 42 of the growing system 40 of the present invention. Such a fertilizer formulation used as source 228 can and preferably does include one or more of the micronutrients of Mn, Cu, Zn, B, Mo, and/or Cl, preferably includes at least a plurality of these micronutrients, and can be formulated to include each one of these micronutrients in respective varying amounts specifically selected for or based on the type and strain of the plant or plants being grown in the chamber 42 of the growing system 40 of the present invention. In a preferred fertilizer formulation, the source 228 includes one or more of the nutrients of N, P, K, Ca, Mg, and/or S along with one or more of the micronutrients of Mn, Cu, Zn, B, Mo, and/or Cl, preferably includes at least a plurality of each, and can include each one of the aforementioned nutrients and micronutrients in respective varying amounts specifically selected for, determined, or based on the type and strain of the plant or plants being grown in the chamber 42 of the growing system 40 of the present invention.

One preferred fertilizer source 228 is a fertilizer 225 that is a blend of at least a plurality, preferably a plurality of pairs, i.e., at least three, of N, K, P, Ca, Mg, S, Cl, B, Fe, Mn, Cu, Zn, Ni, and Mo in respective concentrations of (a) N sufficient to achieve critical leaf concentrations of between 10-50 mg of N per gram of dry leaf matter of the foliage 46 of plant 44 being grown in chamber 42, preferably between 15-40 mg of N per gram of dry leaf matter, and more preferably between about 20 and about 30 mg of N per gram of dry leaf matter, (b) K sufficient to achieve critical leaf concentrations of between 5-50 mg of K per gram of dry leaf matter, preferably between 10-40 mg of K per gram of dry leaf matter, and more preferably between about 20 and about 30 mg of K per gram of dry leaf matter, (c) P sufficient to achieve critical leaf concentrations of between 2-10 mg of P per gram of dry leaf matter, preferably between 2-5 mg of P per gram of dry leaf matter, and more preferably between about 3 and about 4 mg of P per gram of dry leaf matter, (d) Ca sufficient to achieve critical leaf concentrations of between 0.5-20 mg of Ca per gram of dry leaf matter, preferably between 0.5-10 mg of Ca per gram of dry leaf matter, and more preferably between about 2 and about 8 mg of Ca per gram of dry leaf matter, (e) Mg sufficient to achieve critical leaf concentrations of between 1-10 mg of Mg per gram of dry leaf matter, preferably between 1.5-5 mg of Mg per gram of dry leaf matter, and more preferably between about 1.5 and about 3.5 mg of K per gram of dry leaf matter, (f) S sufficient to achieve critical leaf concentrations of between 1-5 mg of S per gram of dry leaf matter, (g) Cl sufficient to achieve critical leaf concentrations of between 0.1-6 mg of Cl per gram of dry leaf matter, preferably between 0.5-5 mg of Cl per gram of dry leaf matter, and more preferably between about 1 and about 4 mg of Cl per gram of dry leaf matter, (h) B sufficient to achieve critical leaf concentrations of between 5×10⁻³ and 100×10⁻³ mg of B per gram of dry leaf matter, preferably between 20×10⁻³ and 80×10⁻³ mg of B per gram of dry leaf matter, and more preferably between about 40×10⁻³ and about 60×10⁻³ mg of B per gram of dry leaf matter, (i) Fe sufficient to achieve critical leaf concentrations of between 50×10⁻³ and 150×10⁻³ mg of Fe per gram of dry leaf matter, preferably between 75×10⁻³ and 125×10⁻³ mg of Fe per gram of dry leaf matter, and more preferably between about 50×10⁻³ and about 100×10⁻³ mg of Fe per gram of dry leaf matter, (j) Mn sufficient to achieve critical leaf concentrations of between 10×10⁻³ and 20×10⁻³ mg of Mn per gram of dry leaf matter and preferably between about 12×10⁻³ and about 18×10⁻³ mg of Mn per gram of dry leaf matter, (k) Cu sufficient to achieve critical leaf concentrations of between 1×10⁻³ and 5×10⁻³ mg of Cu per gram of dry leaf matter and preferably between about 2×10⁻³ and about 4×10⁻³ mg of Cu per gram of dry leaf matter, (1) Zn sufficient to achieve critical leaf concentrations of between 15×10⁻³ and 30×10⁻³ mg of Zn per gram of dry leaf matter, preferably between 18×10⁻³ and 28×10⁻³ mg of Zn per gram of dry leaf matter, and more preferably between about 20×10⁻³ and about 25×10⁻³ mg of Zn per gram of dry leaf matter, (m) Ni sufficient to achieve critical leaf concentrations of no greater than about 0.1×10⁻³ of Ni per gram of dry leaf matter, and/or (n) Mo sufficient to achieve critical leaf concentrations of between 0.1×10⁻³ and 1.0×10⁻³ mg of Mo per gram of dry leaf matter, preferably between 0.2×10⁻³ and 0.8×10⁻³ mg of Mo per gram of dry leaf matter, and more preferably between about 0.3×10⁻³ and about 0.7×10⁻³ mg of Mo per gram of dry leaf matter. Such a fertilizer 225 can also contain Na sufficient to achieve critical leaf concentrations of between 0.1-1.5 mg of Na per gram of dry leaf matter, Se sufficient to achieve critical leaf concentrations of between about 0.1×10⁻³ and about 8.0×10⁻³ mg of Se per gram of dry leaf matter, Co sufficient to achieve critical leaf concentrations of between about 0.1×10⁻³ and about 8.0×10⁻³ mg of Co per gram of dry leaf matter, and/or Al sufficient to achieve critical leaf concentrations of between about 5.0×10⁻³ and about 35.0×10⁻³ mg of Al per gram of dry leaf matter. Trace amounts of Si can also be added.

Another preferred fertilizer 225 contains a blend of (a) N sufficient to achieve critical leaf concentrations of between 10-50 mg of N per gram of dry leaf matter of the foliage 46 of plant 44 being grown in chamber 42 and preferably between 15-40 mg of N per gram of dry leaf matter, (b) K sufficient to achieve critical leaf concentrations of between 5-50 mg of K per gram of dry leaf matter and preferably between 10-40 mg of K per gram of dry leaf matter, (c) P sufficient to achieve critical leaf concentrations of between 2-10 mg of P per gram of dry leaf matter and preferably between 2-5 mg of P per gram of dry leaf matter, (d) Ca sufficient to achieve critical leaf concentrations of between 0.5-20 mg of Ca per gram of dry leaf matter and preferably between 0.5-10 mg of Ca per gram of dry leaf matter, (e) Mg sufficient to achieve critical leaf concentrations of between 1-10 mg of Mg per gram of dry leaf matter and preferably between 1.5-5 mg of Mg per gram of dry leaf matter, (f) S sufficient to achieve critical leaf concentrations of between about 1 and about 5 mg of S per gram of dry leaf matter, (g) Cl sufficient to achieve critical leaf concentrations of between 0.1-6 mg of Cl per gram of dry leaf matter and preferably between 0.5-5 mg of Cl per gram of dry leaf matter, (h) B sufficient to achieve critical leaf concentrations of between 5×10⁻³ and 100×10⁻³ mg of B per gram of dry leaf matter and preferably between 20×10⁻³ and 80×10⁻³ mg of B per gram of dry leaf matter, (i) Fe sufficient to achieve critical leaf concentrations of between 50×10⁻³ and 150×10⁻³ mg of Fe per gram of dry leaf matter and preferably between 75×10⁻³ and 125×10⁻³ mg of Fe per gram of dry leaf matter, (j) Mn sufficient to achieve critical leaf concentrations of between 10×10⁻³ and 20×10⁻³ mg of Mn per gram of dry leaf matter and preferably between about 12×10⁻³ and about 18×10⁻³ mg of Mn per gram of dry leaf matter, (k) Cu sufficient to achieve critical leaf concentrations of between 1×10⁻³ and 5×10⁻³ mg of Cu per gram of dry leaf matter and preferably between about 2×10⁻³ and about 4×10⁻³ mg of Cu per gram of dry leaf matter, (1) Zn sufficient to achieve critical leaf concentrations of between 15×10⁻³ and 30×10⁻³ mg of Zn per gram of dry leaf matter and preferably between 18×10⁻³ and 28×10⁻³ mg of Zn per gram of dry leaf matter, (m) Ni sufficient to achieve critical leaf concentrations of no greater than about 0.1×10⁻³ of Ni per gram of dry leaf matter, and (n) Mo sufficient to achieve critical leaf concentrations of between 0.1×10⁻³ and 1.0×10⁻³ mg of Mo per gram of dry leaf matter and preferably between 0.2×10⁻³ and 0.8×10⁻³ mg of Mo per gram of dry leaf matter. Such a fertilizer 225 can also contain at least a plurality of Na sufficient to achieve critical leaf concentrations of between 0.1-1.5 mg of Na per gram of dry leaf matter, Se sufficient to achieve critical leaf concentrations of between about 0.1×10⁻³ and about 8.0×10⁻³ mg of Se per gram of dry leaf matter, Co sufficient to achieve critical leaf concentrations of between about 0.1×10⁻³ and about 8.0×10⁻³ mg of Co per gram of dry leaf matter, and/or Al sufficient to achieve critical leaf concentrations of between about 5.0×10⁻³ and about 35.0×10⁻³ mg of Al per gram of dry leaf matter. Trace amounts of Si can also be added.

With continued reference to FIG. 6, fertilizer delivery system 222 can be and preferably is configured to deliver a fertilizer enhancer 240 together with the fertilizer 225 during a feeding cycle that is a fertilizer-enhancing composition 240 configured to enhance the fertilizer 225 in some manner during application thereof onto at least one plant 44 in growing chamber 42 during a plant feeding cycle compared to application of the fertilizer 225 alone without the presence of any enhancer 240. In a preferred embodiment and method, fertilizer-enhancing composition 240 is combined, preferably by mixing, with a fertilizer 225 containing at least a plurality of nutrients, preferably at least a plurality of pairs of, i.e. at least three, nutrients to form an enhanced fertilizer 225′ that is discharged from nebulizer 248 into growing atmosphere 48 in the form of enhanced fertilizer droplets 236 during a plant feeding cycle. In one such preferred embodiment and method, an enhanced fertilizer 225′ composed of fertilizer 225 and at least one fertilizer enhancer 240 is delivered during a single feeding cycle in the form of aerosolized enhanced fertilizer droplets 236 that contain an amount, e.g., mass or volume, of nutrients sufficient to feed, preferably foliar feed, more preferably stomatal feed, a single plant 44 for a predetermined feeding duration of at least one day, preferably at least a plurality of days, and more preferably at least one week before needing another feeding cycle. As discussed in more detail below, fertilizer-enhancing composition 240 is configured to enhance fertilizer 225 in some manner, such as by increasing fertilizer uptake, rate of fertilizer uptake, fertilizing efficiency, and/or in another manner, compared to the same fertilizer 225 being used without any enhancer 240 whatsoever.

In a particularly preferred enhanced fertilizer embodiment and method, enhanced fertilizer 225′ is a surfactant-enhanced liquid fertilizer 225″ that is composed of fertilizer 225 and a fertilizer enhancer 240 that is a surfactant 242, e.g., at least one surfactant, combined preferably by mixing them together to produce the surfactant-enhanced fertilizer 225″. The presence of surfactant 242 in surfactant-enhanced fertilizer 225″ advantageously increases uptake of nutrients in the fertilizer 225″ during foliar feeding by stomata of the foliage 46 of the plant 44 being fed. The presence of surfactant 242 does so by reducing the surface tension of the liquid fertilizer 225″ which helps the nutrients in the fertilizer 225″ to more easily be drawn into, preferably via wicking or capillary action, stomata 374 of the foliage 46 of the plant 44.

Where configured to deliver such a fertilizer-enhancing composition 240 that is a surfactant 242, delivery system 222 includes a source 244 of the fertilizer-enhancing composition 240 that is surfactant 242, which is pumped by pump 224b during fertilizer delivery system operation to mass flow controller 226 which meters flow of the enhancer 240, in this case surfactant 242, to the nebulizer 248. Nebulizer 248 is configured to combine, such as by mixing, the enhancer 240, in this case surfactant 242, from source 244 with fertilizer 225 from source 228 in fertilizer transport conduit 278 of center tube 276 during nebulizer operation produce an enhanced fertilizer 225′ that preferably is a surfactant-enhanced fertilizer 225″ discharged from nebulizer 248 during feeding of plant 44 in the form of droplets 236 in a mist 232 that preferably is an aerosol 234.

The addition of an enhancer 240 that is a surfactant 242 advantageously increases the uptake and/or rate of stomatal uptake by plant 44 of at least one nutrient and preferably all of the nutrients in the surfactant-enhanced fertilizer 225″ by decreasing surface tension of the droplets 236 of fertilizer 225″, including droplets 236 which are nanosized. The result is that the reduced surface tension surfactant-containing enhanced fertilizer droplets 236, particularly those which are nanosized, more rapidly and more uniformly wet the foliage 46 of plant 44 when the droplets 236 come into contact therewith advantageously spreading liquid fertilizer 225″ more uniformly along substantially the entire external surface area of the foliage 46. By increasing the surface area of foliage 46 wetted or coated with fertilizer 225″, it helps maximize feeding of plant 44 during a feeding cycle by fertilizer 225″ reaching more of the stomata of the foliage 46. Doing so helps increase the rate of feeding by having a greater number of stomata of the plant 44 taking up simultaneously fertilizer 225″ making fertilizing of plant 44 during a feeding cycle more efficient by getting it done more quickly. By more uniformly wetting or coating foliage 46 of the plant 44 with fertilizer 225″, the rate of uptake of the fertilizer 225″ by the stomata is greater and more uniform across all wetted stomata of the plant 44. This advantageously results in more efficient feeding by wasting less fertilizer 225″ because more of the fertilizer 225″ from a predetermined charge or amount, e.g. mass or volume, of fertilizer 225″ discharged by nebulizer 248 during a single feeding cycle is taken up by the plant 44 through its stomata compared to the same fertilizer 225′ which contains no surfactant 242. The presence of surfactant 242 in the droplets 236 also causes the fertilizer 225″ to more easily enter stomata of the plant 44, even when its stomata are nearly closed, as a result of the reduced surface tension enabling at least some of the fertilizer 225″ wetting the foliage 44 to wick and thereby be drawn into stomata advantageously enabling foliar feeding of the plant 44 in situations where virtually no such foliar feeding would occur where the fertilizer 225 lacked any surfactant 242. In addition, the delivery of fertilizer 225″ to foliage 46 of plant 44 in the form of such relatively small droplets 236 in mist 232, preferably aerosol 234, discharged by nebulizer 248, particularly where droplets 236 are nanosized, is beneficial because at least some of the droplets 236, especially those that are nanosized, can in at least some instances directly enter and pass through stomata of plant 44. The result is that less nutrients in the fertilizer 225″ is wasted, including due to evaporation, during each feeding cycle as a result of being formulated with surfactant 242 compared to a fertilizer 225 lacking any surfactant 242.

Where a fertilizer-enhancing composition 240 that includes at least one surfactant 242 is used, each surfactant 242 preferably is a food grade or food safe surfactant, such as one or more of polysorbate 20, polysorbate 80, lecithin, sodium dodecyl sulfate, a monoglyceride, a diglyceride, a sorbitan monostearate, a sucrose ester, glycerol monostearate (GMS), a propylene glycol ester of fatty acids (PGFA), sodium stearoyl lactylate (SSL), or another type of food grade or food safe surfactant. Polysorbates, such as polysorbate 20 or polysorbate 80 are preferred as they are non-ionic surfactants that are effective in reducing surface tension and for stabilizing emulsions. Polysorbate 20 can be and preferably is added to the liquid fertilizer 225 to reduce its surface tension to make it more readily taken up by plant stomata 374 where the viscosity of the liquid fertilizer 225 is no greater than about 40 centipoise. Polysorbate 80 can be and preferably is added to the liquid fertilizer 225 to reduce its surface tension to make it more readily taken up by plant stomata 374 where the viscosity of the liquid fertilizer 225 is higher and preferably is at least about 50 centipoise. In one preferred fertilizer-enhancing composition 240 that includes a surfactant 242, lecithin can be and preferably is a surfactant 242 added to fertilizer 225 in order to stabilize nebulization of the nanosized droplets 236 of the resultant surfactant-enhanced fertilizer 225″ discharged from nebulizer 248 while reducing the surface tension of the droplets 236 so they more rapidly wet the external surfaces of the foliage 46 and are more readily taken up by the plants stomata 374 during foliar feeding.

Where more than one surfactant is used, it can be mixture or blend of a plurality of different surfactants 242 added to, mixed with or otherwise combined with fertilizer 225 to produce a surface tension reduced surfactant-enhanced fertilizer 225″ configured to be more readily attracted to and more uniformly wet exterior surfaces of the foliage 46 of a plant 44 being fertilized during a feeding cycle. Where surfactant-enhanced fertilizer 225″ is composed of a plurality of surfactants 242, the surfactants 242 and amounts or rates of the surfactants added to fertilizer 225 during delivery are selected to configure droplets 236 of fertilizer 225″ to be attracted to the foliage 46, to more uniformly wet and coat the foliage 46, and to be more rapidly taken up by stomata of the plant 44 including by being wicked into stomata thereby advantageously producing a more uniform or constant rate of uptake of fertilizer 225′ into stomata of the plant 44 with less fertilizer waste beneficially more efficiently and more quickly feeding the plant 44 than where fertilizer 225 without any surfactant 242 is used.

The fertilizer discharged from the nebulizer 248, can be an enhanced fertilizer 225′ that is enhanced with one or more fertilizer-enhancing compositions 240 that are not surfactants 242, and which also can be added to an enhanced fertilizer containing one or more surfactants 242 to produce an enhanced fertilizer 225′ that is a surfactant-enhanced fertilizer 225″ containing one or more fertilizer-enhancing compositions 240 in addition to surfactant(s) 242 in the fertilizer 225″. Where an enhanced fertilizer 225′ or 225″ includes one or more non-surfactant enhancers, e.g. fertilizer-enhancing compositions which are not surfactants, the non-surfactant enhancers can be one or more bioactive compounds which can include (a) one or more plant hormones, such as gibberellins, e.g., GA3, such as to promote seed germination, cytokinins to encourage cell division and elongation during seedling emergence during germination as well as stimulate shoot development and leaf expansion during the vegetative growth stage of plant 44, and auxins, e.g., indole 3 acetic acid, to stimulate root growth and elongation during the vegetative growth stage of plant 44; (b) one or more biostimulants, such as seaweed extracts, which can provide one or more natural plant growth hormones, such as auxins and/or cytokinins, such as to enhance germination and root development; (c) one or more inoculants, such as preferably one or more microbial inoculants, such as rhizobia and/or mycorrhizae, such as preferably to improve nutrient uptake and the like by plant 44; (d) one or more elicitors, such as chitosan and/or salicylic acid; (e) one or more nutrient enhancers, such as one or more amino acids, e.g., proline and/or glutamate; (f) one or more hormonal regulators, such as one or more brassinosteroids and/or one or more ethylene precursors, e.g., 1-aminocyclopropane-1-carboxylic acid, and/or ACC; (g) one or more pollination aids, including solutions composed of sucrose and/or boric acid; (h) one or more antioxidants, including ascorbic acid and/or glutathione; (i) one or more maturation enhancers, including one or more ethylene releasing compounds, such as one or more of ethephon (2-chloroethylphosphonic acid), calcium carbide (CaC₂), calcium nitrate, Ethrel, 2-chloroethyl trimethylammonium chloride (CCC), and/or a methionine-derived compound or treatment; (j) one or more quality enhancers, such as calcium chloride, a silicon supplement (e.g., potassium silicate), humic and/or fulvic acids, neem oil, neem cake, potassium nitrate, glycine betaine, a sucrose ester, magnesium sulfate (Epsom Salt), an antitranspirant, abscisic acid (ABA), and/or silver thiosulfate (STS); (k) one or more color development compounds, such as ABA; (1) one or more natural defense solicitors, such as jasmonic acid and derivatives thereof, salicylic acid (SA), Acibenzolar-S-Methyl (ASM), Beta-Aminobutyric Acid (BABA), Oligogalacturonides (OGs), Laminarin, Defensins, Potassium Phosphite, a copper compound, such as one or more copper oxychloride and/or copper sulfate, one or more Beta-Glucans, Pseudomonas fluorescens and/or RNA Interference (RNAi); and/or (m) one or more microbial biocontrol agents, including one or more of Bacillus subtilis, Trichoderma spp., Mycorrhizal Fungi, and/or Pseudomonas fluorescens.

Where an enhanced fertilizer 225′ is formulated to include one or more fertilizer enhancers 240 that are non-surfactant fertilizer-enhancing compositions, like one or more of the aforementioned bioactive compounds listed above, the fertilizer delivery system 222 preferably includes a source (not shown) separate from either or both fertilizer source 228 and/or surfactant source 244, which can and preferably is delivered by pump 224 to mass flow controller 226 as depicted in FIG. 6 which in turn meters it to the intake 268 of the center tube 276 of the nebulizer 248 simultaneously with the fertilizer 225 and/or surfactant 242 causing all of them to be uniformly and preferably substantially homogeneously mixed together in the fertilizer transport conduit 278 of the tube 276 and/or during discharge out nozzle 272. If desired, separate pumps 224a, 224b can be used to separately deliver fertilizer from fertilizer source 228 and surfactant from surfactant source 244 as depicted in FIG. 4. The mass flow controller 226 can also be configured to precisely meter the mass flow rate of the pressurized nitrogen gas 260 to the nebulizer 248 such as in the manner depicted in FIG. 1. Where the mass flow controller 226 simultaneously meters flow of nitrogen gas 260, fertilizer 225 and surfactant 244 by precisely separately and independently measuring and controlling the flow rate of the nitrogen gas 260, fertilizer 225 and the surfactant 244 based on corresponding flow rate set points for each to ensure that a consistent desired mass flow of the nitrogen gas 260, the fertilizer 225 and the surfactant 244 are simultaneously delivered to the nebulizer 248 regardless of changes in pressure, density or temperature of the nitrogen gas 260, fertilizer 225 and surfactant 244.

The present invention also contemplates a fertilizer delivery and dispensing system 220 having a fertilizer delivery system 222 and/or dispensing system 235 configured with fertilizer source 228, a surfactant source 244 and yet another source (not shown) composed of a fertilizer enhancer 240 that includes one or more of the aforementioned bioactive compositions listed above and which is not a surfactant enabling the nebulizer 248 to discharge a bioactive compound enhanced fertilizer 225′ that can be a bioactive compound surfactant enhanced fertilizer 225″. In such a fertilizer delivery and dispensing system 220, mass flow controller 226 can be configured to control the mass flow rate of the nitrogen gas 260, fertilizer 225, surfactant 244, and fertilizer enhancer 240 to precisely deliver a consistent desired mass flow of each to the nebulizer 248.

In use and operation, at least some of the droplets 236 in the mist 232 or aerosol 234 discharged into the growing atmosphere 48 towards foliage 46 of plant 44 are nanosized droplets having a size or diameter of between 1 nm and 150 nm thereby advantageously configuring the smaller nanosized droplets to be more easily taken up by stomata of the plant 44 by being more readily able to pass through the relatively small sized pores of the stomata, which typically range in length from between 10 micrometers (μm) to 80 μm and in width from between 3 μm to 10 μm. As discussed in more detail below, either or both the droplets 236, including droplets 236 which are nanosized, and/or the plant 44 can be charged, such as with a positive and/or negative charge that preferably is an electrostatic charge, to cause droplets 236, including those that are nanosized, in the mist 232 or aerosol 234 to be attracted to foliage 46 of the plant 44 being fed to more quickly deliver the droplets 236, including nanosized droplets, into contact with the foliage 46 during a plant feeding cycle. Charged attraction between the droplets 236 and the foliage 46 advantageously helps cause droplets 236 contacting foliage 46 to more rapidly wet the foliage and more uniformly spread out over a greater surface area of the foliage 46 even when fertilizer 225 lacks any surfactant 242 as compared to droplets applied to foliage 46 that lack any charges and lack surfactant. Charged attraction between the droplets in the foliage further advantageously helps droplets contacting stomata of the foliage 46 to more readily and more quickly enter the stomata helping facilitate foliar feeding. As also discussed in more detail below, in addition to being charged, droplets 236 can also be ionized, such as to facilitate absorption by the plant 44 of one or more nutrients in the fertilizer droplets 236.

In one preferred embodiment, the dispenser 230 preferably is or includes an atomizer 246 configured to discharge a mist 232 of liquid fertilizer droplets 236 containing fertilizer 225. Droplets 236 can be charged droplets 236′ and/or ionized droplets 236″ as it is contemplated within the scope of the present invention the mist 232 having liquid fertilizer droplets that are both charged and ionized. Such an atomizer 246 can be a charged atomizer, such as an electrostatic atomizer, such as a pressurized gas-assisted electrostatic atomizer, an electrospray atomizer, a corona discharge atomizer, an induction atomizer or an ultrasonic atomizer which uses one of direct charging, inductive charging and/or ion transfer, e.g., ionized pressurized gas transfer, to charge droplets 236′ discharged from the atomizer with an electrical charge that is a positive electrical charge or preferably a negative electrical charge that helps attract the discharged charged droplets 236′ to foliage 46 of a plant 44 being fed thereby speeding feeding. The charge imparted to the droplets 236′ also advantageously helps droplets 236′ that have wetted the foliage 46 to enter or be drawn into stomata of the foliage 46 of the plant 44 being fertilized. The relatively small size of the droplets 236′ combined with them being electrically charged helps them even more readily, efficiently and quickly enter pores of stomata of the plant 44 undergoing a feeding cycle. The relatively small size of the droplets 236′ combined with them being electrically charged together with the droplets being delivered in a growing atmosphere 48 having a pressure greater than atmospheric pressure, preferably greater than 150 kPa, more preferably greater than 300 kPa, helps the droplets 236′ yet even more readily, even more efficiently and even more quickly entire pores of stomata of the plant 44 undergoing the feeding cycle. If desired, the nebulizer can be an ionizing nebulizer, such as an electrospray nebulizer, plasma-based nebulizer, a laser ablation nebulizer or a corona discharge nebulizer, which ionizes droplets 236″ and can and preferably also does charge at least some of the ionized droplets 236″ producing ionized charged droplets that also are more readily, more efficiently and more quickly taken up into pores of stomata of the plant 44 being fed during a feeding cycle.

In a particularly preferred embodiment, dispenser 230 is or includes a nebulizer 248 that discharges an aerosol 234 of liquid fertilizer droplets 236 containing fertilizer 225 that preferably are nanosized. Droplets 236 can be charged droplets 236′ and/or ionized droplets 236″ as it is contemplated within the scope of the present invention that the aerosol 234 can be formed of liquid fertilizer droplets that are both charged and ionized. Such an nebulizer 248 can be a charged nebulizer, such as an electrostatic nebulizer, such as a pressurized gas-assisted electrostatic nebulizer, an electrospray nebulizer, a corona discharge nebulizer, an induction nebulizer or an ultrasonic nebulizer which uses one of direct charging, inductive charging and/or ion transfer, e.g., ionized pressurized gas transfer, to charge droplets 236′ discharged from the nebulizer with an electrical charge that is a positive electrical charge or preferably a negative electrical charge that also helps attract the discharged charged droplets 236′ to foliage 46 of a plant 44 being fed thereby speeding feeding of the plant 44. The charge imparted to the droplets 236′ also advantageously helps droplets 236′ that have wetted the foliage 46 to enter or be drawn into stomata of the foliage 46 of the plant 44 being fertilized. The relatively small size of the droplets 236′ of being no larger in diameter than about 150 nm combined with them being electrically charged helps them even more readily, efficiently and quickly enter pores of stomata of the plant 44 undergoing a feeding cycle. The relatively small size of the droplets 236′ of being no larger in diameter than about 150 nm combined with them being electrically charged together with the droplets being delivered in a growing atmosphere 48 having a pressure greater than atmospheric pressure, preferably greater than 150 kPa, more preferably greater than 300 kPa, helps the droplets yet even more readily, even more efficiently and even more quickly enter pores of stomata of the plant 44 undergoing the feeding cycle. If desired, the nebulizer can be an ionizing nebulizer, such as an electrospray nebulizer, plasma-based nebulizer, a laser ablation nebulizer or a corona discharge nebulizer, which ionizes droplets 236″ and can and preferably also does charge at least some of the ionized droplets 236″ producing ionized charged droplets that also are more readily, more efficiently and more quickly taken up into pores of stomata of the plant 44 being fed.

The result is that at least some of the discharged droplets 236, 236′ and/or 236″ either fall onto the foliage 46, are carried by the growing atmosphere 48 until they reach and wet the foliage 46, and/or are attracted to the foliage 46 either by the droplets being charged, e.g., electrostatically charged, the foliage 46 being charged, e.g., electrostatically charged, or both the droplets and the foliage 46, e.g., plant 44, being charged. The nebulizer 248 is configured to atomize liquid fertilizer 228 entering its intake 268 advantageously discharging a mist 232 from its nozzle 272 composed of droplets 236, 236′ and/or 236″ of fertilizer 225, 225′ and/or 225″ which preferably is an aerosol 234 that can be substantially completely, e.g., 100%, made up of nanosized droplets, which each have a size, preferably diameter, of no greater than 200 nm, which preferably have a size no greater than about 150 nm, and which more preferably have a size no greater than about 100 nm. Where the dispenser 230 is an atomizer or nebulizer that discharges a mist or aerosol, preferably is composed of droplets where at least 35% of the droplets are nanosized, more preferably is composed of at least 50% nanosized droplets, and even more preferably is composed of at least 85% nanosized droplets. In another preferred embodiment, the discharged mist 232 or aerosol 234 is composed of droplets 236, 236′ and/or 236″ of which at least 90% are nanosized. The smaller sized droplets 236, 236′ and/or 236″, particularly those that are nanosized, in the mist 232, preferably aerosol 234, advantageously more easily, more efficiently and more quickly enter pores of stomata of the foliage 46 of the plant 44 being fertilized enabling more fertilizer to be taken up through the stomata and do so more quickly thereby more efficiently and more quickly feeding the plant 44 using a minimum of fertilizer compared to conventional foliar feeding.

The dispensing system 220 can be configured with a charge generator, such as where the nebulizer 248 is an electrostatic nebulizer like that depicted in FIG. 6 that is configured to electrically charge the droplets 236′ of fertilizer 225, 225′ or 225″ discharged from the nebulizer 248 with a charge of one polarity, such as a negative polarity, i.e., negative charge, and which is of a sufficient magnitude, e.g. possesses enough coulombs, to electrostatically attract the charged droplets 236′ to the foliage 46 of the plant 44 closest to the nebulizer 248 advantageously helping to more quickly transport the droplets 236′ through the growing atmosphere 48 to the foliage 46, helping to more rapidly and uniformly wet the foliage 46 when the droplets 236′ make contact therewith, and helping to more efficiently take up the fertilizer 225, 225′ or 225″ by the wetted foliage 46, such as preferably by the charge of the droplets 236′ causing more of the fertilizer 225, 225′ or 225″ to be drawn into stomata of the plant 44. The charged droplets 236′ preferably also cause more rapid uptake of the fertilizer 225, 225′ or 225″ by stomata of the plant 44 thereby more quickly feeding the plant 44 using less fertilizer than conventional methods of foliar and stomatal feeding. Where the nebulizer 248 is an electrostatic nebulizer, it preferably is configured to (a) directly charge to the fertilizer droplets 236′ as they are being discharged from the nebulizer 248 via an electrode (not shown) in contact therewith, and/or (b) pass the droplets 236′ being discharged through an electrical field (not shown) generated by the nebulizer 248 and/or which is disposed adjacent the nebulizer 248 that induces a charge in the droplets 236′.

With reference once again to FIG. 4, each plant 44 in the growing chamber 42 can be grounded, such as by part of the plant 44, e.g. its roots 50, stem 70, and/or foliage 46, e.g., leaves 69, being grounded and/or the chamber 42 being grounded, such as by being connected to a ground wire or strap 296 to a ground 298, e.g., to the earth. In the preferred embodiment depicted in FIG. 4, the ground wire or strap 296 is an electrical conductor, such as in the form of a wire or cable, electrically connected (a) at one end to an electrical grounding arrangement 300 disposed in the chamber 42 that is in electrical communication with one or more of the aforementioned parts of each plant 44 in the chamber 42 and (b) at its other end to ground 298 thereby grounding each one of the plants 44 in the chamber 42. In a preferred embodiment, the electrical grounding arrangement 300 is or includes a metal plate or metallic foil disposed inside the chamber 42 and which is in electrical communication with one or more of the aforementioned parts of each one of the plants 44, such as by being in electrical contact therewith. If desired, each plant 44 in the growing chamber 42 can also be grounded by part of the chamber 42, such as its enclosure 180, growing medium 52, barrier 64 and/or a plant support, e.g. rack 73 (FIG. 2), being disposed in electrical communication with one or more of the aforementioned parts of the plant 44 and/or by part of the growing chamber 42, such as its enclosure 180, the growing medium 52, the barrier 64, and/or plant support, e.g. rack 73, one or more of which are grounded, such as by being connected by ground wire or strap 296 to ground 298.

In the preferred embodiment shown in FIG. 4, the electrical grounding arrangement 300 is or includes a metal plate or metallic foil extending from a first one of the plants 44 disposed to or adjacent one sidewall 182a of the growing chamber enclosure 180 to or adjacent the opposite sidewall 182b of the enclosure 180 and is configured to be in electrical communication with either or both the stem 70 or roots 50 of each plant 44, such as by being in electrical contact therewith. If desired, the electrical grounding arrangement 300 can instead or additionally be disposed in contact with the growing medium 52 in the chamber 42 thereby grounding each plant 44 through its roots 50 being in contact by being immersed in the growing medium 52. In another preferred embodiment, the electrical grounding arrangement 300 is part of the barrier 64, such as in the form of a metal plate or metallic foil attached to the barrier 64, and/or can be integrated into the barrier 64, such as being integrally formed with an electrical grounding arrangement 300, that can be in the form of such a metal plate or metallic foil or by the barrier 64 being composed of or impregnated with an electrically conductive material like carbon, carbon fiber, graphite, graphene, metallic particles, metallic filaments, a combination thereof and/or another electrically conductive material. Such an electrically conductive grounding barrier 64 is in electrical communication with each plant 44 in the chamber 42, such as by being in direct electrical communication therewith, such as by being in electrical contact with one or more of the aforementioned parts, e.g., the stems 70 and/or roots 50, of plant 44, or by being in indirect electrical communication therewith, such as by being in electrical contact with the growing medium 52 in the chamber 42 which is in contact with the roots 50 of each plant 44 immersed therein. Grounding of each plant 44 in the chamber 42 makes the charged droplets 236′ discharged from the charged nebulizer 248 to be more strongly attracted to the leaves 69 and other parts of the foliage 46 of each plant 44 in the chamber 42 being fertilized during a feeding cycle. This obviously also helps make stomatal uptake of the nutrients of the fertilizer 225, 225′ or 225″ more efficient and more rapid by optimizing the charge differential between the charged droplets 236′ in the foliage 46 of each plant 44 being fed.

With additional reference to FIG. 8, the fertilizer delivery system 222 can be configured to include an electrical charge generator 302 of a plant charging system 305 connected by an electrical lead 304, e.g. electrically conductive wire or cable, to an electrical charge distribution arrangement 306 disposed in the chamber 42 that is in electrical communication with one or more parts, such as the stem 70, roots 50, and/or foliage 46, e.g. leaves 69, of each plant 44 in the chamber 42 to impart an electrical charge thereto of a desired polarity, e.g. a negative or positive charge, and magnitude, such as in coulombs, that is sufficient to attract uncharged fertilizer droplets 236 discharged from a nebulizer 248 that is not a charged, e.g. electrostatic, nebulizer, to the foliage 46 of each plant 44 in the chamber 42 being fertilized during a feeding cycle. This charged attraction of the uncharged droplets 236 to foliage of a plant being fed during a feeding cycle not only causes the uncharged droplets 236 to make contact with and wet the foliage of a plant 44 being fertilized, it also advantageously helps more uniformly wet and spread liquid fertilizer in the droplets 236 along the external surfaces of the foliage 46 of the plant 44 thereby helping to more efficiently and more quickly foliar feed the plant 44 preferably via faster and more uniform stomatal uptake thereby. If desired, the charge generator 302 can also be and preferably is grounded by being connected to a ground 298, e.g., the earth. If desired, each plant 44 in the growing chamber 42 can also be charged by part of the chamber 42, such as its enclosure 180, growing medium 52, barrier 64 and/or a plant support, e.g. rack 73 (FIG. 2), being disposed in electrical communication with one or more of the aforementioned parts of the plant 44 and in electrical communication with charge generator 302 such as by electrical lead 304 connecting the charge generator 302 to one or more of the enclosure 180, growing medium 52, barrier 64 and/or plant support rack 73 disposed in contact with at least one of the aforementioned parts of plant 44.

In the preferred embodiment depicted in FIG. 8, the charge distribution arrangement 306 is or includes a metal plate or metallic foil extending from a first one of the plants 44 disposed to or adjacent one sidewall 182a of the chamber enclosure 180 to or adjacent the opposite sidewall 182b of the enclosure 180 and is configured to be in electrical communication with either or both the stem 70 or roots 50 of each plant 44, such as by being in electrical contact therewith. If desired, the charge distribution arrangement 306 can instead or additionally be disposed in contact with the growing medium 52 in the chamber 42 thereby supplying an electrical charge to each plant 44 through their roots 50 being in contact with the growing medium 52 by being immersed in the growing medium 52. In another preferred embodiment, the charge distribution arrangement 306 can be carried by or made part of the barrier 64, such as in the form of a metal plate or metallic foil attached to the barrier 64, and/or can be integrated into the barrier 64, such as being integrally formed with an integral charge distribution arrangement 300, which can be in the form of such a metal plate or metallic foil. In one such embodiment where the barrier 64 includes an integral charge distribution arrangement 306, it can be in the form of the barrier 64 being composed of or impregnated with an electrically conductive material like carbon, carbon fiber, graphite, graphene, metallic particles, metallic filaments, another electrically conductive material, and/or combinations thereof. Such an electrical charge distributing grounding barrier 64 is configured to be in electrical communication with each plant 44 in the chamber 42, such as by being in direct electrical communication therewith, such as by being in electrical contact with one or more of the aforementioned parts, e.g., the stems 70 and/or roots 50, of each plant 44, and/or by being in indirect electrical communication therewith, such as by being in electrical contact with the growing medium 52 in the chamber 42 which in turn is in contact with the roots 50 of each plant 44 immersed therein.

It is contemplated as being within the scope of the present invention to electrically charge each plant 44 being fertilized with charged droplets 236′ from an atomizer 246 that preferably is a charged, e.g. electrostatically charged, atomizer that more preferably is a nebulizer 248 that even more preferably is a charged, e.g. electrostatically charged, nebulizer. In one such preferred embodiment and charging method, (a) a charge of one polarity, e.g., a positive charge, and sufficient magnitude, e.g., in coulombs, can be applied, directly or indirectly, to the plant 44, such as in the manner discussed hereinabove, and/or induced in the plant 44, such as via an electric field using an electric field charge generator (not shown), to electrostatically charge the plant 44,, and (b) a charge of an opposite polarity, e.g., a negative charge, and sufficient magnitude, e.g., in coulombs, can be applied directly or indirectly to the droplets 236′ exiting the atomizer 246, preferably nebulizer 248, such as by charging an electrode thereof that comes in contact with the liquid fertilizer 225, 225′ or 225″ passing through atomizer 246, preferably nebulizer 248, including fertilizer droplets 236′ that are nanosized or inducing a charge in the droplets 236′ by an electric field through which the droplets 236′ discharged from the atomizer 246, preferably nebulizer 248, pass through. In such a preferred dual charge fertilizer delivery system and embodiment, the charge generator 302 is configured to apply an electrical charge, preferably electrostatic charge, of one polarity, such as one of a negative or positive polarity, at a desired magnitude, such as in coulombs, to each plant 44 being fertilized and the atomizer 246, preferably nebulizer 248, is configured to apply another electrical charge, preferably electrostatic charge, of a polarity opposite the polarity of the charge of each plant 44 being fertilized at a desired magnitude, such as in coulombs, to the fertilizer droplets 236′ discharged from atomizer 246, preferably nebulizer 248. In one preferred embodiment and method, the fertilizer delivery system 222 is configured to charge the droplets 236′ of fertilizer 225, 225′ or 225″ discharged from atomizer 246, preferably nebulizer 248, into the growing atmosphere 48 with a negative electrostatic charge at a minimum desired charge magnitude of a predetermined minimum number of coulombs and the charge generator 302 of the plant charging system 305 is configured to apply a positive electrical charge, e.g. positive electrostatic charge, to each plant 44 being fertilized by droplets 236′ having a minimum desired charge magnitude of a predetermined minimum number of coulombs. In a preferred method implementation, the preferred minimum charge magnitude in coulombs and charge polarity of each plant 44 being electrically charged during feeding is based on the type, variety and/or strain of the plant, the amount or mass of the vegetation of the plant, as well as a minimum rate of foliar feeding, preferably stomatal feeding, desired based on the type, variety and/or strain of the plant, the amount or mass of the vegetation of the plant.

In a preferred method of electrostatically charging one or more plants 44 in the chamber 42 during growing system operation and particularly during a feeding cycle, at least each plant 44 undergoing a feeding cycle is electrically charged for substantially the duration of the entire feeding cycle thereby attracting the droplets 236 of fertilizer 225, 225′ or 225″ to the foliage 46 of each plant 44 being fed. Such a preferred method and embodiment preferably also includes a charge controller 308 in communication with the charge generator 302 that is configured in software and/or firmware as well as preferably also via user input to monitor one or more and preferably at least a plurality of operation of the fertilizer delivery system 222, each plant 44 undergoing a feeding cycle, and/or the growing atmosphere 48 in the chamber 42 and control at least one and preferably both of the polarity and magnitude of the charge applied to each plant 44. In one preferred method implementation, the controller 308 is in communication with a sensor (not shown), such as a particle sensor or particulate sensor, in communication with the growing atmosphere 48 that is configured to monitor droplets 236 and/or 236′ in the growing atmosphere 48 and increase a magnitude of the electrical, e.g. electrostatic, charge being applied by the charge generator 302 to each plant 44 being fertilized if the particle count of droplets 236 and/or 236′ in the growing atmosphere 48 exceeds a predetermined particle count threshold. In another preferred method implementation, one or more parameters of each plant 44 being charged by the charge generator 302 is monitored and the polarity and/or magnitude of the charge controlled or otherwise adjusted based on those parameters. In one such preferred method implementation, the controller 308 is configured to monitor operation of the fertilizer delivery system 222, including a rate of delivery of fertilizer from nebulizer 248 and control operation of the generator 302 in a manner that controllably varies the charge applied to each plant 44 being fertilized to ensure that a magnitude of the charge of each plant 44 falls within a predetermined desired charge range that ensures a predetermined desired minimum rate of fertilizer delivery is achieved and preferably maintained during a feeding cycle.

In a preferred embodiment and method of the invention, when the charged nanosized surfactant-carrying nutrient-containing fertilizer droplets of the aerosol discharged from the nebulizer float in the growing atmosphere towards the foliage of the plant being fertilized, the charge of the droplets in the aerosol attracting the droplets to the foliage causing the droplets to reach and contact the exterior surface of the foliage more rapidly advantageously helping to speed feeding. The surfactant present in the droplets beneficially more quickly wets the foliage surface with the fertilizer and more uniformly spreads the fertilizer out over the foliage surface causing the fertilizer to reach a greater number of stomata thereby maximizing uptake during stomatal feeding of the plant. The surfactant present can also give rise to a wicking action which helps increase uptake by drawing more of the fertilizer that has wetted the surface of the foliage into pores of the stomata, even when the pores are less than fully open and even when they have a relatively small partially closed pore size that ordinarily would not permit uptake/passage therethrough. The charge can also advantageously help facilitate more rapid uptake of the fertilizer into the pores of the stomata of the foliage by helping to draw fertilizer of droplets that have wetted the foliage surface into the pores of the stomata.

Where the liquid fertilizer contains a fertilizer enhancer 240, e.g., fertilizer-enhancing composition, that is a surfactant 242, the discharge nozzle configuration of the nebulizer 248 advantageously even uniformly mixes the fertilizer with fertilizer-enhancing composition 240 containing one or more of the aforementioned non-nutrient compounds during nebulizer operation producing a non-nutrient compound enhanced fertilizer in accordance with the present invention that is discharged as an aerosol containing nanosized droplets of the enhanced fertilizer into the growing atmosphere during a feeding cycle during growing system operation. In one preferred embodiment of a fertilizer that is an enhanced fertilizer that contains a non-nutrient composition composed of one or more surfactants, such as one or more of the aforementioned surfactants listed above, and method the surfactant-containing non-nutrient composition is uniformly and preferably homogeneously mixed with the fertilizer by the nebulizer and discharged as an aerosol of nanosized droplets of enhanced fertilizer with the surfactant(s) in each droplet helping to attract the droplets to the foliage of the plant undergoing foliar feeding, helping to more rapidly and uniformly spread out over the surface of the foliage, and/or helping through wicking action to more easily draw one or more nutrients in the fertilizer into pores of the stomata of the foliage, even when the stomata pores are not completely open, e.g., slightly open or partially closed, where the pores have an opening size which ordinarily would not be sufficient to allow uptake of the nutrients and/or fertilizer.

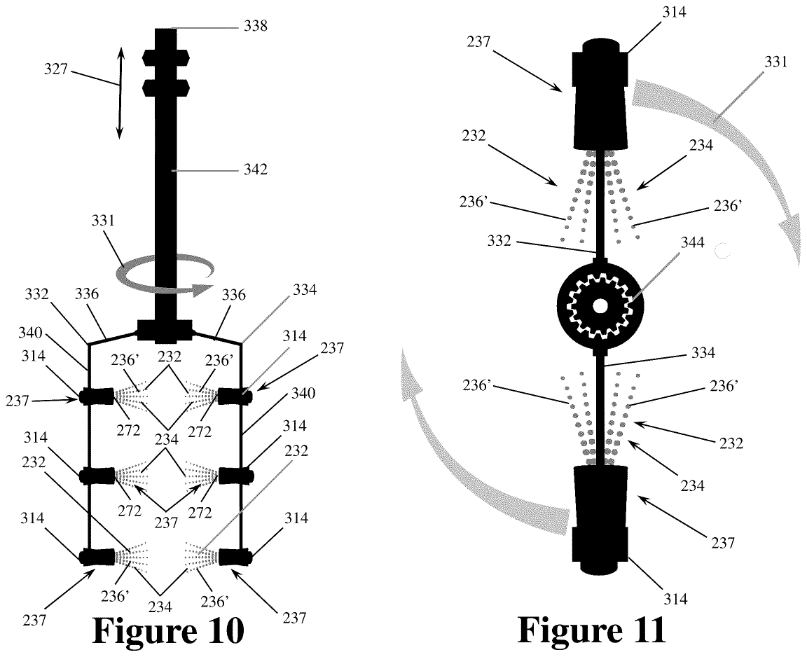

FIGS. 5-11 depict various components of a foliar fertilizer application system 310 of the present invention that can be carried by growing chamber 42 that preferably is disposed within the chamber 42 that includes (a) a fertilizer dispenser assembly 314 like that depicted in FIG. 7 which has a shroud 316 that houses at least the nozzle 272 of a fertilizer dispenser 230 that is an atomizer 246, preferably a nebulizer 248, from which nanosized droplets 236 and/or 236′ of a fertilizer 225, 225′ or 225″ are discharged that can be and which preferably are nanosized, and (b) a gantry system 318 that includes a horizontally and vertically movable and rotatable fertilizer dispenser-carrying gantry 320 operatively connected and movably coupled to a track system 322 mounted to the top wall 184 of the enclosure 180 of chamber 42 enabling the gantry 320 and its multiple fertilizer dispensers 230, preferably atomizers 246, more preferably nebulizers 248, to (i) move substantially simultaneous horizontally bidirectionally in an X direction relative to the X axis as indicated by arrow 325 along a pair of spaced apart tracks or rails 324, 326 mounted to the top wall 184 that extend in the X direction, (ii) move substantially simultaneously horizontally bidirectionally in a Y direction relative to the Y axis as indicated by arrow 327 (FIG. 9) along at least one track or rail 328 that extends in the Y direction, (iii) move substantially simultaneously vertically bidirectionally in a Z direction relative to the Z axis as indicated by arrow 329 (FIGS. 1 & 10) along a vertically extending track or rail 330 (FIG. 1), and (iv) rotate, as depicted by arrow 331, preferably bidirectionally, about a generally vertically extending rotational axis that is the Z axis or parallel to the Z axis to position foliage 46 of at least one plant 44, preferably a single plant 44, undergoing a feeding cycle between a pair of fertilizer dispenser carrying arms 332, 334 of the gantry 320. As best shown in FIG. 10, each one of the arms 332, 334 have (a) a first arm segment 336 extending radially oppositely outwardly away from each other from a vertically extending vertically movable carriage 338 of the gantry 320, and (b) a second arm segment 340 extending downwardly and parallel to one another with the nozzles 272 of their respective dispensers 230, preferably atomizers 246, more preferably nebulizers 248, facing toward one another and toward the foliage 46 of the single plant 44 being fertilized thereby during a single feeding cycle. In a preferred embodiment, such a foliar fertilizer application system 310 is a stomatal feeding application system 312 configured for applying fertilizer on foliage 46 of plants 44 in chamber 42 in a manner that enables stomatal uptake of fertilizer through stomata 374 of foliage 46 of each plant 44 undergoing feeding during a feeding cycle.

As depicted in FIGS. 8-10, the gantry 320 carries at least a plurality, and preferably at least a plurality of pairs of, i.e., at least three, fertilizer dispenser assemblies 314 each equipped with a nozzle 272 from which droplets 236 or 236′ of fertilizer 225, 225′ or 225″ are discharged during plant feeding cycle operation. In the preferred gantry embodiment shown in FIGS. 8 and 10, each one of the gantry arms 332, 334 are equipped with a plurality, preferably a plurality of pairs of the fertilizer dispenser assemblies 314 preferably arranged in opposed pairs which face each other for dispensing nanosized droplets 236 or 236′ of fertilizer 225, 225′ or 225″ toward and onto foliage 46 of a plant 44 disposed therebetween as shown in FIG. 8. As is also shown in FIGS. 8 and 10, the arms 332, 334 of the gantry 320 have at least a plurality of opposed pairs of and preferably a plurality of pairs of fertilizer dispenser assemblies 314 which face toward each other and toward a single plant 44 disposed therebetween.

The gantry carriage 338 includes an elongate vertically oriented shaft 342 that is operatively, movably, and rotatively connected and/or coupled, such as at one shaft end, to part of the track system 322 in a manner that enables movement of the gantry 320, arms 332, 334, and fertilizer dispenser assemblies 314 relative to the track system 322, chamber 42, and plant 44 being fed in the X, Y and Z directions and/or rotatively about vertical axis coaxial or parallel to the Z axis in the manner depicted in FIGS. 8 and 9. As is best shown in FIGS. 9 and 11, the gantry carriage 338 is connected by a rotary gearbox 344 to the track or rail 328 that extends in the Y-direction enabling rotation of the carriage 338, arms 332, 334, and dispensing assemblies 314 about a vertical Z axis. The rotary gearbox 344 is configured to enable rotation of the gantry 320 to rotate the arms 332, 334 and the nozzles 272 of the fertilizer dispensing assemblies 314 carried by the arms 332, 334 about the periphery of the foliage 46 of the plant 44 being fertilized in a full 360° revolution during a feeding cycle of the plant 44 to ensure all of the foliage 46 is wetted with fertilizer 225, 225′ or 225. In one preferred embodiment and method, only a one-half revolution or a rotation of about 180° is needed for completing a feeding cycle. The gantry 320 is rotated at least one-half revolution and can be rotated more than one-half revolution to rotate the arms 332, 334 and nozzles 272 of dispenser assemblies 314 a corresponding amount discharging nanosized fertilizer droplets 236′ onto foliage 46 of the plant 44 being fertilized while the gantry 320 moves up and down as needed to ensure the foliage 46 of the plant 44 is substantially completely covered with fertilizer 225, 225′ or 225″ to ensure the plant 44 receives an appropriate amount of nutrients during the feeding cycle.

In a preferred embodiment and method, the gantry 320 is controllably positioned by a controller in communication with one or more sensors, such as optical and/or IR sensors within the chamber 42 that causes the gantry 320 to travel along one or both tracks or rails 324, 326 and/or 328 within the chamber 42 relative to the plants 44 until the gantry arms 332, 334 are positioned with the foliage 46 of a desired single plant 44 to be fertilized is disposed between the arms 332, 334. Depending on the height of plant 44 being fertilized sensed by one or more of the aforementioned sensors, the gantry 320 is controllably moved vertically up or down as needed to position at least one and preferably at least a plurality of the dispensing assemblies 314 of each arm 332, 334 below a top of the plant 44 to be fertilized. After locating the plant 44 to be fertilized using the sensors and the controller to control positioning of the gantry 320 and arms 332, 334 and positioning the gantry 320 so the arms 332, 334 bracket the plant 44, the gantry 320 is controllably rotated while droplets 236′ of fertilizer 225, 225′ or 225″ are discharged from the nozzles 272 of at least one of the pairs of oppositely facing fertilizer dispensing assemblies 314 toward foliage 46 of the plant 44 being fed.

In one preferred embodiment and method of performing a feeding cycle for a plant 44, the gantry 320, arms 332, 334 and nozzles 272 of dispensing assemblies 314 are rotated in one direction, e.g., clockwise, at least about one complete 360° revolution during a single feeding cycle to complete the feeding cycle for a single plant 44. In another preferred embodiment and method, the gantry 320, arms 332, 334 and nozzles 272 of dispensing assemblies 314 are rotated a plurality of 360° revolutions during a single feeding cycle of a single plant 44. In yet another embodiment and method, the gantry 320, arms 332, 334 and nozzles 272 of dispensing assemblies 314 are rotated about one 360° revolution in one direction, e.g., clockwise direction, and thereafter rotated about one 360° revolution in the opposite direction, e.g., counterclockwise direction, in completing a single feeding cycle for a single plant 44. In a further preferred embodiment and method, the gantry 320, arms 332, 334 and nozzles 272 of dispensing assemblies 314 are rotated one half revolution or about 180° to perform a complete feeding cycle for a single plant 44. In yet another preferred embodiment and method, the gantry 320, arms 332, 334 and nozzles 272 of dispensing assemblies 314 are rotated one half revolution or about 180° in one direction and then rotated one half revolution or about 180° in the opposite direction to perform a complete feeding cycle for a single plant 44. If desired, the gantry 320 can be moved up and/or down during rotation during a feeding cycle, such as to better position one or more of the nozzles 272 of one or more of the dispensing assemblies 314 relative to foliage 46 of the plant 44 being fertilized during a feeding cycle to ensure the external surfaces of the foliage 46 of the plant 44 are substantially completely wetted or coated with droplets of fertilizer 225, 225′ or 225″. After performing a complete feeding cycle for one of the plants 44 in the chamber 42, the gantry 320, arms 332, 334 and nozzles 272 of dispensing assemblies 314 are moved along tracks to position the arms 332, 334 and nozzles 272 of dispensing assemblies 314 so they bracket a second one of the plants 44 in the chamber 42 before executing another feeding cycle where the arms 332, 334 and nozzles 272 of dispensing assemblies 314 are rotated and/or raised or lowered as needed to perform the feeding cycle for the second one of the plants 44. This feeding cycle method is repeated for each one of the plants 44 in chamber 42 until a feeding cycle is carried out for each one of the plants 44 in the chamber 42.

FIGS. 4, 12 and 13 depict an acoustical plant stimulation system 60 of the present invention that is equipped with an acoustic controller, such as preferably in the form of an acoustical tone generator 346 (FIG. 4), e.g., sound generator, which is connected, such as by electrical wiring or cabling 348 (FIG. 4) to at least a plurality of pairs, i.e. at least three, of the transducers 350 that preferably are electro-acoustical transducers configured to generate sound in the growing atmosphere 48 of the chamber 42 in the form of sound waves which have a desired predetermined frequency or frequencies or which have frequencies which vary during acoustical stimulation but which fall within a desired predetermined frequency range which travel through the atmosphere 48 until the sound waves reach and acoustically stimulate foliage 46 and preferably also the other parts of the shoot system 68 of each plant 44 being grown in the chamber 42 into one or more germinating faster, growing faster, producing more vegetation, producing greater yields, and/or having shorter harvest times compared to plants of the same type, variety and strain grown without being subjected to such acoustical stimulation. In a preferred embodiment and method of acoustical stimulation system operation, the system 60 does so by the tone generator 346 providing an electrical signal via the wiring or cabling 348 to the transducers 350 configured to cause the transducers 350 to output sound into the growing atmosphere 48 at such a desired predetermined frequency or frequencies or which have frequencies which vary during acoustical stimulation but which fall within a desired predetermined frequency range configured to (a) open stomata of foliage 46 of the plants 44 in the chamber 42 and/or (b) open wider stomata of foliage 46 of the plants 44 in the chamber 42 to facilitate foliar feeding, preferably stomatal feeding, of at least one of the plants 44 during a feeding cycle for that plant 44. In one such preferred embodiment and method of acoustical stimulation system operation, the system 60 can be and preferably is operated such that the tone generator 346 provides an electrical signal via the wiring or cabling 348 to the transducers 350 configured to cause the transducers 350 to output sound into the growing atmosphere 48 at a different desired second predetermined frequency or frequencies or output other frequencies which vary during acoustical stimulation but which fall within a different second predetermined frequency range configured to (a) begin closing stomata of foliage 46 of the plants 44 in the chamber 42 and/or (b) substantially completely close the stomata of foliage 46 of the plants 44 in the chamber 42 such as after a plant feeding cycle, such as preferably after all the plant feeding cycles of all the plants 44 in the chamber 42 have been completed.

The transducers 350 of the acoustical plant stimulation system 60 are preferably carried by one of the walls 182a, 182b, 182c, 182d and/or 184 that define the enclosure 180 of the growing chamber 42, such as by being mounted to a corresponding one of the walls 182a, 182b, 182c, 182d and/or 184 of the enclosure 180. The transducers 350 are configured to direct sound towards the foliage 46 of the plants 44 in the chamber 42 such as by being oriented relative to the enclosure 180, chamber 42 and foliage 46 of plants 44 in the chamber 42, generally toward the plant foliage 46 of the plants 44 to direct sound emitted therefrom during acoustical plant stimulation system operation through the growing atmosphere 48 generally toward the plants 44 and particularly toward the foliage 46 and/or shoots 68 of the plants 44. The transducers 350 can be disposed within the atmosphere holding compartment 188 of the chamber 42 and oriented to emit sound generally toward the foliage 46 of plants 44 in the chamber 42 or can be configured to conduct sound emitted therefrom through an opening in the corresponding growing chamber enclosure wall to which the transducer 350 is mounted or otherwise carried by, and/or through a duct, port, or tube extending through the corresponding enclosure wall into the growing atmosphere 48 of the chamber 42 and toward the foliage 46 of the plants 44. As discussed in more detail below, the present invention also contemplates at least some of the transducers 350 being conduction transducers configured to vibrationally couple with a corresponding enclosure wall 182a, 182b, 182c, 182d or 184 to which the transducer 350 is mounted in a manner that excites the wall itself into generating or emitting the sound used to acoustically stimulate the plants 44 in the chamber 42.

Each one of the transducers 350, such as preferably conventional air-moving speakers 355, e.g. speaker drivers, such as a dynamic (cone) driver, a piezoelectric driver, an electrostatic driver, a planar magnetic driver, a ribbon driver, a horn driver, or a bone conduction driver, that emit acoustic energy, such as in the form of audible sound having a frequency between 20 Hz and 20,000 Hz, which is communicated to foliage 46, shoots 68, and stems of plants 44 in chamber 42 acoustically stimulating the foliage 46, shoots 68, and stems of plants 44 in chamber 42 during acoustical plant stimulation system operation. Transducers 350 are configured and oriented to direct acoustic energy having one or more desired frequencies and/or within a desired frequency range, discussed in more detail below, into chamber 42 and towards foliage 46, shoots 68, and stems of plants 44 at an amplitude sufficient to acoustically stimulate plants 44 in chamber 42 in a manner that improves one or more of plant growth, yield, fertilizer uptake, and/or transpiration. Transducers 350 can be disposed within atmosphere holding compartment 188 of chamber 42 and be configured and oriented relative to and preferably toward foliage 46 of plants 44 so emitted acoustic energy emitted travels through growing atmosphere 48 in compartment 188 until it reaches and acoustically stimulates foliage 46 of plants 44. Transducers 350 can also be configured and oriented to conduct emitted acoustic energy through an opening, duct, port or tube extending through corresponding adjacent growing chamber enclosure wall 182a, 182b, 182c, 182d and/or 184 into atmosphere 48 carrying transducer 350 so it reaches and acoustically stimulates foliage 46 of plants 44 in chamber 42.

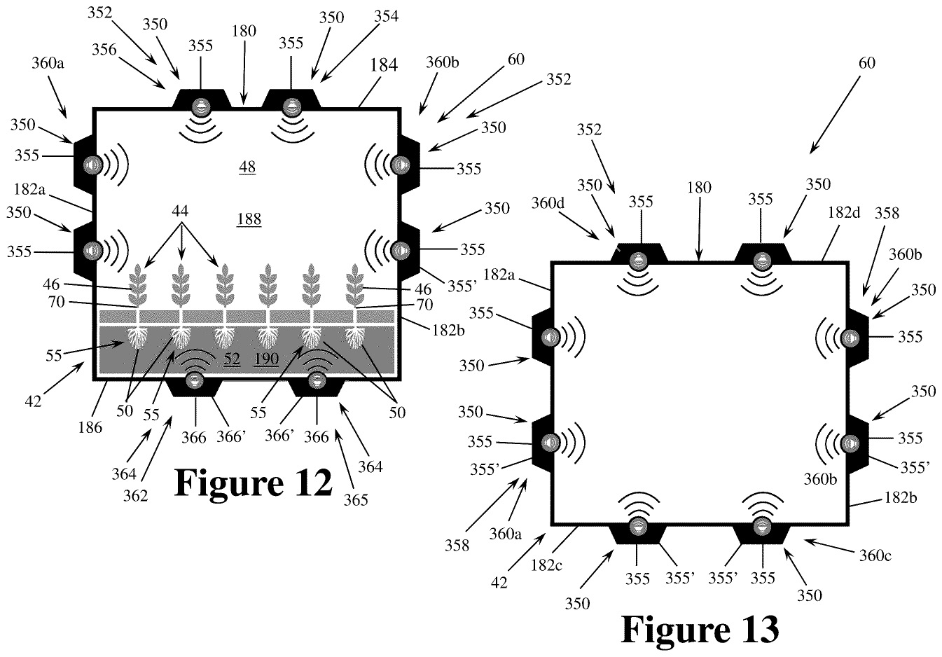

The transducers 350 can further be configured for conduction of acoustic energy directly through and/or using corresponding wall 182a, 182b, 182c, 182d and/or 184 to which transducer 350 is mounted such as where a corresponding conduction speaker 355′, e.g., surface transducer or sound exciter, is attached directly to a corresponding wall 182a, 182b, 182c, 182d and/or 184 of enclosure 180. and excite the wall into vibrating at one or more desired plant stimulating frequencies and/or within a desired range of plant stimulating frequencies like those discussed below. In such a preferred configuration, the conduction speakers 355′ are attached to the corresponding enclosure wall 182a, 182b, 182c, 182d or 184 that vibrationally couples the wall thereto vibrating the wall 182a, 182b, 182c, 182d or 184 at a high enough frequency and amplitude that causes wall 182a, 182b, 182c, 182d or 184 to emit acoustic energy, preferably in the form of sound waves, into growing atmosphere 48 within compartment 188 which travel through atmosphere 48 until sound waves reach foliage 46 of plants in chamber 42 thereby acoustically stimulating the plants 44. Where conduction speakers 355′ are used, each speaker 355′ is directly attached to a corresponding wall 182a, 182b, 182c, 182d and 184, wall 182a, 182b, 182c, 182d and 184 preferably is generally flat, generally smooth and made of a stiff yet flexible enough material having suitably low damping and resonant frequency within the frequency operating or output range of speaker 355′ mounted thereto, and possesses an acoustic impedance matching the acoustic impedance of (a) speaker 355′ and (b)(i) growing atmosphere 48 and/or (ii) atmosphere holding compartment 188. With continued reference to FIGS. 12 and 13, acoustic energy emitted by each conduction speaker 355′ transforms corresponding wall 182a, 182b, 182c, 182d and 184 into an acoustic transducer coupled speaker wall 182a′, 182b′, 182c′, 182d′ and 184′ vibrated by speaker 355′ mounted thereto causing wall 182a′, 182b′, 182c′, 182d′ and 184′ to emit acoustic energy into atmosphere 48 that acoustically stimulates plants 44 in chamber 42. Examples of suitable materials that wall 182a, 182b, 182c, 182d and 184 can be made of in order to be transformed into an acoustic energy outputting wall 182a′, 182b′, 182c′, 182d′ and 184′ include aluminum, acrylic, e.g., Plexiglas, glass, medium density fiberboard, wood, e.g. plywood, carbon fiber composites, polycarbonate, fiberglass, ceramic materials, and paper-based composites.

With continued reference to FIGS. 12 and 13, the transducers 350 preferably are arranged in an acoustical plant stimulating transducer array 352 so that substantially the entire shoot system 68 of each plant 44 each plant 44 disposed in the growing atmosphere holding compartment 188 of chamber 42, including the leaves 69 of its foliage 46 and its stem 70, are substantially uniformly acoustically immersed in sound therefrom directed from all four sides 182a, 182b, 182c, 182d and the top 184 of the chamber 42. The transducers 350 of the array 352 are preferably configured to deliver a relatively uniform sound pressure level, preferably in dB, substantially simultaneously to the foliage 46 of each plant 44 such that the sound pressure level at the foliage 46 of one plant 44 in the atmosphere holding compartment 188 of the chamber 42 preferably is within ±10 dB, preferably within ±7.5 dB, and more preferably within ±5 dB of the sound pressure level at the foliage 46 of every other plant 44 in the atmosphere holding compartment 188 of the chamber 42 during acoustical plant stimulating system operation.

In a preferred embodiment, the acoustical plant stimulating transducer array 352 includes (a) an overhead transducer arrangement 354 disposed over or overhead the plants 44 and above the foliage 46 of the plants 44 in the growing atmosphere holding compartment 188 of the chamber 42 that is or includes an overhead bank 356 of at least a plurality of substantially uniformly spaced apart transducers 350 which overlies the tops of the foliage 46 of the plants 44, and (b) a laterally disposed transducer arrangement 358 disposed to the side of or alongside the foliage 46 of the plants 44 that is or includes at least one laterally disposed bank 360a, 360b, 360c, 360d disposed to the side of or alongside the foliage 46 of the plants 44 in the chamber 42. The overhead disposed transducers 350 of the overhead transducer arrangement 354 are oriented, arranged and configured to collectively focus sound emanating from the overhead transducers 350 downwardly towards the tops of the foliage 46 of the plants 44 and the portion of the foliage 46 of the plants 44 that extends outwardly of the foliage tops of the plants 44. The transducers 350 of the laterally disposed transducer arrangement 358 are disposed alongside the foliage 46 of the plants 44 and oriented, arranged and configured to collectively focus sound emanating from the laterally disposed transducers 350 generally towards the sides of the foliage 46 of the plants 44 in the chamber 42. As depicted in FIG. 12, the transducers 350 of the laterally disposed transducer arrangement 358 can be and preferably are located at a height lower than the transducers 350 of the overhead transducer arrangement 354 to help more uniformly distribute sound within at least the growing atmosphere holding compartment 188 of the chamber 42, including to parts of the stems of each plant 44 disposed within the foliage 46.

The overhead bank 356 of transducers 350 preferably is composed of at least a plurality of pairs, i.e. at least three, of uniformly spaced apart transducers 350 which can be arranged in a plurality of rows and a plurality of columns of the transducers 350. As previously discussed, the transducers 350 of the overhead arrangement 354 can be carried by the top wall 184 of the chamber 42 like that depicted in FIG. 12 or can be otherwise disposed inside the chamber 42 underneath the top wall 184 and can be spaced from the top wall 184. As previously discussed, the transducers 350 can be directly attached to the top wall 184 and configured to excite the top wall 184 into vibrating at plant stimulating frequencies that is delivered to the plant foliage 46 causing sound waves at those desired frequencies to emanate from an interior surface of the wall 184 that faces generally towards the tops of the plants 44 into the growing atmosphere 48 where the sound travels to the plants 44 during acoustical plant stimulation. Although not shown in FIG. 12, one of the transducers 350, more than one of the transducers 350, or even all of the transducers 350 of the overhead bank 356 can be conduction speakers 355′, e.g. surface transducers or sound exciters.

In the preferred embodiment shown in FIGS. 12 and 13, the laterally disposed transducer arrangement 358 is composed of a plurality of, preferably at least a plurality of pairs, i.e. at least three, of laterally disposed banks 360a, 360b, 360c and 360d of transducers 350 disposed along a corresponding side of the foliage 46 of the plants 44 in the chamber 42. In other words, in the preferred embodiment depicted in FIGS. 12 and 13, the laterally disposed transducer arrangement 358 is composed of a laterally disposed bank 360a, 360b, 360c and 360d of transducers 350 for each one of the walls 182a, 182b, 182c, and 182d that form the enclosure 180 of the chamber 42. Where the chamber enclosure 180 is formed of a single sidewall, such as a tubular or cylindrical sidewall (not shown), the laterally disposed transducer arrangement 358 preferably is composed of at least laterally disposed transducers 350 uniformly spaced apart, preferably equiangularly or equidistantly spaced apart, about the single wall and/or periphery of the foliage 46 of the plants 44 disposed in the chamber 42 and which are oriented to generally focus the sound towards the plants 44 and/or a center of the chamber 42. Where the transducers 350 are conduction speakers 355′, there preferably are at least two of the speakers 355′ fixed to the single enclosure sidewall which are uniformly, preferably equiangularly or equidistantly, spaced apart from each other about or along the single wall and/or the periphery of the foliage 46 of the plants 44 located in chamber 42.

With reference collectively to FIGS. 12 and 13, each one of the laterally disposed banks 360a, 360b, 360c and 360d has a pair of uniformly or equidistantly spaced apart rows and uniformly or equidistantly spaced apart columns of transducers 350 such that each bank 360a, 360b, 360c and 360d as at least four transducers 350 with FIG. 12 depicting that each bank 360a, 360b, 360c and 360d has a pair of uppermost transducers 350 and a pair of lowermost transducers 350 located at a height lower than and preferably below the uppermost transducers 350. In other words, there are at least four, preferably two pairs, of transducers 350 for each enclosure wall 182a, 182b, 182c or 182d arranged in two rows and two columns with there being an uppermost pair of transducers 350, a lowermost pair of transducers 350, a right-hand side pair of transducers 350, and a left-hand side pair of transducers 350. Although not clearly shown in FIG. 12, the overhead bank 356 preferably also contains pair of uniformly or equidistantly spaced apart rows and uniformly or equidistantly spaced apart columns of transducers 350.

With continued reference to FIGS. 12 and 13, one or more of the laterally disposed banks 360a, 360b, 360c and 360d can have at least one transducer 350 that is a conduction speaker 355′ and can have at least one other transducer 350 that is a speaker 355 that is conventional air-moving speaker that is not a conduction speaker 355′. If desired, all of the transducers 350 of a plurality of the laterally disposed banks 360a, 360b, 360c and 360d can be or include conduction speakers 355′. In one embodiment like that depicted in FIG. 12, the lowermost transducers 350 of at least a plurality of the laterally disposed banks 360a, 360b, 360c and 360d, in this case, banks 360a and 360b of corresponding opposed enclosure walls 182a and 182b which face each other, are conduction speakers 355′ and the uppermost transducers 350 of the same plurality of laterally disposed banks 360a, 360b, 360c and 360d, in this case, banks 360a and 360b of walls 182a and 182b, are speakers 355 that are conventional air-moving speakers (not conduction speakers 355′). In the embodiment of FIG. 12, none of the transducers 350 of overhead bank 356 are conduction speakers 355′, but if desired at least one of the transducers 350, more than one of the transducers 350, e.g., one row or one column of the transducers 350, or even all the transducers 350, e.g., all of the rows or columns of transducers 350, of overhead bank 356 can be or include conduction speakers 355′.

In another embodiment like that depicted in FIG. 13, at least the one of the rows of the transducers 350 of at least a plurality of the laterally disposed banks 360a, 360b, 360c and 360d, in this case, banks 360a and 360b of opposed walls 182a and 182b, are conduction speakers 355′ and at least one of the other rows of transducers 350 of these same plurality of banks 360a, 360b, 360c and 360d, namely, banks 360a and 360b of walls 182a and 182b, are speakers 355 that are conventional air-moving speakers (not conduction speakers 355′). In yet another embodiment, all of the transducers 350 of one of the banks, namely bank 360c, of a corresponding one of the enclosure walls, namely wall 182c, are or include conduction speakers 355′ with the rest of the transducers 350 of the bank 360d of the opposing wall 182d are or include speakers 355 that are conventional air moving speakers.

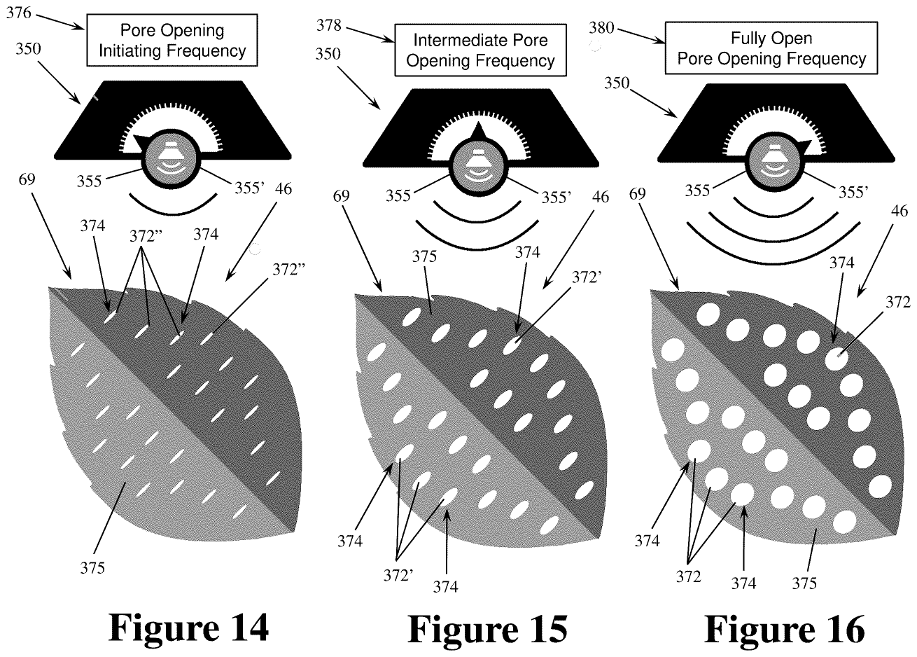

With reference once again to FIG. 4, operation of at least the tone generator 346 of the acoustical plant stimulation system 60 and preferably also the transducers 350, including the frequency or tonal output and loudness or sound pressure level of the plant stimulating sound waves generated by the transducers 350, are controlled by an acoustical stimulation system controller 368 configured in software and/or firmware as well as via user input 370 to do so in a manner that acoustically stimulates foliage 46 and preferably also other parts of the shoot system of each plant 44, particularly stomata 374 thereof, to facilitate foliar feeding, preferably stomatal feeding, during carrying out a feeding cycle of the plants 44. The controller 368 preferably is configured in software and/or firmware as well as via user input 370 to control the frequency or tonal output and loudness or sound pressure level of the plant stimulating sound waves generated by the transducers 350 directed toward the plants 44 which travel through the growing atmosphere 48 to acoustically stimulate foliage 46 of each plant 44. In particular, the sound waves acoustically stimulate the stomata 374 thereof, including the guard cells (not shown) of each stoma 374, in a manner that can and preferably does cause pores 372 of the stomata 374 in the underside external surface or abaxial surface 375 of each leaf 69 of the foliage 46 of each plant 44 in the chamber 42 to begin opening like that depicted in FIG. 14 and which continue to further open as depicted in FIG. 15 until substantially completely open as depicted in FIG. 16 as the foliage 46 is progressively acoustically stimulated with increasing frequency sound waves in the manner described in more detail below.

As discussed in more detail below in reference to FIGS. 14-16, before initiating a feeding cycle or at the beginning of a feeding cycle and preferably during a feeding cycle, the controller 368 can be and preferably is configured to perform sonic induced stomatal pore widening by carrying out a stomata pore opening acoustical stimulation cycle of the present invention by controllably operating the transducers 350 to generate sound in the chamber 42 having a stomata pore-opening initiating frequency 376 of about 500 Hz during a pore-opening initiating phase causing pores 372 of stomata 374 of the foliage 46 of plant 44 in chamber 42 to begin to open by increasing in size, e.g., increasing in width and/or length, and thereby increasing in the opening area of the pore, from slit-shaped substantially closed, e.g., completely closed, pore 372″ as depicted in FIG. 14 that is no more than 10% open by having a pore opening area of no more than 10% of fully open pore 372, preferably no more than about 5% open by having a pore opening area of no more than 5% of fully open pore 372, increases in frequency to an intermediate stomata pore-opening frequency 378 of about 3000 Hz that further opens and increases the size of the pores 372′ of the foliage 46 to an intermediate generally oval shape where the oval-shaped pores 372′ are about 50% open (have a pore opening area of about 50% of a fully open pore 372), preferably between 40% and 60% open (have a pore opening area of between 40%-60% of a fully open pore 372), like the pores 372′ depicted in FIG. 15, and finally further increases in frequency until the frequency reaches a stomata pore substantially completely open, e.g., fully open, pore-opening frequency 380 of about 6000 Hz that causes substantially all of the pores 372 to become substantially completely open, e.g., fully open, to about 100% open, preferably at least 90% open (have a pore opening area of at least about 90% of a fully open pore 372), like the pores 372 depicted in FIG. 16. During the stomata pore opening acoustical stimulation cycle, the controller 368 preferably is configured to cause sound to be emitted from the transducers 350 at each frequency at a sound pressure level of at least 50 dB, preferably at least about 70 dB and no greater than 110 dB, preferably no greater than about 100 dB sufficient to cause the pores 372 of the stomata 374 of plant 44 to open. While the controller 368 can be configured to generally linearly increase the frequency of the sound used to acoustically stimulate plant 44 over time from the stomata pore-opening initiating frequency 376 of about 500 Hz to the fully open pore-opening frequency 380 of about 6000 Hz, the controller 368 preferably is configured to stepwise increase the frequency by stepping the frequency from the stomata pore-opening initiating frequency 376 of about 500 Hz to the fully open pore-opening frequency 380 of about 6000 Hz using at least a plurality of pairs of frequency steps that increase the frequency at least 100 Hz, preferably at least 250 Hz, and more preferably at least 500 Hz during each step.

In one embodiment and method implementation of feeding cycle acoustical stimulation, after fully opening the stomata pores 372 of the plant 44 until its feeding cycle is substantially completed such that least 80% of the feeding cycle is completed and preferably about 100% completed, stomata pore opening acoustical stimulation is continued at a frequency greater than the stomata pore-opening initiating frequency 376 of about 500 Hz and preferably at the fully open pore-opening frequency 380 of about 6000 Hz to keep the pores 372 open enough for nutrients in the liquid fertilizer from the droplets 236, 236′, 236″ wetting leaf 69 to be taken up by the pores 372. In one such embodiment and method implementation of feeding cycle acoustical stimulation, the frequency of the sound outputted during stomata pore opening acoustical stimulation is at a frequency of at least the intermediate stomata pore-opening frequency 378 of about 3000 Hz, preferably is between the intermediate pore-opening frequency 378 of about 3000 Hz and the fully open frequency 380 of about 6000 Hz, and preferably is maintained at the fully open frequency 380 of about 6000 Hz until the feeding cycle is competed or substantially completed.

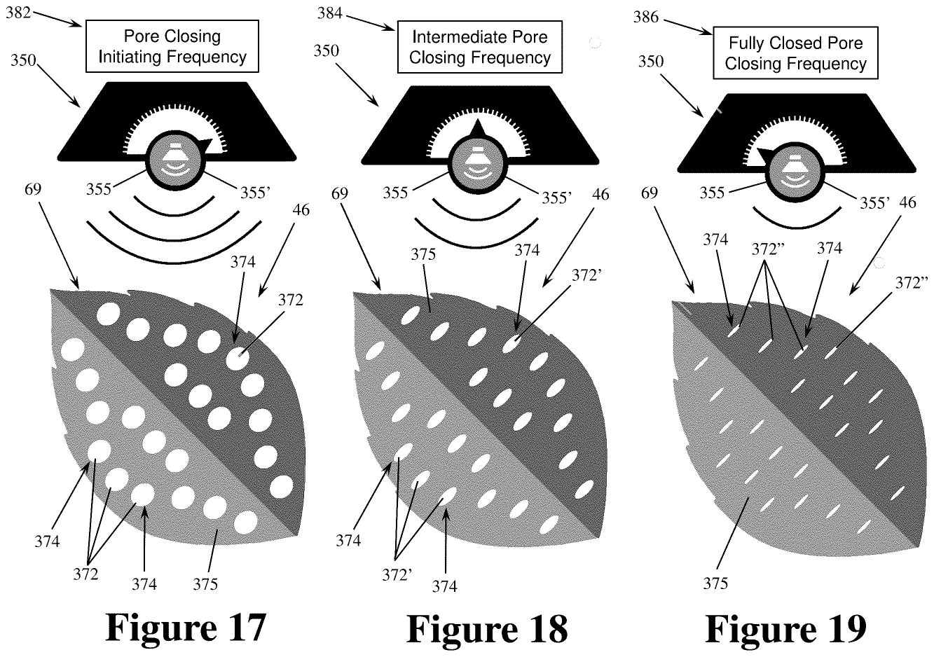

When the feeding cycle is completed or nearing at least 80% completion, a stomata pore closing acoustical stimulation cycle in accordance with the present invention can be performed to close the stomata 374 of plant 44 by closing the pores 372 of the stomata 374 of plant 44. In carrying out a stomata pore closing acoustical stimulation cycle, the controller 368 can be and preferably is configured to controllably operate the transducers 350 to generate sound in the chamber 42 having a stomata pore-closing initiating frequency 382 having a sound pressure level configured to begin closing the fully open pores 372 outputted at this frequency and sound pressure level until the fully open pores 372 depicted in FIG. 17 reduce in size to at least as small as the slit-sized substantially completely closed pores 372″ depicted in FIG. 19 and which reduce in size by reducing their width and/or length to have a size or surface area of less than 15% of the size of substantially completely or fully open pore 372, which preferably have a size of less than 10% of the size of fully open pore 372, and which more preferably have a size of less than about 5% of the size of fully open pore 372. In one embodiment and method of performing a stomata pore closing acoustical stimulation cycle, the controller 368 can be and preferably is configured to controllably operate the transducers 350 (a) during a stomata pore closing initiating phase to generate sound in the chamber 42 having a pore-closing initiating frequency 382 at a first frequency and having a sound pressure level configured to begin closing the fully open pores 372, (b) during an intermediate stomata pore closing phase to generate sound in the chamber 42 having an intermediate stomata pore-closing frequency 384 at a second frequency different from the first frequency and having a sound pressure level configured to further the close the stomata pores 372′ so they have a size less than about 50% than the size of the fully open pores 372 (preferably between 40% and 60% the size of fully open pore 372), and (c) during a final stomata pore closing phase to generate sound in the chamber 42 having a substantially completely closed or fully closed stomata pore-closing frequency 386 at a third frequency different from the first and second frequencies 382, 384 and having a sound pressure level configured to substantially completely close the stomata pores 372″ so pores 372″ have a size of no greater than 15%, preferably less 10%, and more preferably less than about 5%, of the size of the same pore when it was a fully open pore 372. In one embodiment and method implementation, the controller 368 is configured to begin the stomata pore closing acoustical stimulation cycle by decreasing the frequency of the acoustical plant stimulating sound from about 6000 Hz to a pore-closing initiating frequency 382 of less than 6000 Hz to begin closing of the stomata pores from their fully open pores 372 shown in FIG. 17 until the frequency reaches a fully closed pore-closing frequency 386 of no more than about 500 Hz that causes the pores to substantially completely close to at least as small as the slit-shaped pores 372″ shown in FIG. 19 to a size no greater than 15%, preferably no greater than 10%, and more preferably no greater than about 5% of their prior corresponding fully open pore size. In one such embodiment and method implementation, the controller 368 is configured to controllably (a) begin the stomata pore closing acoustical stimulation cycle by decreasing the frequency of the acoustical plant stimulating sound from about 6000 Hz to a pore-closing initiating frequency 382 of less than 6000 Hz to begin closing of the stomata pores from the substantially completely or fully open pores 372 shown in FIG. 17, (b) reduce the frequency from the pore-closing initiating frequency 382 until the frequency reaches an intermediate pore-closing frequency 384 of less than about 3000 Hz where the pores are oval-shaped pores 372′ like those shown in FIG. 18 which have an intermediate size less than about 50%, preferably between 40%-60%, compared to when they were fully open, and (c) reduce the frequency from the intermediate pore-closing frequency 384 until the frequency reaches the substantially completely or fully closed pore-closing frequency 386 of no more than about 500 Hz that causes the pores 372″ to substantially completely close to a size no greater than 15%, preferably no greater than 10%, and more preferably no greater than about 5% of their prior corresponding size when they were substantially completely open, e.g., fully open, pores 372.

In another preferred embodiment and method of acoustically stimulating plant stomata during plant feeding, during acoustical stimulation with sound from transducers 350, the substantially completely closed slit-shaped pores 372″ of stomata 374 of a representative leaf 69 of foliage 46 of plant 44 in chamber 42 begin to open. Where completely closed, the completely closed pores at least initially open to become at least slit-shaped, like the slit-shaped pores 372″ shown in FIG. 14, when acoustically stimulated at a desired stomata pore-opening frequency 376 of at least about 500 Hz, which preferably is no more than 1000 Hz, and which more preferably is no more than about 750 Hz. In one embodiment and method implementation, to initiate opening of the pores 372″ of the stomata 374 of each plant 44 in the chamber 42, the foliage 46 of each plant 44 in the chamber 42 is acoustically stimulated with sound at a desired aforementioned stomata pore-opening frequency 376 at a desired sound pressure level of at least 50 dB, preferably at least 70 dB, and which is no greater than 110 dB, preferably no greater than about 100 dB, for an initial pore opening period of time of at least five seconds, preferably at least 15 seconds and more preferably at least about 30 seconds to initiate opening of the pores 372″ causing them to open to a size that is at least 5% open, preferably at least 10% open, and more preferably at least about 15% open compared to when fully open like the substantially completely open pores 372 depicted in FIG. 16. In such an embodiment and method implementation, each plant 44 in chamber 42 is acoustically stimulated by sound having a desired aforementioned sound pressure level and a desired aforementioned stomata pore-opening frequency 376 during an initial pore opening period of time of no longer than 60 seconds, preferably no longer than about 50 seconds, and more preferably no longer than about 40 seconds to initiate opening of the pores 372″ causing them to open to a size that is at least 5% open, preferably at least 10% open, and more preferably at least 15% open compared to when fully open like the pores 372 depicted in FIG. 16. In another embodiment and method implementation, the foliage 46 of the plant 44 in the chamber 42 is acoustically stimulated with sound at a desired aforementioned stomata pore-opening frequency 376 at a desired aforementioned sound pressure level for an initial period of time of at least 60 seconds, preferably at least about 90 seconds, and more preferably at least about 2 minutes and for no longer than 10 minutes, preferably no longer than 6 minutes, and more preferably no longer than about 5 minutes to initiate opening of the pores 372″ causing them to open to a size that is at least 10% open, preferably at least 15% open, and more preferably at least 25% open compared to when fully open like the pores 372 depicted in FIG. 16.

Continued acoustical stimulation of the plant 44 after the stomata pore opening phase preferably causes the stomata pores 372′ of the representative leaf 69 of the foliage 46 of plant 44 to enter an intermediate pore opening phase where the stomata pores of representative leaf 69 increase in size from the slit-shaped pores 372″ shown in FIG. 14 to become larger, like the oval-shaped pores 372′ in FIG. 15, which are at least 40% open, preferably at least about 50% or at least about half open and preferably no more than 60%, when compared to the same pores 372 when fully open in FIG. 16. With continued reference to FIG. 15, acoustical stimulation during this intermediate pore opening phase preferably is done with increased frequency sound waves preferably having an intermediate pore-opening frequency 378 of at least 2000 Hz and preferably no more than 4000 Hz, more preferably at least about 2500 Hz and no more than about 3500 Hz, and even more preferably about 3000 Hz±250 Hz at a sound pressure level of at least 50 dB, preferably at least 70 dB, and which is no greater than 110 dB, preferably no greater than about 100 dB for a sufficient period of time during the intermediate pore opening phase to acoustically stimulate the guard cells of the stomata 374 of the foliage 46 of each plant 44 in the chamber 42 to further open their respective stomata pores 372′ to have an intermediately sized opening of between 40% and 60% of a fully open stomata pore 372 (FIG. 16) and which preferably has an oval-shaped pore 372 having an intermediately sized opening that is about 50%±15% of the size of the same pore 374 when it is fully open.

In one embodiment and method, after the initial pore-opening phase is completed, the foliage 46 of each plant 44 in chamber 42 is acoustically stimulated with sound at an aforementioned desired intermediate pore-opening frequency 378 at a desired aforementioned sound pressure level for an intermediate pore-opening period of time of at least five seconds, preferably at least 15 seconds, and more preferably at least about 30 seconds. Each plant 44 in chamber 42 is acoustically stimulated for no longer than 60 seconds, preferably for no longer than about 50 seconds, and more preferably for no longer than about 40 seconds for the pores 372′ to intermediately open. In another embodiment and method implementation, the foliage 46 of the plant 44 in the chamber 42 is acoustically stimulated with sound at a desired intermediate pore-opening frequency 378 at a desired aforementioned sound pressure level for an intermediate pore opening period of time of at least 60 seconds, preferably at least about 90 seconds, and more preferably at least about 2 minutes, and for no longer than 10 minutes, preferably no longer than 6 minutes, and more preferably no longer than about 5 minutes for the pores 372′ to intermediately open to at least 35% and more preferably at least 50% and preferably to no more than 65% of their fully open pore size.

Finally, with reference to FIG. 16, the pores 372 of the stomata 374 of the leaf 69 of foliage 46 of plant 44 continue to open and increase in size after carrying out the intermediate pore opening phase from the oval-shaped pores 372′ shown in FIG. 15 when further acoustically stimulated during a fully pore open phase at a stomata pore fully open frequency at a suitable sound pressure level until they substantially completely open as represented by the larger generally round substantially fully open stomata pores 372 of representative leaf 69 shown in FIG. 16. In a preferred embodiment and method, acoustic stimulation of the plant 44 continues, preferably by being acoustically stimulated after the initial pore opening phase and the intermediate pore opening phase during the fully open phase at a stomata pore fully open frequency of at least 5000 Hz and no greater than 7000 Hz, preferably at least 5500 Hz and no greater than 6500 Hz, and more preferably about 6000 Hz±250 Hz at a sound pressure level of at least 50 dB, preferably at least 70 dB, and which is no greater than 110 dB, preferably no greater than about 100 dB for a sufficient period of time during the fully open pore phase to acoustically stimulate the guard cells of the stomata 374 of the foliage 46 of each plant 44 in the chamber 42 to fully open their respective stomata pores 372 so they are at least about 75% open, preferably are at least 85% open, more preferably are at least 90% open, and even more preferably are at least 95% open.

In one embodiment and method, after intermediate initial pore-opening phase is completed, the foliage 46 of each plant 44 in chamber 42 is acoustically stimulated with sound at an aforementioned desired fully open frequency 380 at a desired aforementioned sound pressure level for a pore fully open period of time of at least five seconds, preferably at least 15 seconds, and more preferably at least about 30 seconds and for no longer than 60 seconds, preferably for no longer than about 50 seconds, and more preferably for no longer than about 40 seconds for the pores 372 to substantially completely open by being at least 75% open, preferably at least 85% open, more preferably at least 90% open and even more preferably at least 95% open. In another embodiment and method implementation, the foliage 46 of the plant 44 in the chamber 42 is acoustically stimulated with sound at a desired aforementioned pore fully open frequency 380 at a desired aforementioned sound pressure level for a pore fully open period of time of at least 60 seconds, preferably at least about 90 seconds, and more preferably at least about 2 minutes and for no longer than 10 minutes, preferably no longer than about 6 minutes, and more preferably for no longer than about 5 minutes for the pores 372 to substantially completely open so it is at least 75% open, preferably at least 85% open, more preferably at least 90% open, and even more preferably at least 95% open.

In a further preferred embodiment and method of acoustically stimulating plant stomata during plant feeding, during acoustical stimulation with sound from transducers 350, substantially completely open pores 372 of stomata 374 of the representative leaf 69 of foliage 46 of plant 44 in chamber 42 depicted in FIG. 17 begin to close with the pores 372 becoming smaller, preferably at least 5% smaller, more preferably at least 10% smaller, and even more preferably at least 15% smaller than the fully open pores 372 shown in FIG. 17 when acoustically stimulated at a desired stomata pore closing initiating sound frequency 382 of less than about 6000 Hz, preferably between 6000 Hz and 5400 Hz, and more preferably between about 5900 Hz and about 5500 Hz at a sufficient sound pressure level of at least 50 dB, preferably at least 70 dB, and which is no greater than 110 dB, preferably no greater than about 100 dB to cause fully open pores 372 to begin closing by getting at least 5%, preferably at least 10%, more preferably at least 15% smaller in size than when fully open.

In one embodiment and method implementation, to initiate closing of the pores 372 of the stomata 374 of each plant 44 in the chamber 42, the foliage 46 of each plant 44 in the chamber 42 is acoustically stimulated with sound at a desired aforementioned pore-closing initiating frequency 382 at a desired aforementioned sound pressure level of at least 50 dB, preferably at least 70 dB, and which is no greater than 110 dB, preferably no greater than about 100 dB, for an initial pore closing initiating period of time of at least five seconds, preferably at least 15 seconds and more preferably at least about 30 seconds. In such an embodiment and method implementation, each plant 44 in chamber 42 is acoustically stimulated by sound having an aforementioned desired sound pressure level and a desired aforementioned pore-closing frequency 382 during an initial pore closing initiating period of time of no longer than 60 seconds, preferably no longer than about 50 seconds, and more preferably no longer than about 40 seconds to initiate pore closing to cause the pores to decrease in size, e.g., by decreasing in at least one of width and/or length, at least 5%, preferably at least 10%, and more preferably at least 15% in size compared to fully open pore 372. In another embodiment and method implementation, the foliage 46 of the plant 44 in the chamber 42 is acoustically stimulated with sound at a desired aforementioned pore-closing initiating frequency 382 at a desired aforementioned sound pressure level for an initial pore closing initiating period of time of at least 60 seconds, preferably at least about 90 seconds, and more preferably at least about 2 minutes and for no longer than 10 minutes, preferably no longer than 6 minutes, and more preferably no longer than about 5 minutes to decrease in size at least 15%, preferably at least 25%, and more preferably at least 35% in size compared to a fully open pore 372.

Continued pore-closing acoustical stimulation of the plant 44 after the stomata pore closing initiating phase preferably causes the stomata pores 372 of the representative leaf 69 of the foliage 46 of plant 44 to enter an intermediate pore closing phase where the stomata pores of representative leaf 69 are stimulated at an intermediate pore-closing frequency 384 at a sufficient sound pressure level that continues to decrease the size of the stomata pores from the fully open pores 372 shown in FIG. 17 to become smaller, like the oval-shaped intermediately sized pores 372′ in FIG. 18, which are no greater than 60% open (have a pore opening area of no greater than 60% compared to when fully open), preferably no greater than about 50% open (have a pore opening area of no greater than 50% compared to when fully open) and more preferably no greater than about 40% open (have a pore opening area of no greater than 50% compared to when fully open) compared to the same pores 372 when fully open in FIG. 17. With continued reference to FIG. 18, acoustical stimulation during this intermediate pore closing phase preferably is done with decreased frequency sound waves preferably having an intermediate pore-closing frequency 384 of between 4000 Hz and 2000 Hz, more preferably between about 3500 Hz and about 2500 Hz, and even more preferably being about 3000 Hz±250 Hz at a sound pressure level of at least 50 dB, preferably at least 70 dB, and which is no greater than 110 dB, preferably no greater than about 100 dB for a sufficient period of time during the intermediate pore closing phase to acoustically stimulate the guard cells of the stomata 374 of the foliage 46 of each plant 44 in the chamber 42 to further intermediately close their respective stomata pores 372′ to have a size between 60% and 40 of a fully open stomata pore 372 (FIG. 17) and which preferably has an oval-shaped pore 372′ like that depicted in FIG. 18 having an opening that is no larger than about 50% +15% of the size (have a pore opening area of no greater than 50%±15% compared to when the pore is fully open) of the same pore 372 when fully open.

In one embodiment and method, after the initial pore closing initiating phase is completed, the foliage 46 of each plant 44 in chamber 42 is acoustically stimulated with sound at a desired aforementioned intermediate stomata pore-closing frequency 384 at a desired aforementioned sound pressure level for an intermediate pore closing period of time of at least five seconds, preferably at least 15 seconds, and more preferably at least about 30 seconds. Each plant 44 in the chamber 42 is acoustically stimulated for no longer than 60 seconds, preferably for no longer than about 50 seconds, and more preferably for no longer than about 40 seconds to intermediately close the pores 372′. In another embodiment and method implementation, the foliage 46 of the plant 44 in the chamber 42 is acoustically stimulated with sound at a desired intermediate stomata pore-closing frequency 384 at a desired aforementioned sound pressure level for an intermediate pore closing period of time of at least 60 seconds, preferably at least about 90 seconds, and more preferably at least about 2 minutes, and for no longer than 10 minutes, preferably no longer than 6 minutes, and more preferably no longer than about 5 minutes to intermediately close the pores 372′.

Finally, with reference to FIG. 19, the pores 372′ of the stomata 374 of the leaf 69 of foliage 46 of plant 44 continue to close and decrease in size after carrying out the intermediate pore closing phase from the oval-shaped pores 372 shown in FIG. 18 when further acoustically stimulated during a substantially completely pore closed phase at a desired substantially completely closed stomata pore-closing frequency 386 at a suitable sound pressure level until they substantially completely close as represented by the relatively small generally slit-sized nearly closed stomata pores 372″ of representative leaf 69 shown in FIG. 19. In a preferred embodiment and method, acoustic stimulation of the plant 44 continues, preferably by being acoustically stimulated after the initial pore closing initiating phase and after the intermediate pore closing phase and during the fully pore closing phase at a fully closed pore-closing frequency 386 of no greater than 2000 Hz, preferably no greater than 1500 Hz, more preferably no greater than about 1000 Hz, and no less than 50 Hz, preferably no less than 100 Hz, and more preferably no less than 150 Hz and which is preferably about 500 Hz±250 Hz at a desired sound pressure level of at least 50 dB, preferably at least 70 dB, and which is no greater than 110 dB, preferably no greater than about 100 dB, for a sufficient period of time during the fully closed pore phase to acoustically stimulate the guard cells of the stomata 374 of the foliage 46 of each plant 44 in the chamber 42 to substantially completely close their respective stomata pores 372″ so they are no more than 15% (have a pore opening area of no greater than 15% compared to when fully open), preferably no more than 10% (have a pore opening area of no greater than 10% compared to when fully open), and more preferably no more than 5% (have a pore opening area of no greater than 5% compared to when fully open) of their fully open pore size.

In one embodiment and method, after intermediate initial pore-closing phase is completed, the foliage 46 of each plant 44 in chamber 42 is acoustically stimulated with sound at a desired aforementioned fully closed pore-closing frequency 386 at a desired aforementioned sound pressure level for a pore fully closed period of time of at least five seconds, preferably at least 15 seconds, and more preferably at least about 30 seconds and for no longer than 60 seconds, preferably for no longer than about 50 seconds, and more preferably for no longer than about 40 seconds that results in the pores 372″ being substantially completely closed. In another embodiment and method implementation, the foliage 46 of the plant 44 in the chamber 42 is acoustically stimulated with sound at a desired aforementioned fully closed pore-closing frequency 386 at a desired aforementioned sound pressure level for a pore fully closed period of time of at least 60 seconds, preferably at least about 90 seconds, and more preferably at least about 2 minutes and for no longer than 10 minutes, preferably no longer than about 6 minutes, and more preferably for no longer than about 5 minutes that results in the pores 372 being substantially completely closed by being no more than 15% (have a pore opening area of no greater than 15% compared to when fully open), preferably no more than 10% (have a pore opening area of no greater than 10% compared to when fully open) and preferably no more than 5% (have a pore opening area of no greater than 5% compared to when fully open) of their fully open size.

With continued reference to FIGS. 14-16, in another preferred embodiment and method of acoustically stimulating stomata 374 of foliage 46 of a plant 44, the output of the tone generator 346 is controlled, such as preferably by the controller 368, in a manner that outputs tones or sounds having a frequency ranging from an initial acoustical stimulation frequency that is a stomata pore-opening initiating frequency 376 of about 500 Hz when the pores 372″ of the stomata 374 of plant 44 are substantially completely closed that acoustically stimulates the pores 372 to begin to open as depicted by the slit-shaped pores 372″ in FIG. 14, to an intermediate acoustical stimulation frequency that is an intermediate pore-opening frequency 378 of about 3000 Hz which causes the pores 372′ to further open to an intermediate size as depicted in FIG. 15, and finally to a final acoustical stimulation frequency that is a stomata pore fully open pore-opening frequency 380 of about 6000 Hz which acoustically stimulates the pores 372 to substantially fully open as depicted in FIG. 16. During acoustical stimulation, the sound pressure level of the sound emitted at these frequencies is at least 50 dB, preferably at least 70 dB, and preferably no higher than 110 dB and preferably no higher than 100 dB for optimal acoustical stimulation of the plants 44 in the chamber 42.

In carrying out this preferred embodiment and method implementation, the controller 368 preferably is configured, such as in firmware or software and/or via user input, to cause the transducers 350 to output sound at the initial or stomata pore opening initiating frequency of about 500 Hz at a sound pressure level within the growing atmosphere 48 of at least 50 dB, preferably of at least about 70 dB, and preferably of no more than about 110 dB, sufficient to acoustically stimulate guard cells of the stomata 374 of foliage 46, such as preferably leaf 69, of a plant 44 in the chamber 42 immersed in the sound to cause the pores 372″ of the stomata 374 to begin to open such as to at least the size of the slit-shaped pores 372″ of the stomata 374 of the leaf 69 depicted in FIG. 14 representative of foliage 46 of plant 44. Sound at this frequency is outputted for at least a plurality of pairs of minutes and preferably no more than ten minutes before the frequency of the sound is increased. FIG. 15 depicts the intermediate sized openings of the pores 372′ of the stomata of the leaf when stimulated at an intermediate frequency of about 3000 Hz. Sound at this frequency is outputted for at least a plurality of pairs of minutes and preferably no more than ten minutes before the frequency of the sound is increased. The output of the tone generator 346 is further controlled, such as preferably by the controller 368 being configured in firmware, software and/or via user input, in a manner that outputs tones or sounds increasing in frequency from the initial or stomata pore opening initiating frequency of about 500 Hz while maintaining the sound pressure level to be at least 50 dB, preferably to be at least about 70 dB, and preferably to be no more than about 110 dB until the frequency reaches a final or stomata pore fully open frequency of about 6000 Hz sufficient to acoustically stimulate the guard cells of the stomata 374 of foliage 46, such as preferably leaf 69, of the plant 44 in the chamber 42 immersed in the sound to fully open the pores 372 of the stomata 374, such as is depicted by the fully open round-sized pores 372 of the stomata 374 of the leaf 69 shown in FIG. 16. Sound at this frequency is outputted for at least a plurality of pairs of minutes and preferably no more than ten minutes. While the frequency of the sound outputted by the transducers 350 during acoustical stimulation can be substantially linearly increased over time, the frequency preferably is increased stepwise from about 500 Hz to about 6000 Hz using at least a plurality of pairs of, i.e., at least three, frequency increasing steps where the frequency is increased by at least 250 Hz, preferably at least 500 Hz, during each step until the stomata pore fully open frequency of 6000 Hz is reached when the pores 372 are at least 85% open (have a pore opening area of at least 85% compared to when 100% open), preferably at least 90% open (have a pore opening area of at least 90% compared to when 100% open) and more preferably at least 95% open (have a pore opening area of at least 95% compared to when 100% open).

In another preferred embodiment and acoustical stimulation method, the controller 368 is configured to increase the frequency of the sound outputted by the transducers 350 over time in which the foliage 46 of plants 44 in chamber 42 are substantially completely immersed during a stomata pore opening initiating phase at a stomatal pore-opening initiating frequency 376 of about 500 Hz±250 Hz at a desired sound pressure level of at least 50 dB, preferably at least 70 dB, and which is no greater than 110 dB, preferably no greater than 100 dB for a sufficient period of time that acoustically stimulates the guard cells of the leaves 69 of the foliage 46 of the plants 44 in the chamber 42 to begin to open to open the pores 372″, as depicted by the slit-shaped stomata pores 372″ shown in FIG. 14. The controller 368 is further configured to increase the frequency over time during an intermediate stomata pore opening phase from the stomatal pore-opening frequency 376 to an intermediate pore-opening frequency 378 of at least about 3000 Hz±1000 Hz at the desired sound pressure level of at least 50 dB, preferably at least 70 dB, and which is no greater than 110 dB, preferably no greater than 100 dB for a sufficient period of time that further stimulates the guard cells of the stomata to correspondingly increase the size of the pores 372′ of the stomata 374 of the leaf 69 representative of foliage 46 of plants 44 in the chamber 42 until the pores become oval shaped like the intermediately open oval-shaped pores 372′ shown in FIG. 15 that are at least 40% open (have a pore opening area of at least 40% compared to when 100% open), preferably are at least about 50% open (have a pore opening area of at least 50% compared to when 100% open), and more preferably are between 40% and 60% open (have a pore opening area that is between 40% and 60% of the pore opening area compared to when the same pore is 100% open). The controller 368 is even further configured to increase the frequency over time during a stomata pore fully open phase from the intermediate stomatal pore opening frequency 376 to a stomata pore fully open pore-opening frequency 380 of about 6000 Hz±1500 at the desired sound pressure level of at least 50 dB, preferably at least 70 dB, and which is no greater than 110 dB, preferably no greater than 100 dB for a sufficient period of time that even further stimulates the guard cells of the stomata to additionally correspondingly increase the size of the pores 372′ of the stomata 374 of the leaf 69 representative of foliage 46 of plants 44 in the chamber 42 until the pores become generally circularly shaped like the found substantially completely open pores 372 shown in FIG. 16 that are at least 85% (has a pore opening area that has at least 85% of the pore opening area compared to when the same pore is 100% open), preferably at least 90% (has a pore opening area that has at least 90% of the pore opening area compared to when the same pore is 100% open) and more preferably at least 95% open (has a pore opening area that has at least 95% of the pore opening area compared to when the same pore is 100% open).

In a particularly preferred embodiment and method of performing a variable frequency stomatal opening acoustical stimulation pattern in accordance with the present invention, at least one and preferably all of the plants 44 in the growing chamber 42, the controller 368 preferably is configured such as in software, firmware and/or by user input 370 to control operation of tone generator 346 in a manner that controllably, gradually and preferably linearly increases the frequency of the tone outputted by transducers 350 from a stomata pore-opening frequency 376 of about 500 Hz at a desired sound pressure level of at least 50 dB, preferably at least 70 dB and which is no more than 100 dB, preferably no more than about 100 dB to a fully open frequency 380 of about 6000 Hz over a time period of at least a plurality of minutes, which preferably is a time period of between 5 and 15 minutes, which more preferably is a time period of between 8 and 12 minutes, and which even more preferably is a time period of about 10 minutes±1 minute, before pausing or dwelling at least plurality of minutes, preferably between 2 and 4 minutes, more preferably between 4 and 8 minutes, even more preferably between 8 and 12 minutes, yet even more preferably about 10 minutes±1 minute without the transducers 350 outputting any sound. After the first occurrence of the variable frequency stomatal opening acoustical stimulation pattern is carried out and completed, this variable frequency stomatal opening acoustical stimulation pattern is repeated at least once and preferably is repeated at least a plurality of times in carrying out a preferred embodiment and method of stomatal opening acoustical stimulation in accordance with the present invention. When sound is emitted when performing such a variable frequency stomatal opening acoustical stimulation pattern in accordance with the present invention, the controller 368 and transducers 350 are configured to maintain a sound pressure level within the growing atmosphere 48 at the foliage 46 of the plants 44 in the chamber 42 that is between 50 dB and 110 dB and which preferably does not exceed 115 dB, which preferably is controlled to be between 70 dB and 100 dB, and which more preferably is controlled to be between about 70 dB and about 90 dB.

In a preferred embodiment and method of variable frequency stomatal opening acoustical stimulation of plants 44 in chamber 42, this pattern of variable frequency stomatal opening acoustical stimulation is performed at least a plurality of times per hour during carrying out a feeding cycle of at least one of the plants 44 in the chamber 42 and preferably during the feeding cycles of all of the plants 44 in the chamber 42 to substantially completely open the pores 372 of the stomata 374 of at least the leaves 69 of the foliage 46 of each one of the plants 44 in the chamber 42 to have a pore opening area that is at least 90%, preferably at least 95%, and more preferably at least 95% of the pore opening area compared to when the same pore is 100% open to increase and optimize uptake of fertilizer delivered from the atomizers, preferably charged atomizers, preferably nebulizers, more preferably charged nebulizers in carrying out each one of the feeding cycles of each one of the plants 44. In one such preferred embodiment and method of variable frequency stomatal opening acoustical stimulation in accordance with the present, this pattern of variable frequency stomatal opening acoustical stimulation is performed at 3 times per hour during carrying out a feeding cycle of all of the plants 44 in the chamber 42. Performing variable frequency stomatal opening acoustical stimulation pattern to fully open the pores of the stomata of the foliage of the plant undergoing a feeding cycle advantageously ensures the pores 372 of the stomata are substantially open (have a pore opening area that has at least 85% of the pore opening area compared to when the same pore is 100% open), preferably substantially completely open (have a pore opening area that has at least 90% of the pore opening area compared to when the same pore is 100% open) and more preferably are fully open or 100% open, thereby helping to maximize uptake of fertilizer, preferably surfactant-enhanced fertilizer, delivered in the form nanosized droplets discharged from the nebulizer fertilizer dispenser nozzles of the foliar fertilizer application system of the plant feeding system of the present invention.

When it is desired to close the pores 372 of the stomata 374, the foliage 46, such as depicted by the sizes of the pores 372, 372′ and 372″ of the stomata 374 of the representative leaf 69 in FIGS. 14-19, the frequencies of the tone outputted by the transducers 350 into the growing atmosphere 48 that acoustically stimulates the foliage 46 of plant 44 are controllably decreased, such as linearly, by controller 368 in the opposite direction within the aforementioned frequency range from the stomata pore fully open frequency 380 or pore-closing initiating frequency 382 of about 6000 Hz, where the stomata pores 372 were substantially completely open, to the initial acoustical stimulation pore-opening frequency 376 or substantially completely closed pore-closing frequency 386 of about 500 Hz that causes substantially completely or intermediately open stomata pores 372 and/or 372′ to substantially completely close like pores 372″. The controller 368 can be configured such as in software, firmware and/or by user input to control operation of tone generator 346 to carry out another variable frequency stomatal closing acoustical stimulation pattern in a manner that controllably, gradually and preferably linearly decreases the frequency of the tone outputted by transducers 350 from the fully open frequency 380 of about 6000 Hz to the substantially completely closed pore-closing frequency 386 of about 500 Hz over a period of at least a plurality of minutes, which preferably is about a 10 minute±2½ minute period, before pausing or dwelling at least plurality of minutes, preferably at least 2 minutes, preferably at least 5 minutes and more preferably about 8 minutes±4 minutes with no sound before resuming sound output and performing the variable frequency stomatal closing acoustical stimulation pattern at least a plurality of times, preferably at least a plurality of pairs of times, per hour during carrying out the plant feeding cycle for at least one and preferably each plant 44 in the chamber 42. This variable frequency stomatal closing acoustical stimulation pattern preferably is sequentially performed until the feeding cycles of all of the plants 44 are finished. In a preferred embodiment and method, each one of the plants 44 in the chamber 42 is sequentially fed such that an aforementioned plant feeding cycle like that discussed above in reference to FIGS. 6-11 is performed for each plant 44 in the chamber 42 either substantially simultaneously or preferably sequentially such that each one of the plants 44 is feeding during its feeding cycle with a feeding cycle repeated for each plant 44 until all the plants 44 in the chamber 42 have been fed by preferably being fertilized. When the last feeding cycle for the last plant 44 in the chamber 42 being fed is about 80% completed or has been completed the variable frequency stomatal closing acoustical stimulation pattern, including the aforementioned repetition(s) thereof disclosed hereinabove can be and preferably is performed. When sound is emitted when performing such a variable frequency stomatal closing acoustical stimulation pattern, including repeating the pattern in the manner disclosed hereinabove, in accordance with the present invention, the controller 368 and transducers 350 are further configured to maintain a sound pressure level within the growing atmosphere 48 at the foliage 46 of the plants 44 in the chamber 42 that is between 50 dB and 110 dB and which preferably does not exceed 115 dB, which preferably is controlled to be between 70 dB and 100 dB, and which more preferably is controlled to be between about 70 dB and about 90 dB.

In an alternative embodiment and method, when the last feeding cycle for the last plant 44 in the chamber 42 being fed is about 80% completed or has been completed, stomatal pore closing acoustical stimulation can instead be performed by carrying out one of the aforementioned embodiments and methods of acoustically stimulating closing of the pores 372, 372′ and/or 372″ of the stomata 374 of the foliage 46 of each one of the plants 44 in the chamber 42 disclosed above in referring to FIGS. 17-19 preferably is carried out. When sound is emitted when performing such stomatal closing acoustical stimulation in accordance with the present invention, the controller 368 and transducers 350 are also configured to maintain a sound pressure level within the growing atmosphere 48 at the foliage 46 of the plants 44 in the chamber 42 that is between 50 dB and 110 dB and which preferably does not exceed 115 dB, which preferably is controlled to be between 70 dB and 100 dB, and which more preferably is controlled to be between about 70 dB and about 90 dB.

With reference once again to FIG. 12, in a preferred embodiment of an acoustical plant stimulation system 60 of the present invention, the system 60 can and preferably does include a plant root stimulation system 362 that preferably is a hydro-acoustic root stimulation system that employs at least one and preferably a bank 365 of a plurality of spaced apart hydro-acoustic sound transducers 364 that are each configured to generate acoustic pressure waves in the liquid growing medium 52 having a predetermined desired frequency or frequencies, e.g., predetermined maximum frequency or frequencies, such as discussed in more detail below, and which can fall within a predetermined desired frequency range, which stimulate the roots 50 of each one of the plants 44 in a manner that causes or increases uptake of oxygen and/or fertilizer in the growing medium 52 by the roots 50 of each plant 44 in growing chamber 42. The growing medium 52 preferably is an aqueous liquid growing medium and which more preferably is a water-containing hydroponics liquid growing medium in which the roots 50 of each plant 44 in chamber 42 are at least partially immersed or submerged and which preferably substantially are completely immersed or submerged during hydro-acoustic stimulation of roots 50 of each plant 44 during operation of the root stimulation system 362 of the present invention. Acoustic stimulation of the roots 50 and/or root system 55 of plants 44 in chamber 42 advantageously increases one of plant growth, yield, yield volume, yield mass, or the like including by increasing uptake of nutrients and/or other plant-affecting constituents as well as preferably also oxygen by the roots 50 of plants 44 during growing of plants 44 in chamber 42.

In a preferred embodiment, each one of the hydro-acoustic transducers 364 is an underwater sound projector 366, such as in the form of a hydro-coupling transducer 366′, which acoustically couples with liquid growing medium 52 in the growing medium holding compartment 190 of the enclosure 180 of the growing chamber 42 and oscillates at frequencies which generates acoustic pressure waves in the growing medium 52 at frequencies of at least a plurality of hertz that stimulate the roots 50 of the plants 44 being grown in the chamber 42 that hydro-acoustically stimulates roots 50 immersed in the growing medium 52 to (a) start taking up (i) oxygen in the growing medium and/or (ii) fertilizer in the growing medium 52, or (b) increase a rate of uptake of (i) oxygen in the growing medium 52, and/or (ii) fertilizer in the growing medium 52 compared to the same type, variety and strain of plants grown in a conventional hydroponic growing system without hyperoxygenating the hydroponic growing medium and also compared to the same type, variety and strain of plants grown conventionally in soil. With continued reference to FIG. 12, each one of the hydro-acoustic transducers 364 is disposed in operable cooperation with the bottom wall 186 of the enclosure 180 of the chamber 42, such as by being mounted to the bottom wall 186, in a manner that hydro-acoustically couples the transducer 364 with liquid growing medium 52 in the chamber 42 such that operation of each transducer 364 generates pressure waves in the growing medium 52 that preferably are acoustic waves in the growing medium 52. In one embodiment, at least the portion of each one of the hydro-acoustic transducers 364 that oscillates during operation of the root stimulation system 362 is disposed in sufficient direct contact with the growing medium 52 to cause hydro-acoustic coupling therebetween such that oscillation generates pressure or sound waves in the growing medium having a desired predetermined frequency or frequencies in accordance with that discussed in more detail below which are of a sufficient amplitude that they travel through the growing medium 52 to the roots 50 of each plant 44 in the chamber 42 acoustically stimulating the roots 50 to uptake oxygen and/or fertilizer from the growing medium 52 or increase root uptake of oxygen and/or fertilizer from the growing medium 52. In one such embodiment, each transducer 364 is mounted to enclosure wall 186 such as in the manner depicted in FIG. 12 with an opening (not shown) formed in the wall 186 in communication with the transducer 364 causing the transducer 364 to directly contact and hydro-acoustically couple with growing medium 52 in the chamber 42 in a manner that efficiently generates sound waves in the form of pressure waves in the growing medium 52 during operation of the root stimulation system 362 of the present invention. Although not shown in FIG. 12, in another such embodiment, one or more or even all of the transducers 364 can be disposed within the chamber 42 in direct contact with the growing medium 52, such as by being partially or completely immersed or submerged in growing medium 52 in direct contact with the growing medium 52 hydro-acoustically coupling each transducer 364 with growing medium 52 in which the roots 50 of each plant 44 are immersed or submerged such that oscillation of the transducer 364 during operation of the plant root system stimulation system 362 generates sound waves in the form of pressure waves in the liquid growing medium 52 configured to stimulate the roots 50 and/or root system 55 of each plant 44 in the chamber 42 in a manner that advantageously increases plant growth and/or yield including by increasing root uptake of oxygen, nutrients and/or other constituents in the growing medium 52. In at least one preferred embodiment and method of acoustically stimulating roots 50 of plant 44, the chamber 42 employs a plant root system stimulation system 362 having at least one hydro-acoustic sound emitting bank 365 composed of at least a plurality, preferably at least a plurality of pairs of, i.e., at least three, spaced apart hydro-acoustic transducers 364 which are electrically driven to induce acoustic sound waves in the growing medium 52 at a frequency of no more than about 2 Hz, preferably no more than about 5 Hz, more preferably no more than about 50 Hz, even more preferably no more than 100 Hz, still even preferably no more than 250 Hz, and yet even more preferably no more than 1000 Hz, configured to stimulate the roots 50 and root system 55 of each plant 44.

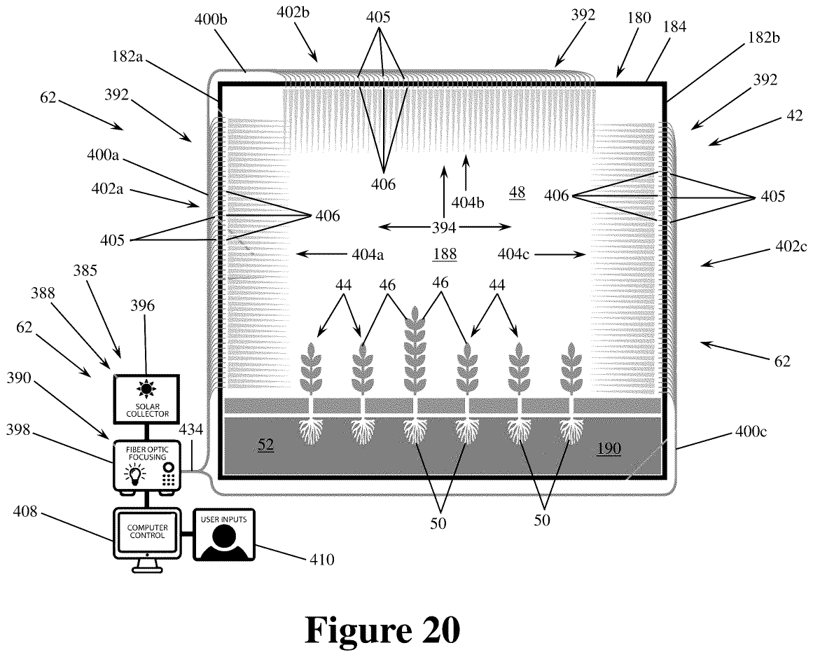

FIG. 20 illustrates a preferred but exemplary embodiment of a plant lighting system 62 of the present invention equipped with a light engine 385 that provides a source 388 of light in communication with a light receiving and distribution arrangement 390 that receives the light and communicates it to a light emitting arrangement 392 in operable cooperation with the growing chamber 42 which is configured to deliver light 394 to the chamber 42 in a manner which substantially uniformly irradiates the foliage 46 of all of the plants 44 in the chamber 42 with light for photosynthesis. The lighting system 62 is configured to deliver light 394 having wavelengths desired for optimal photosynthesis and which preferably at least lacks any UV wavelengths. In a preferred plant lighting system embodiment and lighting method, lighting system 62 can be further configured to deliver light 394 lacking IR wavelengths including either or both near IR wavelengths and/or far IR wavelengths.

In the preferred embodiment depicted in FIG. 20, the light source 388 preferably is or includes the sun, e.g., sunlight 426, and which also includes a solar collector 396 disposed outside of the chamber 42 that is configured to collect sunlight 426 and deliver it to the light receiving and distribution arrangement 390, which is or includes a light gathering and/or focusing arrangement that preferably is or includes a fiber optic focusing device 398 configured to distribute collected sunlight through fiber optic cable bundles 400a, 400b, 400c to at least a plurality of, preferably at least a plurality of pairs of, i.e., at least three, banks 402a, 402b, 402c of light emitting arrays 404a, 404b, 404c each composed of at least a plurality of pairs of, i.e., at least three, light emitters 406 in communication with a fiber optic cable 405 and which is configured to emit light into the growing atmosphere 48 of the chamber 42 to irradiate the foliage 46 of each one of the plants 44 in the chamber 42. The light emitting arrangement 392 preferably includes spaced apart light emitters 406 each disposed at the end of a fiber optic cable 405 and/or connected to the end of the fiber optic cable 405 of a corresponding fiber optic cable bundle 400a, 400b, 400c whose fiber optic cables 405 are in communication at or adjacent their opposite ends with a light distribution arrangement 390 which receives light, such as preferably sunlight 426, from light source 388, such as preferably the sun.

Although FIG. 20 illustrates banks 402a, 402b, 402c of arrays 404a, 404b, 404c of emitters 406 carried respectively by the growing chamber enclosure walls 182a, 182b and top wall 184, the lighting system 62 can and preferably does also include banks of arrays of emitters 406 not shown in the drawings which are carried by front and rear walls 182c and 182c of the enclosure 180 helping to ensure light irradiates the foliage 46 of the plants 44 from all sides and above. This unidirectional lighting arrangement preferably is configured to provide 360° irradiation of all sides of the foliage 46 of a plant 44 when there is only a single plant 44 in the chamber 42 and substantially uniform irradiation of at least two sides of the foliage 46 of each plant 44 when there is a plurality or more plants 44 in the chamber 42. In a preferred embodiment, the emitters 406 of each array 404a, 404b, 404c of each enclosure sidewall 182a, 182b are preferably disposed at respective ends of the fiber optic cables 405 of the respective bundles 400a, 400b, 400c and which are respectively arranged substantially along the entire surface of corresponding sidewalls 182 a, 182 b at a density of at least 25 emitters 406 and 24 strands of fiber optic cables 405 per square centimeter of sidewall surface area to ensure more uniform irradiation of the plant foliage 46.

As discussed in more detail below, the lighting system 62 preferably includes a controller 408 configured in firmware and/or software as well as via user input 410 to control operation of the system 62, including delivery of light 394 to the plants 44 being grown in chamber 42 during the various plant growth stages. In a preferred embodiment and method, the controller 408 can be configured to selectively deliver light 394 having different wavelengths or wavelengths to irradiate foliage 46 of the plants 44 depending on the stage of growth of the plants 44.

Where the light source 388 is or includes sunlight, at least one of the collector 396, the light gathering and/or focusing such as fiber optic focusing device 398, banks 402a, 402b, 402c, arrays 404a, 404b, 404c, and/or emitters 406 is configured to at least selectively filter UV light from the collected sunlight so the light 394 delivered to the plants 44 in the chamber 42 during at least one or more of the plants' stages of growth is lacking in UV wavelengths to minimize and substantially completely prevent UV damage to the plants 44. In one lighting system embodiment and method of providing light to plants 44, at least one of the collector 396, the light gathering and/or focusing such as fiber optic focusing device 398, banks 402a, 402b, 402c, arrays 404a, 404b, 404c and/or emitters 406 is configured to selectively filter IR from the sunlight, such as by filtering either far IR, near IR, or both near and far IR, delivering light 394 to the plants 44 that is lacking in either far IR, near IR, or both near and far IR wavelengths during one or more of the plants' stages of growth. In another lighting system embodiment and plant lighting method, at least one of the collector 396, the light gathering and/or focusing such as fiber optic focusing device 398, banks 402a, 402b, 402c, arrays 404a, 404b, 404c and/or emitters 406 is configured to selectively filter UV light and IR light from the sunlight delivering light 394 to irradiate foliage 46 of the plants 44 in the visible light spectrum which not only lacks UV wavelengths but also either far IR, near IR, or both near and far IR.

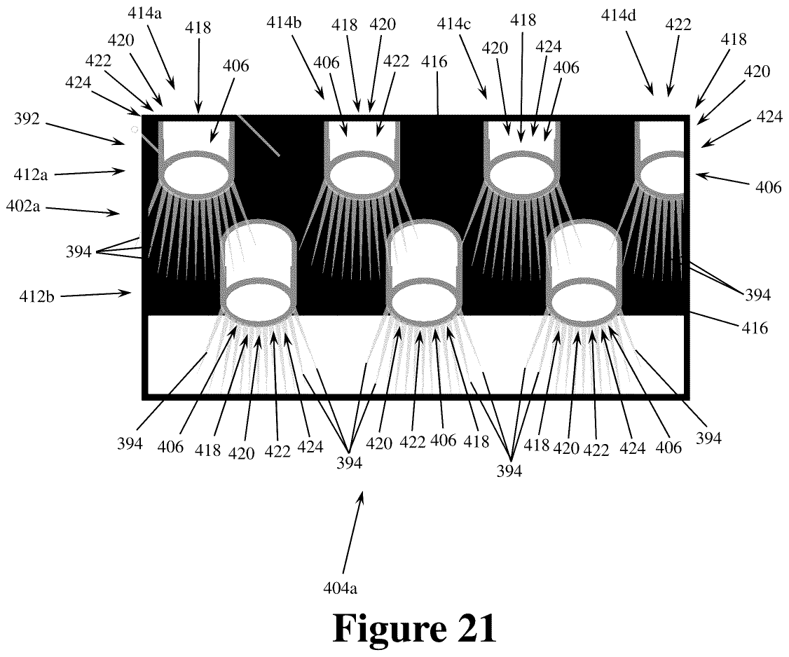

FIG. 21 is a fragmentary view of a portion of one of the arrays 404a of one of the banks 402a of light emitters 406 having at least a plurality, preferably at least a plurality of pairs, i.e., at least three, of rows 412a, 412b, and at least a plurality, preferably at least a plurality of pairs, i.e., at least three, of staggered columns 414a, 414b, 414c, 414d of spaced apart light emitters 406 anchored to a panel 416, e.g., a substantially rigid light panel, carried by, e.g., mounted to, a corresponding one of the enclosure walls 182a, 182b, 182c, 182d and/or 184 with light 394 being emitted from each one of the emitters 406 during operation of lighting system 62 that irradiates foliage 46 of each plant 44 in the chamber 42 for plant photosynthesis. While the emitters 406 can be disposed within the chamber 42 such that light emitted therefrom can directly irradiate the foliage 46 of the plants 44 in the chamber 42, the emitters 406 can be disposed on a side of a corresponding adjacent light transmissible wall 182a, 182b, 182c, 182d and/or 184 opposite the plants 44 such that light emitted from each emitter 406 passes through corresponding wall 182a, 182b, 182c, 182d and/or 184 before reaching foliage 46 of plants 44. The emitters 406 of the portion of the array 404a shown in FIG. 21 can be and preferably are formed by, at or of the ends of fiber optic cables 405 of bundle 400a and are arranged substantially along the surface of corresponding sidewall 182 a at a density of at least 25 emitters 406 and 24 strands of fiber optic cables 405 per square centimeter of sidewall surface area to ensure more uniform irradiation of the plant foliage 46.

While at least the portion of each wall 182a, 182b, 182c, 182d and/or 184 through which light from each emitter 406 passes can be optically transparent, e.g., made of an optically transparent material like glass, each wall 182a, 182b, 182c, 182d and/or 184 through which light from each emitter 406 passes can include or be composed of a selective light transmissible material which can include or be composed of a light wavelength filtering material configured to selectively filter certain desired or predetermined wavelengths of light emitted from each emitter 406 such that the light 394 irradiating foliage 46 of the plants 44 contains fewer wavelengths than the light exiting the emitters 406. In a preferred embodiment where light exiting the emitters 406 passes through a corresponding selectively light transmissible wall 182a, 182b, 182c, 182d and/or 184, the wall 182a, 182b, 182c, 182d and/or 184 can include a layer of a selectively light transmissible material, such as preferably an acrylic, or be substantially completely composed of such a selective light transmissible material, such as preferably an acrylic, configured to selectively filter at least UV wavelengths from light emitted from emitters 406 such that the light 394 irradiating the foliage 46 of plants 44 in chamber 42 is free of any UV wavelengths. In one such preferred embodiment, wall 182a, 182b, 182c, 182d and/or 184 can include or further include a layer of selective light transmissible material, such as preferably an acrylic, configured to further selectively filter IR such as either or both near IR and/or far IR, from the light from emitters 406 before reaching the plants 44 in chamber 42 such that the light 394 exiting selective light transmissible wall 182a, 182b, 182c, 182d and/or 184 that actually irradiates the plant foliage 46 contains visible light wavelengths, lacks UV, and preferably also lacks either or both near IR and/or far IR light. In another such preferred embodiment, each wall 182a, 182b, 182c, 182d and/or 184 is substantially completely composed of a selective light transmissible material that preferably is an acrylic that selectively filters IR, such as by selectively filtering either or both near IR light and/or far IR light as well as UV light from the light from emitters 406 that passes through wall 182a, 182b, 182c, 182d and/or 184 produces selectively wavelength filtered light 394 that irradiates plants 44 in the chamber 42 that contains visible light, lacks UV light, and also lacks either or both near IR and/or far IR light.

Where light emitted from the emitters 406 passes through at least a light-transmissible portion of a corresponding wall 182a, 182b, 182c, 182d and/or 184 of the enclosure 180 of the chamber 42 before irradiating foliage 46 of the plants 44 in the chamber 42, each emitter 406 can simply be the free end of a corresponding fiber optical cable 405 of corresponding fiber optic cable bundle 400a, 400b, 400c such that light is emitted directly from the free end. The opposite end of the fiber optic cable 405 of each emitter 406 in in light transmissible communication with, such as by being connected to, light distribution arrangement 390 as discussed above, to receive light, e.g., sunlight, from source 388.

In one embodiment and plant lighting method depicted in FIG. 20, the emitters 406 of each one of the arrays 404a, 404b, 404c is disposed on one side, the exterior side, of the walls 182a, 182b, and 184 of the enclosure 180 of the chamber 42 and the plants 44 are disposed on the other side, the interior side, of the walls 182a, 182b, and 184 such that light emitted from emitters 406 of each one of the arrays 404a, 404b, 404c during plant lighting system operation passes through corresponding wall 182a, 182b, and 184 exiting therefrom as the light 394 that irradiates the plants 44 for photosynthesis. In this embodiment and plant lighting method, the walls 182a, 182b, and 184 of the enclosure 180 of the chamber 42 are made of a selectively light transmitting material that preferably is acrylic or which includes a layer of selectively light transmitting material that is acrylic which is configured to at least filter UV from the light emitted from the emitters 406 of each one of the arrays 404a, 404b, 404c passing through the walls 182a, 182b, and 184 so the light 394 exiting the walls 182a, 182b, and 184 that irradiates the plants 44 contains visible light, such as visible light having wavelengths of between about 400 and about 700 nm, preferably between 380 and 750 nm, but contains virtually no UV. In one such preferred embodiment and method, the walls 182a, 182b, and 184 of the enclosure 180 of the chamber 42 are made of a selectively light transmitting material that preferably is acrylic or which includes a layer of selectively light transmitting material that is acrylic which is further configured to also block IR, preferably at least block far IR, e.g., infrared light having wavelengths ranging between about 15 μm and 1 millimeters, such that the light 394 exiting the walls 182a, 182b, and 184 that irradiates the plants 44 contains only visible light, such as visible light having wavelengths of between about 400 and about 700 nm, preferably between 380 and 750 nm.

FIG. 22 is a diagram depicting a preferred embodiment of a light engine 385 of the present invention that utilizes a solar collector 388 to gather natural unfiltered sunlight 426 from the sun and focus the gathered light 425 onto light-receiving ends 430 of at least a plurality of pairs of, i.e., at least three, elongate fiber optic cables 432 arranged in a master fiber optic cable bundle 434 that communicates the light to the growing chamber 42 where it irradiates the plants 44 in the chamber 42. With reference once again to FIG. 20, the mater fiber optic cable bundle 434 splits into at least three different fiber optic bundles 400a, 400b, 400c that respectively transmit the light 425 to corresponding arrays 404a, 404b, 404c of light emitters 406 from which light is outputted which ultimately irradiates the plants 44 in the chamber 42.

The collector 388 has a lens arrangement 435 that is or includes a light gathering lens 436 that preferably is a Fresnel lens 437, e.g., Fresnel lens concentrator, which helps to gather, concentrate and direct the sunlight 426 into a focusing unit 438 of the collector 388 having a smaller area than the Fresnel lens 437. The focusing unit 438 is configured to focus rays of the gathered light 425 onto corresponding light-receiving ends 430 of each one of the fiber optic cables 432 of the fiber optic cable bundle 434 for efficient light coupling therewith. If desired, each light-receiving end 430 a coupler and/or lens, such as a microlenses or graded-index (GRIN) lens can be disposed between each light-receiving end 430 and the lens arrangement 435 to focus the rays of light 426 received therefrom into the core of the corresponding fiber optic cable 432 having the light-receiving end 430 to increase the efficiency of light transmission through the fiber optic cables 432 of bundle 434.

The lens arrangement 435 can and preferably does include a light filtering arrangement 439 in the form of a selective light wavelength filter 440 configured to at least filter UV from the sunlight 426 to deliver gathered light 425 that preferably is filtered light 428 containing light that includes visible light and which lacks UV. In one preferred embodiment, the light gathering lens 436 preferably is a Fresnel lens 437 composed of a light filtering material that preferably is made of a UV filtering material such that the light gathering lens 436, preferably Fresnel lens 437, is configured with a light wavelength filter 440 is integral with lens 436, preferably Fresnel lens 437. In one such preferred embodiment, the lens 436, preferably Fresnel lens 437, is composed of a light-filtering acrylic, preferably a UV blocking acrylic, which preferably is configured to at least filter and substantially completely block UV in the sunlight 426 producing filtered light 428 substantially lacking in light having wavelengths less than about 400 nm, preferably less than 380 nm, and which fall within the UV spectrum. The light-filtering acrylic, preferably an UV blocking acrylic, of lens 436, preferably Fresnel lens 437, is configured to allow visible light having wavelengths ranging between about 400 nm and about 700 nm, preferably between 380 nm and 750 nm, to pass through such that (a) the filtered light 428 reaching the light-receiving fiber optic cable ends 430 has wavelengths ranging between about 400 nm and about 700 nm, preferably between 380 nm and 750 nm, and (b) the light 394 irradiating the plants 44 thereby also has wavelengths ranging between about 400 nm and about 700 nm, preferably between 380 nm and 750 nm. The light-filtering acrylic, preferably UV blocking acrylic, of lens 436, preferably Fresnel lens 437, preferably is configured to allow at least some near IR having wavelengths of greater than about 700 nm and less than about 3000 nm to pass through with the acrylic absorbing and therefore substantially completely blocking far IR having wavelengths greater than 3000 nm. The result is that such an acrylic lens 436, preferably Fresnel lens 437 block UV and allows light having between about 400 nm and about 3000 nm to pass through producing filtered light 428 having these wavelengths emitted into chamber 42 as light 394 which irradiates the plants 44 for photosynthesis.

In another embodiment, the light wavelength filter 440 can be separate from the light gathering lens 436, is disposed in line with the lens 436, and can either overlie or underlie lens 436, such as by being disposed alongside the lens 436, e.g., held against the lens 436, using a lens mounting arrangement 442. The mounting arrangement 442 is depicted in FIG. 22 mounting the light gathering lens 436 and light wavelength filter 440 to the focusing unit 438.

While the separate light wavelength filter 440 can also be composed of light filtering acrylic, such as an UV filtering acrylic having the same light transmission wavelengths as disclosed above in the preceding paragraph, it can instead be or include an electronically controllable light wavelength filter that can be an electronically controllable light wavelength bandpass filter operatively electronically connected to controller 408 which is configured in software and/or firmware and/or via user input 410 to selectively control what wavelengths from the sunlight 426 are outputted as filtered light 428 to the light-receiving fiber optic cable ends 430 for delivery into the chamber 42 as plant-irradiating light 394. Where a light wavelength filter 440 is used that is an electronically controllable filter 440, the electronically controlled light wavelength filter 440 can be or include (1) an acousto-optic tunable filter (AOTF), (2) a liquid crystal tunable filter (LCTF), (3) an electrochromic filter, (4) an interferometer-type filter, e.g., Fabry-Pérot Interferometer (FPI), and/or (5) a graphene-based optical filter.

During operation of a lighting system 62 equipped with an electronically controllable wavelength filter 440, such as one or more of (1)-(5) listed above in the preceding paragraph, the controller 408 and/or user 410 control operation of the filter 440 through application of one or more of control signals, voltages or the like to the filter 440 to cause the filter 440 to selectively filter wavelengths from the sunlight 426 and/or selectively permit passage of only one or more specific bands or ranges of wavelengths in the sunlight 426 to produce filtered light 428 that is transmitted as plant-irradiating light 394 advantageously having specific desired wavelengths, a specific desirable range of wavelengths, or a plurality of specific ranges of wavelengths tailored for the type, strain and variety of the plant(s) 44 being grown and/or for the particular stage of growth of the plant(s) 44. In a preferred embodiment of light system 62 and method of irradiating plants 44 in chamber 42, an electronically controllable selective wavelength filter arrangement 420 employs one or more electronically controllable filters (1)-(5) listed in the preceding paragraph controlled by controller 408 and/or user 410 to selectively filter the sunlight 426 to produce filtered light 428 that ultimately is transmitted as light 394 that irradiates plants 44 that: (a) only contains visible light having predetermined wavelengths, predetermined wavelength range, or multiple predetermined wavelength ranges of (i) between about 400 and about 700 nm, (ii) preferably between 380 and 750 nm, (iii) more preferably between about 430 and about 450 nm and between about 640 and about 680 nm, or (iv) even more preferably between 430 and 450 nm and between 640 and 680 nm, with all UV and IR preferably filtered, e.g., removed, from the sunlight 426, (b) contains (i) only red light having wavelengths between about 620 and about 740 nm which each plant 44 is irradiated with during its flowering stage of growth, (ii) predominantly red light having wavelengths between 620 and 740 nm which each plant 44 is irradiated with during its flowering stage of growth, (iii) only red light having wavelengths between about 620 and about 740 nm and only near IR having wavelengths between about 750 and about 850 nm, e.g., only light having wavelengths between about 600 and about 850 nm, which each plant 44 is irradiated with during its flowering stage of growth, (iv) only near IR having wavelengths of at least 751 nm and no greater than about 1400 nm that each plant 44 is irradiated with during its flowering stage of growth, (v) only red light having wavelengths between about 620 and about 740 nm and only near IR having wavelengths between about 750 and about 1400 nm, e.g., only light having wavelengths between about 600 and about 1400 nm, which each plant 44 is irradiated with during its flowering stage of growth, or (c) contains any combination of visible light having one of the aforementioned wavelengths or wavelength ranges in (a)(i), (a)(ii), (a)(iii) or (a)(iv) listed hereinabove and near IR having one of the aforementioned wavelengths or wavelength ranges in (b)(i), (b)(ii), (b)(iii), (b)(iv) or b(v) also listed hereinabove. The selectively electronically controllable light wavelength filter 440 also can be configured or further configured to ensure that the light 394 used to irradiate the plants 44 has been filtered so it contains substantially no UV with substantially all UV light having wavelengths ranging between 100 and about 400 nm preferably substantially completely filtered so it is lacking in the plant-irradiating light 394 delivered to chamber 42.

In another lighting system embodiment and plant lighting method of the present invention, the light engine 385 can and preferably also does include a light intensity control arrangement 464 with a luminous intensity regulator 466 that is disposed inline with the focusing lens 436 such that it overlies or underlies lens 436 so that sunlight 426 passes through the regulator 466 before or after passing through lens 436. The light intensity control arrangement 464 and preferably its regulator 466 is configured to selectively control the luminous intensity of the light 394, such as in candelas, irradiating the foliage 46 of the plants 44 to keep it below a predetermined luminous intensity threshold. In at least one preferred embodiment and method, the light intensity control arrangement 464 and particularly its regulator 466 is an electronically controlled or electronically controllable by being configured to be selectively electronically controlled by controller 408 and/or user 410 to regulate the luminous intensity of light 394 reaching the foliage 46 of the plants 44. Preferred but exemplary regulators 424 include one or more (a) liquid crystal devices (LCDs), such as twisted nematic (TN) LCDs, and/or guest-host liquid crystal displays, (b) an electrochromic device, (c) a suspended particle device (SPD) with suspended nanoscale particles which decreasingly or increasingly align in response to voltage controllably applied thereto to controllable allow more or less light to pass through, (d) a photochromic material, e.g., hybrid photochromic, configured to electronically change transmissibility of light passing through it, and/or an electro-optic modulator to ensure light 394 irradiating the foliage 46 of plants 44 in chamber 42 does not exceed a desired predetermined luminous intensity threshold in candelas. Therefore, during operation of light engine 385 and lighting system 62, the controller 408 and/or user 410 controls operation of the light filtering arrangement 439, preferably its electronically controllable wavelength filter 440, and operation of the light intensity control arrangement 464, preferably its luminous intensity regulator 466 to substantially simultaneously (a) limit the wavelengths of light 394 irradiating the plants 44 to one of the aforementioned wavelength ranges disclosed above, and regulate the luminous intensity of the light 394 irradiating the plants 44 so it remains below the desired predetermined candela threshold.

The light engine 385 preferably includes a sun tracker 444 that has a sun or light sensor arrangement 446 equipped with one or more sun or light sensors whose signals or light-related data is outputted via signal/data line 445 to a sun tracking drive arrangement 448 that can and preferably does employ a sun tracking drive 450 that can be a single axis or dual axis sun tracking drive configured to track the sun (a) primarily azimuthally to cause the collector 388 to follow the path of the sun as it travels across the sky, and/or (b) preferably also attitudinally to adjust the angle of inclination of the collector 388 relative to the sun to optimize collection of sunlight 426 during plant lighting system operation. Where sensors of the sun or light sensor arrangement 446 detect that there is insufficient sunlight present to provide enough light to properly irradiate the plants 44 to ensure photosynthesis occurs, a branch of light signal/data line 445 activates an alternative light source 452, such as in the form of an artificial light source 455, such as preferably a light emitting diode light source or the like, which then communicates light 454 to the light-receiving ends 430 of fiber optic cables 432. In the preferred embodiment depicted in FIG. 22, when the signal or data from sensor arrangement 446 drops below a predetermined luminous intensity threshold that indicates there is insufficient sunlight, an alternative light source positioning motor 456 displaces preferably by rotation the artificial light source 455 so it overlies the collector 388 preferably disposing the source 455 so it is generally inline with the light gathering lens 436 of the collector 388 so light 454 outputted from artificial light source 455 is received by the collector 388 in place of the sunlight 426.

In a preferred embodiment, sunlight 426 not gathered by the collector 388 irradiates at least one solar panel array 457 composed of least a plurality of pairs of solar panels 458 which supply electrical power that is communicated through (a) power line 460 to the sun tracking drive arrangement 448 to power electrical motor(s) of its sun tracking drive 450, and (b) power line 462 to alternative light source positioning motor 456 to power it when needed to position artificial light source 455 over collector 388. In such a preferred embodiment, the solar panels 458 of the at least one array 457 preferably also supply electrical power to the electrically powered components of the oxygenation system 54, growing atmosphere operating system 56, plant feeding system 58, and acoustical stimulation system 60 in addition to the plant lighting system 62 such that the growing system 40, including growing chamber 42, preferably is electrically powered using solar power. In such a preferred embodiment, growing system 40 preferably employs at least a plurality of pairs of solar panel arrays 457 each having at least a plurality of pairs of solar panels 458 to supply enough electrical power from solar energy to electrically power all of the systems and electrical components of the chamber 42 and all of its systems 54, 56, 58, 60, 62.

With reference once again to FIG. 21, where light wavelength filtering and/or luminous intensity regulation is not performed at or by the light engine 385, one or more and preferably all of the light emitters 406 of an array and/or bank of a preferred embodiment of lighting system 62 can be under the control of or include a light control arrangement 418 configured to control some aspect of light emitted from emitter 406 to produce light 394 having one or more of a desired wavelength, wavelengths, wavelength range, intensity, power, beam spot diameter, and/or diffuseness. In one preferred embodiment of lighting system 62 and method of illuminating or irradiating plants 44 in chamber 42 with light 394 for photosynthesis, the light control arrangement 418 is in communication with controller 408 and configured for selectively controlling one or more of a desired predetermined wavelength, wavelengths, wavelength range, intensity, power, beam spot diameter, and/or diffuseness of light emitted by emitters 406 to produce light 394 irradiating foliage 46 of plants 44 having the one or more of the desired predetermined wavelength, wavelengths, wavelength range, intensity, power, beam spot diameter, and/or diffuseness specified by controller 408 as configured in software, firmware and/or via user input 410 such as in the manner discussed below.

With continued reference to FIG. 21, in one light system embodiment, the light controlling arrangement 418 includes a light wavelength filter arrangement 420, such as a light bandpass filter arrangement, configured to allow one or more desired predetermined wavelengths of light from emitter(s) 406, such as preferably a desired predetermined range of wavelengths of light, preferably in the visible light spectrum, to pass through the filter arrangement 420 exiting as light 394 which irradiates the plants 44 in chamber 42. In one embodiment of a light system 62 and method of irradiating plants 44 in chamber 42 with light 394 for photosynthesis, the light controlling arrangement 418 employs a light wavelength filter arrangement 420 composed of (1) an acousto-optic tunable filter (AOTF), (2) a liquid crystal tunable filter (LCTF), (3) an electrochromic filter, (4) an interferometer-type filter, e.g., Fabry-Pérot Interferometer (FPI), and/or (5) a graphene-based optical filter. A preferred light wavelength filter arrangement 420 is an electronically controllable light wavelength filter arrangement 420 that is electronically controlled by controller 408 and/or user 410 to selectively filter wavelengths of light exiting emitter(s) 406 and/or permit only one or more specific bands or ranges of wavelengths of light exiting emitter(s) 406 to pass through that is or becomes the light 394 that irradiates the plant(s) 44 advantageously having specific desired wavelengths, range of wavelengths or a plurality of ranges of wavelengths tailored for the type, strain and variety of the plant(s) 44 being grown and/or for the particular stage of growth of the plant(s) 44. In a preferred embodiment of light system 62 and method of irradiating plants 44 in chamber 42, an electronically controllable selective wavelength filter arrangement 420 employs one or more electronically controllable filters (1)-(5) listed above arranged between emitter(s) 406 and plant(s) 44 and controlled by controller 408 and/or user 410 to selectively filter light from emitter(s) 406 to produce light 394 exiting filter arrangement 420 that irradiates plants 44 that: (a) only contains visible light having predetermined wavelengths, predetermined wavelength range, or multiple predetermined wavelength ranges of (i) between about 400 and about 700 nm, (ii) preferably between 380 and 750 nm, (iii) more preferably between about 430 and about 450 nm and between about 640 and about 680 nm, or (iv) even more preferably between 430 and 450 nm and between 640 and 680 nm, with all UV and IR wavelengths preferably filtered, e.g., removed, from the light 394, (b) contains (i) only red light having wavelengths between about 620 and about 740 nm which each plant 44 is irradiated with during its flowering stage of growth, (ii) predominantly red light having wavelengths between 620 and 740 nm which each plant 44 is irradiated with during its flowering stage of growth, (iii) only red light having wavelengths between about 620 and about 740 nm and only near IR having wavelengths between about 750 and about 850 nm, e.g., only light having wavelengths between about 600 and about 850 nm, which each plant 44 is irradiated with during its flowering stage of growth, (iv) only near IR having wavelengths of at least 751 nm and no greater than about 1400 nm that each plant 44 is irradiated with during its flowering stage of growth, (v) only red light having wavelengths between about 620 and about 740 nm and only near IR having wavelengths between about 750 and about 1400 nm, e.g., only light having wavelengths between about 600 and about 1400 nm, which each plant 44 is irradiated with during its flowering stage of growth, or (c) contains any combination of visible light having one of the aforementioned wavelengths or wavelength ranges in (a)(i), (a)(ii), (a)(iii) or (a)(iv) and near IR having one of the aforementioned wavelengths or wavelength ranges in (b)(i), (b)(ii), (b)(iii), (b)(iv) or b(v).

The selectively controllable light wavelength filter arrangement 420 also can be configured or further configured to ensure that the light 394 used to irradiate the plants 44 has been filtered so it contains substantially no UV with substantially all UV light having wavelengths ranging between 100 and about 400 nm preferably substantially completely filtered from light emitted by emitters 406 so it is lacking in light 394. While each emitter 406 can be equipped with its own light controlling arrangement 418 that is or includes such a selectively controllable light wavelength filter arrangement 420 controlled, preferably electronically controlled, by controller 408 and/or user 410 that preferably is or includes one or more of the aforementioned electronically controllable wavelength filters (1), (2), (3), (4) and/or (5) listed above, a common light controlling arrangement 418, including any filters (1), (2), (3), (4) and/or (5) of filter arrangement 420, can be configured and arranged to overlie all of the emitters 406 of an array 404a, 404b, or 404c with the light controlling arrangement 418, including filters (1), (2), (3), (4) and/or (5) of filter arrangement 420, disposed between the emitters 406 of the array 404a, 404b, or 404c and the plants 44 in the chamber 42. In a preferred embodiment and method, the light 394 from each array 404a, 404b, 404c of lighting system 62 can be independently controlled by controller 408 and/or user 410 by having a separate light controlling arrangement 418 independently controlled by controller 408 and/or user 410 that is or includes such its own selectively controllable light wavelength filter arrangement 420 independently controlled by controller 408 and/or user 410 disposed between the emitters 406 of each array 404a, 404b, 404c and plants 44 in the chamber 42.

In another lighting system embodiment and plant lighting method of the present invention, the light controlling arrangement 418 can be, include or further include a light intensity control arrangement 422 for selectively controlling the intensity of the light 394 irradiating the foliage 46 of the plants 44. In at least one preferred embodiment and method, the light intensity control arrangement 422 is an electronically controllable luminous intensity regulator 424 configured to be selectively electronically controlled by controller 408 and/or user 410 to regulate the luminous intensity of light 394 reaching the foliage 46 of the plants 44. Preferred but exemplary regulators 424 include one or more (a) liquid crystal devices (LCDs), such as twisted nematic (TN) LCDs, and/or guest-host liquid crystal displays, (b) an electrochromic device, (c) a suspended particle device (SPD) with suspended nanoscale particles which decreasingly or increasingly align in response to voltage controllably applied thereto to controllable allow more or less light to pass through, (d) a photochromic material, e.g., hybrid photochromic, configured to electronically change transmissibility of light passing through it, and/or an electro-optic modulator to ensure light 394 irradiating the foliage 46 of plants 44 in chamber 42 does not exceed a predetermined luminous intensity threshold in candelas.

While each emitter 406 can be equipped with its own light controlling arrangement 418 that is, includes or further includes its own separate light intensity control arrangement 422, which preferably is, includes or further includes an electronically controllable luminous intensity regulator 424, preferably one or more of the aforementioned electronically controllable luminous intensity regulators (a)-(d) listed above in the preceding paragraph, a common light controlling arrangement 418, including a light intensity control arrangement 422 composed of one or more electronically controllable luminous intensity regulators 424 like the aforementioned electronically controllable luminous intensity regulators (a)-(d) listed above, can be configured and arranged to overlie all of the emitters 406 of an array 404a, 404b, or 404c such that the common light controlling arrangement 418, including common light intensity control arrangement 422 composed of common electronically controllable luminous intensity regulators 424, like regulators (a)-(d) listed above, is disposed between the emitters 406 of the array 404a, 404b, or 404c and the plants 44 in the chamber 42. In a preferred embodiment and method, the luminous intensity of light 394 from each array 404a, 404b, 404c of lighting system 62 can be independently controlled by controller 408 and/or user 410 by having a separate light controlling arrangement 418 independently controlled by controller 408 and/or user 410 that is, includes or further includes its own selectively electronically controllable light intensity control arrangement 422 independently controlled by controller 408 and/or user 410 disposed between the emitters 406 of each array 404a, 404b, 404c and each plant 44 in the chamber 42.

In use and operation, plant propagule 44″, such as a seed, cutting, bulb, rhizome, tuber, corm, runner (stolon), offset, spore or other type of plant propagule, is introduced in a plant growing container 80 of a plant growing station 75 inside a growing chamber 42 of a growing system 40 in accordance with the present invention where it preferably is in contact with, but not fully immersed in, liquid growing medium 52 in the growing medium holding compartment 190 to begin its germination and propagation from a seedling 44′ into a plant 44 having a stem 70, shoots 68 and leaves 69 making up its foliage 46. The chamber 42 preferably is disposed sufficiently far underground at a depth of at least 15 meters below the Earth's surface that ensures the growing atmosphere 48, liquid growing medium 52, and plants 44 are maintained at a substantially constant plant growth optimizing temperature of between about 20 degrees Celsius and about 32 degrees Celsius that also helps ensure optimal growth of the plants 44. These climate conditions within the chamber 42 are advantageously maintained without the use of any active climate control, such as in the form of cooling towers, air conditioners, heat pumps, or other types of powered, e.g., electrically powered, heating, refrigeration, and/or cooling equipment. In a preferred embodiment and plant growing method, chamber 42 preferably is disposed underground at least 20 meters to ensure that the growing atmosphere 48, liquid growing medium 52, and plants 44 are maintained at such a desired plant growth optimizing temperature during at least one, preferably at least a plurality of stages of growth of the plants 44 in the chamber 42, and more preferably during each growth stage of the plants 44 in the chamber 42 without the use of any active climate control. In one such preferred embodiment and plant growing method, in one such preferred embodiment and method, is disposed (a) below the surface of the earth at least 15 meters and preferably at least 20 meters to ensure that the growing atmosphere 48, liquid growing medium 52, and plants 44 are maintained at such a desired plant growth optimizing temperature, and (b) above an underground aquifer from which water is drawn for (1) use in or as the liquid growing medium 52, particularly where the liquid growing medium 52 is an aqueous hydroponic liquid growing medium 53, (2) providing water used by the electrolyzer 82 of the liquid growing medium oxygenation system 54 including to generate oxygen gas used for oxygenation during oxygenation system operation and as oxygenated makeup water to be added to the liquid growing medium 52, preferably hydroponic growing medium 53, and (3) use in the plant feeding system 58, including for making or adding to (i) liquid fertilizer 228, and/or (ii) liquid surfactant 244 used in the plant feeding system 58.

During use and growing system operation of the growing chamber 42, the liquid growing medium 52, preferably aqueous hydroponic liquid growing medium 53, in the chamber 42 is oxygenated, preferably hyperoxygenated, with supersaturated oxygen using the oxygenation system 54 such that the growing medium 52, preferably hydroponic medium 53, contains oxygen nanobubbles, i.e., nanosized oxygen bubbles, and which maintains a level of oxygen in the growing medium 52, preferably hydroponic medium 53, of at least 2 milligrams of oxygen per liter of growing medium 52, preferably hydroponic medium 53, preferably at least 3 mg/L, more preferably at least 5 mg/L, and even more preferably at least about 6.5 mg/L and which is preferably no greater than about 8 mg/L, preferably between 5 and 8 mg/L, for increased oxygen uptake by the roots 50 of plants 44 substantially completely immersed in the growing medium 52, preferably hydroponic medium 53. Such increased oxygen uptake by the roots 50 of each plant 44 in the chamber 42 advantageously speeds up germination, increases vegetative growth, decreases the time to budding, flowering and fruiting/seed formation of each plant 44 in the chamber 42 and preferably also advantageously increases plant yield, plant life, and/or the number of harvests of each one of the plants 44 from a single harvest for each plant 44 to at least a plurality of harvests, preferably at least a plurality of pairs of harvests, before plant senescence or death.

Also during use and growing system operation of the growing chamber 42, the growing atmosphere 48 within the chamber 42 is oxygen regulated, CO₂ enriched, and maintained at a pressure greater than the Earth's atmospheric pressure by the growing atmosphere operating system 56 such that the chamber 42 preferably is a hyperbaric plant growing chamber 45 having a percentage of CO₂ greater than the Earth's atmosphere and which can and preferably does regulate the percentage of oxygen in growing atmosphere 48 to maintain it at or below a predetermined desired maximum percentage of oxygen that can be less than the percentage of oxygen in the Earth's atmosphere. During use and operation, the growing atmosphere operating system 56 maintains (a) the pressure of the growing atmosphere 48 at a pressure of at least 150 kPa or 21 psi, preferably at least 200 kPa or 29 psi, and more preferably at least about 300 kPa or at least about 43 psi, and which can be and preferably is no greater than 1200 kPa or 175 psi, more preferably no greater than 1000 kPa or 145 psi, even more preferably no greater than 800 kPa or about 115 psi, yet even more preferably no greater than about 600 kPa or about 87 psi, and still even more preferably no greater than about 500 kPa or about 72 psi, (b) at least 0.05%, preferably at least 0.06%, more preferably 0.08%, and even more preferably at least 0.10% CO₂ by volume in the growing atmosphere 48, and (c) no greater than 25%, preferably no greater than about 21%, more preferably no greater than about 18%, and even more preferably no greater than about 15% oxygen by volume in the growing atmosphere 48. In one preferred embodiment and method, the amount of oxygen in the growing atmosphere 48 is regulated to remove oxygen produced during respiration of the plants 44 in the chamber 42 to keep the percentage of oxygen in the growing atmosphere 48 no greater than 21%, preferably no greater than 18%, and more preferably no greater than about 15% by volume while supplying CO₂ as needed from the CO₂ gas supply system 194 and/or CO₂ gas generation system 204, such as provided by CO₂ capturing system 205, to maintain the amount of CO₂ in the growing atmosphere 48 to be between 0.05% and 0.40%, preferably between 0.08% and 0.20%, by volume, while maintaining the pressure of the growing atmosphere 48 at between 200 kPa or 29 psi and 1000 kPa or 145 psi during at least the seed stage, germination stage, seedling stage, vegetative growth stage, budding stage and flowering stage of growth of the plants 44 in the chamber 42. Maintaining such a carbon enriched growing atmosphere 48 at such increased pressures while regulating and removing excess oxygen from the growing atmosphere 48 also advantageously speeds up germination, increases vegetative growth, decreases the time to budding, flowering and fruiting/seed formation of each plant 44 while preferably also advantageously increasing plant yield, plant life and the number of harvests of each one of the plants 44 to at least a plurality of harvests, preferably at least a plurality of pairs of harvests, before plant senescence or death.

Further during use and growing system operation of the growing chamber 42, the plant feeding system 58 utilizes the fertilizer delivery and dispensing system 220 that delivers liquid fertilizer 225, 225′ or 225″ using atomizer 246, preferably nebulizer 248, to discharge the fertilizer 225, 225′, 225″ in a mist 232, preferably an aerosol 234, of droplets 236 into the growing atmosphere 48 during each plant feeding cycle which are nanosized or which include droplets 236 that are nanosized for foliar feeding preferably via stomatal uptake by foliage 46 of the plant 44 being fertilized during the feeding cycle. The relatively small size of the droplets 236, particularly those that are nanosized, not only facilitate more rapid travel through the growing atmosphere 48 to reach and wet the foliage 46 of the plant 44 being fertilized during the plant's feeding cycle, but the relatively small size of the droplets 236, especially those that are nanosized, are also advantageously more easily taken up by stomata 374 of the leaves 69 of the foliage 46 of the plant 44 being fertilized. To facilitate foliar feeding, preferably stomatal feeding, of a plant 44 during its feeding cycle, (a) the droplets 236′ are electrically charged, e.g. electrostatically charged, (b) at least part of the plant 44, such as preferably its foliage 46, is electrically charged, e.g. electrostatically charged, or (c) both the droplets 236′ and at least part of the plant 44, such as preferably its foliage 46, are respectively electrically charged, e.g., electrostatically charged, with charges of opposite polarity all of which cause the droplets 236′ or 236″ to be attracted to the foliage 46 of the plant 44 being fed. This advantageously speeds up feeding by causing the attracted droplets 236′ to more quickly reach and wet the foliage 46 of the plant 44 undergoing a feeding cycle as well as to be more quickly taken up by and into pores 372, preferably substantially completely open pores 372, of the stomata 374 of the plant 44 which advantageously provides more efficient feeding of the plant 44 for a given weight or volume of liquid fertilizer discharged by the atomizer 246 or nebulizer 248 of the feeding system. In a preferred embodiment and method, one of the aforementioned acoustical stimulation methods can be and preferably is performed before and can be performed during carrying such foliar feeding, preferably stomatal feeding, to ensure substantially all of the pores 372 of the foliage 46 of the plants 44 in the chamber 42 are substantially open by being at least 85% open, preferably at least 90% open and more preferably at least 95%. Where at least one surfactant 244 is added to the liquid fertilizer 228 producing a surfactant-enhanced fertilizer 225″ discharged in the form of droplets 236, 236′, 236″ from atomizer 246 or nebulizer 248, the surfactant-containing fertilizer droplets 236, 236′, 236″ not only more rapidly and uniformly wet and spread out over the outer surfaces of the foliage 46 of the plant 44 undergoing a feeding cycle, but also are more quickly and more readily taken up by and into the substantially completely open pores 372 of the stomata 374 of the foliage 46, including through wicking or capillary action, advantageously increasing the rate of feeding of each plant 44 being fed during a plant feeding cycle.

In preparation for and preferably prior to beginning a feeding cycle for a plant 44 in the chamber 42, acoustical stimulation of the plant 44 is performed to open, begin opening and/or further open pores 372′ or 372″ of stomata 374 of the foliage 46 of the plant 44 preferably until substantially all of the pores 372 of the foliage 46 of substantially all of the plants 44 in the chamber 42 are substantially completely open, e.g., fully open, to facilitate their uptake of liquid fertilizer from the droplets 236, 236′, 236″ in the mist 232 discharged from atomizer 246 or aerosol 234 discharged from nebulizer 248 which travel through the growing atmosphere 48 and contact and wet the foliage 46 of the plant 44. In a preferred embodiment of the acoustical stimulation system 60 and method of acoustically stimulating a plant 44, a plant 44 in the chamber 42 undergoing a feeding cycle is acoustically stimulated at a pore-opening initiating frequency 376 at a desired predetermined sound pressure level and for a sufficient amount of time to cause substantially completely closed pores 372″ of the stomata 374 of the foliage 46 of the plant 44 undergoing the feeding cycle to begin to open and which is increased to a stomata pore substantially completely open frequency at a desired predetermined sound pressure level and for a sufficient amount of time to cause substantially all of the pores 372 of the stomata 374 of the foliage 46 of the plant 44 undergoing the feeding cycle to become substantially completely open and remain substantially completely open until the feeding cycle is completed. Doing so advantageously maximizes foliar feeding, preferably stomatal feeding, by optimizing uptake by the substantially completely open stomata 374 of the fertilizer in droplets 236, 236′, 236″ wetting the foliage 46 during application of the fertilizer onto the foliage 46 during the feeding cycle until the feeding cycle is completed.

In a preferred embodiment of the acoustical stimulation system 60 and method of acoustically stimulating a plant 44 in preparation for and/or which is undergoing feeding during a feeding cycle, acoustical stimulation system controller 368 and/or user 370 controls operation of tone or sound generator 346 to cause acoustical transducers 350 to emit and acoustically stimulate the foliage 46 of the plant 44 that is about to undergo or is undergoing a feeding cycle with sound at an initial frequency that is a stomata pore-opening initiating frequency 376 of preferably about 500 Hz at a desired predetermined sound pressure level of at least 50 dB and no greater than 110 dB which preferably is between about 70 dB and about 90 dB for a long enough period of time to cause substantially completely closed pores 372″ (or partially open pores 372′) of the stomata 374 of the foliage 46 of the plant 44 being fertilized to begin opening. The frequency of the sound from the transducers 350 is then increased such as in steps, generally linearly, generally logarithmically or even generally exponentially increased, from the while the aforementioned desired sound pressure level is maintained until a final frequency is reached that is a stomata pore substantially completely open, e.g., fully open, frequency 380 of preferably about 6000 Hz that results in the pores 372 of the stomata 374 of the foliage 46 of the plant 44 undergoing the feeding cycle being substantially completely open. If desired, the foliage can be continue to be acoustically stimulated during the feeding cycle to keep substantially all of the pores 372 of the stomata 374 of the foliage 46 of the plants 44 in the chamber 42 substantially completely open until feeding of each plant 44 is completed and preferably until the feeding cycle is completed. The sound from the transducers 350 preferably is emitted at the fully open frequency 380 at the aforementioned desired sound pressure level until the feeding cycle of the plant 44 is finished. Where the chamber 42 contains multiple plants 44, the sound from the transducers 350 preferably is emitted at the fully open frequency 380 at the aforementioned desired sound pressure level until the feeding cycles of each one of the plants 44 in the chamber 42 is finished. In one preferred embodiment and stomata pore opening acoustical plant stimulation method of the present invention, the frequency of the sound from the transducers 350 is increased in predetermined frequency steps, such as preferably an equal steps, from the stomata pore-opening initiating frequency 376 of preferably about 500 Hz to an intermediate pore-opening frequency 378 of about 3000 Hz opening the pores 372″ from being substantially closed or slit-shaped until the pores 372′ of the stomata 374 are between 40% open and 60% open, and thereafter from the intermediate frequency 378 of about 3000 Hz to the fully open frequency 380 of preferably about 6000 Hz until the pores 372 of the stomata 374 are substantially completely open by each being at least 90% open and which preferably are each about 100% open.

Where it is desired to acoustically stimulate the substantially completely open pores 372 of the stomata 374 of the foliage 46 of a plant 44 to close upon or after completion of its feeding cycle, acoustical stimulation system controller 368 and/or user 370 controls operation of tone or sound generator 346 to cause acoustical transducers 350 to emit and acoustically stimulate the foliage 46 of the plant 44 with sound having an initial stomata pore closing frequency that preferably is a pore-closing initiating frequency 382 of about 6000 Hz at the desired predetermined sound pressure level of at least 50 dB and no greater than 110 dB which preferably is between about 70 dB and about 90 dB and which decreases in frequency at a rate which causes the substantially completely open pores 372 of the stomata 374 of the foliage 46 of plant 44 to begin closing preferably causing the size of the pores 372′ of the stomata 374 of the plant 44 to reduce to an intermediate size of no greater than 75% of their fully open pore size and preferably no greater than 60% of their fully open size. The frequency of the sound emitted from the transducers 350 during pore closing is reduced, such as in steps, generally linearly, generally logarithmically, or generally exponentially, from the pore-closing initiating frequency 382 of about 6000 Hz to a final pore fully closed pore-closing frequency 386 of about 500 Hz while the sound pressure level of the emitted sound is maintained at an aforementioned desired predetermined sound pressure level until each one of the substantially completely open pores 372 of the stomata 374 of the foliage 46 of the plant 44 reduces in size so the pores 372″ become substantially completely closed by being less than 10% open and preferably less than about 5% open. In one preferred embodiment and stomata pore closing acoustical plant stimulation method of the present invention, the frequency of the sound from the transducers 350 is decreased in predetermined frequency steps, such as preferably in equal steps, from the stomata closing initiating frequency 382 of preferably about 6000 Hz to an intermediate stomata pore-closing frequency 384 of about 3000 Hz until the pores 372′ of the stomata 374 are between 40% open and 60% open, and thereafter from the intermediate stomata pore-closing frequency 384 of about 3000 Hz to the fully closed pore-closing frequency 386 of preferably about 500 Hz where the pores 372″ of the stomata 374 become substantially completely closed by each being no more than 10% open and which preferably are each no more than about 5% open.

In one preferred embodiment and method, such a method of stomata pore closing acoustical plant stimulation is initiated when the feeding cycle of the plant 44 is substantially completed by being at least 90% completed, and preferably by being at least about 95% completed, and preferably is performed until all of the pores 372″ of all of the stomata 374 of the plant 44 whose feeding cycle was completed are substantially completely closed. In another such preferred embodiment and method, such a method of stomata pore closing acoustical plant stimulation is initiated when the feeding cycle of the last one of the plants 44 in the chamber 42 is completed or substantially completed, such as by being at least 90% completed, and preferably by being at least about 95% completed, and preferably is performed until all of the pores 372″ of all of the stomata 374 of all of the plants 44 in the chamber 42 are substantially completely closed.

Still even further during use and growing system operation of growing chamber 42, growing system 40 employs a plant lighting system 62 that utilizes sunlight 426 as a source of plant photosynthesis light that is gathered by a solar collector 396 disposed above ground exteriorly of the growing chamber 42 and which delivers it through fiber optic cables of a fiber optic cable bundle that is separated into a plurality of fiber optic cable bundles which deliver light 394 in the chamber 42 which irradiates the foliage 46 of each plant 44 in the chamber 42 enabling plant photosynthesis to occur. Sunlight 426 is filtered at least to substantially eliminate UV wavelengths from the light 394 irradiating the plants 44 and can be filtered to also substantially eliminate far IR wavelengths from the light 394 irradiating the plants 44. In a preferred embodiment, acrylic that preferably is a UV filtering acrylic is used to filter the UV from the sunlight 426 to produce plant-irradiating light 394 substantially lacking in ultraviolet light wavelengths. In such a preferred embodiment, the acrylic, preferably UV filtering acrylic, also filters out far IR wavelengths from the sunlight 426 producing a plant-irradiating light 394 having wavelengths in the visible light spectrum as well as in the near IR spectrum.

A preferred growing system of the present invention can have a plurality of pairs of, i.e., at least three, growing chambers 42 and each chamber 42 can be disposed sufficiently far enough underground under the surface of the Earth to ensure the plants 44 and growing atmosphere 48 in the chamber 42 are maintained without heating or cooling at a substantially constant plant growth optimizing temperature of between 10 degrees Celsius and 35 degrees Celsius, preferably between 20 degrees Celsius and 32 degrees Celsius, and more preferably between about 21 degrees Celsius and 29 degrees Celsius that helps ensure optimal growth of the plants 44. In a preferred plant growing system and growing method, each chamber 42 preferably is disposed underground under the surface of the ground at least 10 meters, preferably at least 15 meters, and more preferably at least about 20 meters to ensure that the plants 44 and growing atmosphere 48 in each chamber 42 are maintained at a substantially constant optimal growing temperature falling within one of these aforementioned plant growth optimizing temperature ranges.

In one preferred growing system, growing environment, and growing method in accordance with the invention, the chambers 42 are disposed underground in a desert, such as the Sahara, Arabian or Sonoran desert, at least about 12 meters, preferably at least 15 meters, and more preferably at least 20 meters under the surface of the desert which advantageously maintains the temperature of the growing atmosphere 48 and plants 44 in each chamber 42 at a substantially constant temperature of between 20 and 32 degrees Celsius and preferably is between about 24 and about 29 degrees Celsius for optimal plant growth, yield and life. The underground chambers 42 preferably are disposed above an underground aquifer which provides water for the (a) liquid growing medium 52, (b) electrolyte 84 of the oxygenation system 54, and (c) the plant feeding system 58 including for use in making up the liquid fertilizer 225, 225′, 225″, surfactant 244 and/or mixing them together in preparation for and/or during carrying out foliar feeding of plants 44 in each chamber 42.

In a preferred method of growing system and growing chamber operation, the growing atmosphere operating system 56 is configured to be operated, such as in software and/or firmware and/or via user input to introduce an oxygen rich growing atmosphere into the chamber to facilitate germination and sprouting of a propagule in a growing container with only a portion of the propagule in contact with growing medium. During propagule germination and sprouting, the oxygen rich growing atmosphere is hyperbarically pressurized to at least one of the aforementioned growing chamber growing atmosphere pressures and/or maintained within one of the aforementioned growing atmosphere pressure ranges until sprouting occurs. Thereafter, the growing atmosphere operating system is operated to transition the oxygen rich growing atmosphere into the aforementioned CO₂ enhanced growing atmosphere containing a percentage of CO₂ significantly greater than in Earth's atmosphere, preferably having one of the aforementioned minimum CO₂ percentages and/or maintained within one of the aforementioned minimum CO₂ percentage ranges disclosed above during growth from a seedling into a plant and thereafter during each one of the plant growing phases up until maturation when produce or yield of each plant in the form of edible product of the plant is ready to be harvested.

When the plants in the chamber reach maturation, in a preferred method of extending post-harvest shelf life of produce grown by or on the at least one plant in the chamber, the post-maturation growing atmosphere in the chamber is replaced with an ozone rich atmosphere containing at least 5%, preferably at least 15%, more preferably at least 30%, and even more preferably at least 50% by volume ozone, which can be composed substantially completely of ozone, to sterilize and kill all parasites of the produce of each plant in the chamber for at least a plurality of hours, preferably at least 4 hours, more preferably at least 8 hours, even more preferably at least 12 hours, and can do so for at least one day until the ozone rich atmosphere is replaced with a CO₂ enhanced shelf-life extending atmosphere in the chamber. In one preferred method of extending post-harvest shelf life, the ozone rich atmosphere is introduced into the chamber for between 24 and 72 hours before being replaced with an CO₂ enhanced shelf-life extending atmosphere. In at least one such preferred implementation of the shelf-life extending method, treatment of the produce while still on the at least one plant in the chamber with such an ozone rich atmosphere advantageously kills at least 99% and preferably at least 99.9% of surface pathogens on the outer surface of the produce. It preferably also kills at least 99% and preferably at least 99.9% of parasites on the outer surface of the produce. Treatment with the ozone rich atmosphere is carried out at a pressure of ≥200 kPa within the chamber.

The CO₂ enhanced shelf-life extending atmosphere has a percentage of CO₂ greater than the highest percentage of CO₂ in the growing atmosphere used in the chamber during any of the prior stages of plant growth of the plants in the chamber and which treats the edible produce of each plant in the chamber in a manner which significantly extends shelf-life of the produce after being harvested from the plants in the chamber. In one method implementation, the atmosphere in the growing atmosphere can be composed substantially completely of CO₂ during this post-maturation produce sterilizing and shelf-life increasing method implementation. In one preferred method implementation, after treatment of the produce on the at least one plant in the chamber with ozone, the chamber is flushed with CO₂ such that the ozone-rich atmosphere in the chamber is replaced with an ultra-high CO₂ atmosphere. In one such preferred implementation, the ozone-rich atmosphere in the chamber is flushed and replaced with an ultra-high CO₂ atmosphere composed of at least 60% CO₂ by volume, preferably at least 75% CO₂ by volume, more preferably at least 90% CO₂ by volume, and even more preferably with pure or 100% CO₂. During ultra-high CO₂ atmosphere treatment of the produce on the at least one plant prior to harvest, the temperature within the chamber preferably is reduced to between 10-15° C. In a preferred implementation, the ultra-high CO₂ atmosphere is maintained in the chamber up until harvest of the produce from the at least one plant in the chamber and preferably for at least 12 hours, preferably at least 24 hours, more preferably 48 hours before harvest and even more preferably no more than 72 hours before harvest. Such a preferred combined shelf-life extending method of treatment of the produce with an ozone-rich atmosphere followed by treatment with an ultra-high CO₂ atmosphere extends room-temperature shelf life of the produce harvested from the at least one plant in the chamber by at least 100%, preferably at least 200% and more preferably at least 300% compared to the produce not being treated. In such a combined ozone and ultra-high CO₂ post-harvest shelf life extending treatment method, a pressure of ≥200 kPa is maintained in the chamber to enhance treatment.

Although not shown in the drawings, in a preferred embodiment and method implementation, one or more sensors are disposed in the chamber and configured to detect maturity of the produce one the at least one plant in the chamber. Once produce maturity is detected, the above discussed combined ozone and ultra-high CO₂ post-harvest shelf life extending treatment method is initiated while maintaining a pressure of ≥200 kPa in the chamber. Upon produce maturity being detected, the growing atmosphere is replaced with the ozone-rich atmosphere containing on the aforementioned minimum ozone percentages disclosed above. After treatment in the ozone-rich atmosphere for an aforementioned treatment period of at least 4 hours, preferably at least 8 hours, more preferably at least 12 hours and even more preferably between 24 and 72 hours, the ozone-rich atmosphere in the chamber is replaced with an ultra-high CO₂ atmosphere having one of the aforementioned minimum CO₂ percentages disclosed in the preceding paragraph. Ultra-high CO₂ atmosphere treatment is done at a reduced temperature of 10-15° C. in the chamber up until harvest of the produce grown on the at least one plant in the chamber and preferably for at least 12 hours before harvest, preferably at least 24 hours before harvest, more preferably at least 48 hours before harvest and even more preferably no more than 72 hours before harvest.

Understandably, the present invention has been described above in terms of one or more preferred embodiments and methods. It is recognized that various alternatives and modifications can be made to these embodiments and methods that are within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention.

What is claimed is:

1. A system for growing at least one plant having a root system and a shoot system comprised of foliage having stomata, the plant growing system comprised of a growing chamber in which is disposed a growing atmosphere and at least one plant being grown therein.

2. The plant growing system of claim 1, further comprising a foliar feeding system configured for fertilizing the foliage of the at least one plant in the growing chamber, the foliar feeding system comprised of (a) a liquid fertilizer containing one or more plant nutrients dissolved in an aqueous liquid, and (b) a fertilizer delivery system comprised of at least one applicator that discharges droplets of the liquid fertilizer into the growing atmosphere and onto the foliage of the at least one plant during a plant feeding cycle.

3. The plant growing system of claim 2, wherein the fertilizer droplets discharged from the at least one applicator comprise nanosized droplets of the liquid fertilizer.

4. The plant growing system of claim 2, wherein the at least one applicator is configured for aerosolizing nanosized droplets of the liquid fertilizer into the growing atmosphere in the growing chamber that float in the growing atmosphere until contacting and wetting the foliage of the at least plant.

5. The plant growing system of claim 4, wherein one of the nanosized fertilizer droplets discharged from the at least one applicator and the at least one plant in the growing chamber has one of a positive and a negative electrical charge.

6. The plant growing system of claim 2, wherein the applicator comprises one of an atomizer and a nebulizer that discharges charged nanosized droplets of the liquid fertilizer into the growing atmosphere in the growing chamber that attract the nanosized fertilizer droplets to the foliage of the at least one plant.

7. The plant growing system of claim 2, wherein the foliar feeding system further comprises a charge generator in communication with the at least one plant in the chamber, the charge generator applying an electrical charge to the foliage of the at least one plant in the chamber during discharge of the fertilizer droplets from the at least one applicator, the charge attracting the fertilizer droplets to the foliage of the at least one plant.

8. The system of claim 2, further comprising:
at least one acoustic transducer configured to emit sound into the plant growing chamber; and
an acoustic controller configured to selectively vary a frequency of sound emitted from the at least one transducer during the plant feeding cycle from a stomata pore-opening initiating frequency that causes closed stomata of the foliage of the at least one plant to begin opening to a stomata pore fully-open frequency where the stomata of the foliage of the at least one plant are substantially completely open.

9. The system of claim 8, wherein the stomata pore-opening frequency is approximately 500 Hz and the stomata pore fully-open frequency is approximately 6000 Hz.

10. The system of claim 9, wherein the sound emitted from the at least one transducer has a sound pressure level of between about 50 dB and about 110 dB.

11. The plant growing system of claim 2, wherein the foliar feeding system has a plurality of the applicators and further comprises a movable gantry carrying the plurality of applicators and disposed in the growing atmosphere in the chamber, the movable gantry movable within the growing atmosphere relative to the at least one plant to direct fertilizer droplets discharged from each of the applicators towards the foliage of the at least one plant.

12. The plant growing system of claim 11, wherein the movable gantry is comprised of a track system and drive arrangement configured to enable the gantry and applicators to move within the growing atmosphere relative to the foliage of the at least one plant.

13. The plant growing system of claim 12, wherein the track system and drive arrangement are configured to enable the gantry to rotate the applicators around the foliage of the at least one plant and move the applicators in an X-direction, a Y-direction and a Z-direction relative to the at least one plant.

14. The system of claim 1, further comprising:
at least one acoustic transducer configured to emit sound into the plant growing chamber; and
an acoustic controller configured to selectively vary a frequency of sound emitted from the at least one transducer from a stomata pore-opening initiating frequency that causes closed stomata of the foliage of the at least one plant to begin opening to a stomata pore fully-open frequency where the stomata of the foliage of the at least one plant are substantially completely open.

15. The system of claim 14, wherein the stomata pore-opening frequency is approximately 500 Hz and the stomata pore fully-open frequency is approximately 6000 Hz.

16. The system of claim 15, wherein the sound emitted from the at least one transducer has a sound pressure level of between about 50 dB and about 110 dB.

17. The system of claim 1, further comprising:
at least one acoustic transducer configured to emit sound into the plant growing chamber; and
an acoustic controller configured to selectively vary a frequency of sound emitted from the at least one transducer from a stomata pore-closing initiating frequency that causes open stomata of the foliage of the at least one plant to begin to close to a stomata pore fully-closed frequency where the stomata of the foliage of the at least one plant are substantially completely closed.

18. The system of claim 17, wherein the stomata pore-closing frequency is approximately 6000 Hz and the stomata pore fully-closed frequency is approximately 500 Hz.

19. The system of claim 18, wherein the sound emitted from the at least one transducer has a sound pressure level of between about 50 dB and about 110 dB.

20. The system of claim 1, wherein:
(a) the plant growing chamber is comprised of (i) a sealed hyperbaric growing atmosphere holding compartment holding the growing atmosphere, and (ii) an aqueous liquid growing medium holding tank holding an aqueous hydroponic liquid growing medium;
(b) the growing atmosphere in the growing atmosphere holding compartment is pressurized to a pressure of at least 150 kPa and contains at least 0.05% CO₂ by volume;
(c) the aqueous hydroponic liquid growing medium in the aqueous liquid growing medium holding tank contains at least 5 mg/L dissolved oxygen;
(d) the root system of the at least one plant is continuous substantially completely immersed in the aqueous hydroponic liquid growing medium in the aqueous liquid growing medium holding tank; and
(e) the foliage of the at least one plant is disposed in the pressurized growing atmosphere in the growing atmosphere holding compartment.

21. The plant growing system of claim 20, wherein the growing atmosphere has a pressure of between about 300 kPa and about 600 kPa and contains between 0.06% and 0.40% carbon dioxide by volume.

22. The plant growing system of claim 20, wherein the oxygen dissolved in the hydroponic liquid growing medium is comprised of oxygen nanobubbles.

23. The plant growing system of claim 20, wherein the growing atmosphere consists essentially of carbon dioxide during a ripening or maturation stage of the at least one plant.

24. The system of claim 1, wherein the growing chamber further comprises an aqueous hydroponic liquid growing medium; and
further comprising:
a plant oxygenation system comprised of (1) an electrolyzer containing an aqueous electrolyte and configured to produce (i) oxygen gas, and (ii) an oxygenated aqueous effluent having a first oxygen content; and
an atomizer or nebulizer fluid flow communication with the oxygen gas and the oxygenated aqueous effluent and configured to atomize or nebulize the oxygen gas in the oxygenated aqueous effluent discharging nebulized oxygenated aqueous liquid droplets therefrom each comprised of at least one oxygen nanobubble and having a second oxygen content greater than the first oxygen content of the oxygenated aqueous effluent; and
wherein the nebulized oxygenated aqueous liquid droplets comprise an oxygenated aqueous hydroponic liquid growing medium makeup liquid added to the hydroponic liquid growing medium in the growing chamber to maintain a dissolved oxygen content of ≥5 mg/L in the hydroponic liquid growing medium in the growing chamber.

25. The system of claim 24, wherein the aqueous hydroponic liquid growing medium in the growing chamber maintains the oxygen content of between 5 and 8 mg/L for at least one month without requiring additional oxygenated aqueous hydroponic liquid growing medium makeup liquid to be added thereto.

26. The system of claim 1, further comprising a plant lighting system comprised of a solar collector, a fiber-optic cable bundle receiving collected sunlight from the solar collector and transporting it to the growing chamber, and a plurality of light emitters in light emitting communication with the growing chamber directing the collected sunlight from the fiber-optic cable bundle into the growing chamber and onto foliage of the at least one plant in the growing chamber.

27. The system of claim 26, wherein the growing chamber is located underground.

28. The system of claim 27, wherein the collected sunlight is selectively filtered to reduce or eliminate UV light before irradiating the foliage of the at least one plant in the growing chamber.

29. The system of claim 28, further comprising an acrylic filter that filters UV light from the sunlight before irradiating the foliage of the at least one plant in the growing chamber.

30. The system of claim 1, wherein the growing chamber comprises a hyperbaric growing chamber located underground in the desert at least 15 feet below the surface of the desert, the hyperbaric growing chamber comprised of a growing atmosphere containing 0.06% CO₂ by volume and pressurized to at least 150 kPa, and an aqueous hydroponic liquid growing medium, and further comprising: a plant oxygenation system configured to oxygenate the hydroponic liquid growing medium to a dissolved oxygen content of between 5 and 8 mg/L and maintain the dissolved oxygen content of between 5 and 8 mg/L for at least one month; a foliar feeding system comprised of a liquid feed mixture comprised of fertilizer and a surfactant discharged as a stream into the growing atmosphere onto foliage of the at least one plant in the growing chamber for foliar feeding of the at least one plant during a plant foliar feeding cycle; and a plant lighting system comprised of an above-ground solar collector, a fiber-optic cable bundle receiving collected sunlight from the solar collector and transporting it to the growing chamber, and a plurality of light emitters in light emitting communication with the growing chamber discharging the collected sunlight from the fiber-optic cable bundle onto foliage of the at least one plant in the growing chamber.

31. The system of claim 30, wherein the underground hyperbaric growing chamber maintains a temperature of 20-32° C. within the growing chamber without active climate control.

32. The system of claim 30, further comprising an underground aquifer in fluid flow communication with the growing chamber supplying water that makes up at least some of the hydroponic liquid growing medium.

33. The system of claim 30, further comprising an acoustic plant stimulation system comprised of at least one acoustic transducer configured to emit sound into the plant growing chamber; and an acoustic controller configured to selectively vary a frequency of sound emitted from the at least one transducer from one of a frequency that opens stomata of the foliage of the at least one plant in the growing chamber and a frequency that closes stomate of the foliage of the at least one plant in the growing chamber.

34. The system of claim 33, wherein the acoustic plant stimulation system is operated to acoustically stimulate the at least one plant in the growing chamber during the plant foliar feeding cycle.
